(19) United States
(12) Patent Application Publication
(10) Pub. No.: US 2007/0080940 A1
(43) Pub. Date: Apr. 12, 2007

(54) Remote control system, and display device and electronic device using the remote control system

(75) Inventors: Fumihiko Aoki, Nara (JP); Kohji Hisakawa, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/544,689

(22) Filed: Oct. 10, 2006

(30) Foreign Application Priority Data
Oct. 7, 2005 (JP) 2005-295132
Nov. 11, 2005 (JP) 2005-327610

(51) Int. Cl. G09G 5/08

(52) U.S. Cl. 345/158

(57) ABSTRACT

One embodiment of a remote control system according to the invention includes: a remote control transmitter including a light-emitting element control unit that emits light-emitting element that emit position detection light signals; a remote control receiver including a light-reception signal processing unit that detects position detection reception signals from the position detection light signals, an output detection unit that performs waveform conversion on the position detection reception signals to obtain output signals as position detection output signals, and an arithmetic processing unit that calculates a displacement of the remote control transmitter in a first axis direction and a second axis direction based on an amplitude correlation of output signals; and a cursor control unit that controls the position of the cursor based on the displacement of the remote control transmitter in the first axis direction and the displacement of the remote control transmitter in the second axis direction.

### BACKGROUND OF THE INVENTION

This application claims priority under 35 U.S.C. § 119(A) on Patent Application No. 2005-295132 filed in Japan on Oct. 7, 2005, and Patent Application No. 2005-327610 filed in Japan on Nov. 11, 2005, the entire contents of which are hereby incorporated by reference.

The present invention relates to a remote control system that controls the position of a cursor displayed on a display screen from a distant location, and also to a display device that controls a cursor that is displayed on a display screen by such a remote control system. The invention further relates to an electronic device equipped with a remote operation device (remote control transmitter), such as a television receiver, a program recorder, a game console, a videophone system and a security camera.

Remote control devices for operating a cursor displayed on a display screen of a display device from a distant position have been known conventionally. Examples of such remote control devices include devices that perform remote control using a mouse in the case of a personal computer (PC), and devices that perform remote control using a cross-shaped key on an infrared remote controller in the case of a television receiver. Other examples include devices that control the position of the cursor by transmitting a command optical code signal and letting the remote control receiver identify the command optical code signal in the case of operating a jog shuttle or the like.

In addition, as a system for moving the cursor in a direction in which the remote control transmitter is swung, a system in which a gyro sensor is contained in the remote control transmitter, a swing angle sensed by the gyro sensor is converted into a code signal, and the code signal is transmitted wirelessly to a display device (the remote control receiver side) has been put into practical use (for example, a projector, a PC and an IT-TV).

Further, remote control devices provided with a remote operation body having a light-emitting element, and a controller unit that receives light from the remote operation body to detect indicated locations have been proposed (e.g., see Japanese patent No. 3273531 (hereinafter, referred to as Patent Document 1) as optical remote coordinate indicating devices that use light-emitting elements. The remote operation body of this remote coordinate indicating device disclosed in Patent Document 1 is provided with a total of five light-emitting element systems, and configured such that the light-emitting elements simultaneously emit light in groups of two or more, making the signal processing complicated.

In conventional television receivers, channel switching and volume adjustment, for example, can be performed by pushing and operating predetermined keys arranged on the remote control transmitter to move the pointer (cursor) on the monitor screen such that the pointer is placed over a button describing a command name on the screen, and selecting that button, without having to look at the remote control transmitter itself In this case, devices for operating the pointer on the screen from a distant position include a cross-shaped key, a ball pointing device and a joystick, which are attached to the remote control transmitter.

On the other hand, with the evolution of various electronic devices, a very large number of keys are arranged on the remote control transmitter, making it troublesome to find a key to be pressed. Moreover, the key operation has become complicated, and it has become necessary to press multiple keys. In the case of selecting the necessary ones from among a huge number of recorded programs or TV channels, it has been troublesome to make a selection from their listings, and the search operation has been complicated.

As described above, the conventional remote control operation is complicated, and has reached its limitations. Therefore, inventions that improve the operability of such a remote control transmitter have been proposed (e.g., see JP 2005-012433A, JP H9-251341A (hereinafter, referred to as “Patent Document 2” and “Patent Document 3”, respectively)).

The invention described in Patent Document 2 is provided with an inertial sensor that detects the movement direction of a remote control transmitter when the remote control transmitter is moved by a user, and generates a direction signal expressing the direction of that movement. The television receiver is configured to move a pointer to a desired position by shifting the pointer in response to the direction signal.

With the invention described in Patent Document 3, if a user clicks when a mouse cursor is outside a reaction region such as an icon displayed in the screen, then the reaction region is enlarged and an enlarged area is displayed. If the user moves the mouse cursor into the enlarged area and clicks, then a process corresponding to the original reaction region is automatically started

The above-described conventional techniques have the following problems.

First, in the case where the operating means for the cursor is a mouse and the display device is a PC monitor, it is possible to finely control the cursor and smoothly operate the cursor even if there are small buttons to be selected at arbitrary positions on the screen. However, when this is applied to a television receiver (hereinafter, occasionally referred to as “TV”) in a living room, the operation space for a mouse that is placed and operated on a table is limited compared with that for a remote controller that can be placed and operated in a free spatial position, and this leads to the problem of reduced operability.

In the case of the operation using a cross-shaped key of an infrared remote controller, which is used for TVs, there is the problem that it is difficult to operate the cursor smoothly, making it impossible to finely control the position of the cursor with high accuracy.

In the case of the remote control transmitter containing a gyro sensor, it is necessary to mount at least two expensive gyro sensors to sense a horizontal swing angle and a vertical swing angle. When these are mounted to a remote control transmitter, there is the problem that the remote control transmitter becomes very expensive and increases in size.

Moreover, the remote operation body of the remote coordinate indicating device disclosed in Patent Document 1 involves complicated signal processing and therefore has a complicated circuit configuration, so that and there is the problem that it is not possible to provide an inexpensive remote operation body.

In the case of the invention described in Patent Document 2, it is necessary to provide an inertial sensor to the remote control transmitter, and to generate and output a direction signal based on the inertial sensor. Accordingly, there is the problem that the remote control transmitter has a complicated structure and requires complicated signal processing on the remote control transmitter side. Furthermore, although the invention described in Patent Document 2 can move the pointer by moving the remote control transmitter, the processing after moving the pointer is still performed by operating the keys of the remote control transmitter, so that the operation is no different from the conventional operation, for example, in terms of the complicatedness of the key operation.

The invention described in Patent Document 3 can reduce the movement amount of the mouse cursor when an icon located in a position distant from the mouse cursor is to be operated, but the processing after the mouse cursor has entered into the enlarged reaction region is still performed by operating the keys of the remote control transmitter. Therefore, the operation is no different from the conventional operation, as with Patent Document 2.

### SUMMARY OF THE INVENTION

The present invention was made in view of such circumstances, and it is an object of the invention to provide an inexpensive remote control system that can realize cursor movement directly connected to displacement (for example, swinging movement) of a remote control transmitter, can readily control the position of a cursor displayed on a display screen with high accuracy so as to provide a direct sense of operation, and also can be reduced in size, and a display device using the remote control system.

It is another object of the present invention to provide an electronic device that makes it possible to perform operations without looking at the remote control transmitter, perform operations more intuitively than in performing operations while reading commands written on buttons on a screen, readily select the necessary program or channel from among a huge number of recorded programs or TV channels, and reduce the number of keys on the remote control transmitter, by using a display device that uses the above-described remote control system. Specifically, the present invention provides an electronic device that makes it possible to facilitate various operations by speedily and intuitively moving a cursor on a monitor screen located at a distant position by arbitrary movements of the remote control transmitter in a free space.

A remote control system according to the present invention includes: a remote control transmitter including a position detection light-emission unit that emits position detection light signals; a remote control receiver including a light-reception signal processing unit that detects position detection reception signals from the position detection light signals that are received, and a displacement detection unit that detects a displacement of the remote control transmitter based on the position detection reception signals; and a cursor control unit that controls a position of a cursor displayed on a display screen, wherein the position detection light-emission unit includes: a first light-emitting element and a second light-emitting element that are arranged symmetrically with respect to a central axis of the remote control transmitter in a first axis direction; a third light-emitting element and a fourth light-emitting element that are arranged symmetrically with respect to the central axis in a second axis direction that intersects the first axis direction; and a light-emitting element control unit that successively drives the first light-emitting element to the fourth light-emitting element through pulse position modulation by a time division driving system so as to successively emit a first light signal to a fourth light signal as the position detection light signals, the light-reception signal processing unit detects a first reception signal to a fourth reception signal corresponding respectively to the first light signal to the fourth light signal as the position detection reception signals, the displacement detection unit includes: an output detection unit that performs waveform conversion on the position detection reception signals to obtain a first output signal to a fourth output signal as position detection output signals corresponding respectively to the first reception signal to the fourth reception signal; and an arithmetic processing unit that calculates a displacement of the remote control transmitter in the first axis direction based on an amplitude correlation between the first output signal and the second output signal, and calculates a displacement of the remote control transmitter in the second axis direction based on an amplitude correlation between the third output signal and the fourth output signal, and the cursor control unit controls the position of the cursor based on the displacement of the remote control transmitter in the first axis direction and the displacement of the remote control transmitter in the second axis direction.

With this configuration, it is possible to optically detect a displacement of the remote control transmitter in the first axis direction and the second axis direction two-dimensionally, and two-dimensionally control the position of the cursor in accordance with the displacement, thereby providing an inexpensive optical remote control system that can readily control the cursor position with high accuracy and can be reduced in size.

In a remote control system according to the present invention, the position detection light-emission unit includes a start signal light-emitting element that emits a detection start light signal indicating start of a light-emission cycle of the position detection light signals.

With this configuration, it is possible to prevent signal interference by determining a detection start point of detecting a displacement of the remote control transmitter and specifying the light-emission cycle (detection cycle), thereby making it possible to reliably receive the position detection light signal to accurately determine the position detection reception signal and the position detection output signal.

In a remote control system according to the present invention, the arithmetic processing unit includes a header detection unit that detects a detection start output signal corresponding to the detection start light signal and specifies the first output signals to the fourth output signal.

With this configuration, it is possible to specify the first output signal to the fourth output signal reliably, thereby providing a remote control system that can perform position detection with high accuracy.

In a remote control system according to the present invention, a light-emission pulse width of the first light signal to the fourth light signal and a light-emission pulse width of the detection start light signal are different from each other.

With this configuration, it is possible to clearly distinguish between the detection start light signal and the position detection light signal and carry out signal processing on the position detection output signal accurately, thereby making it possible to detect a displacement of the remote control transmitter reliably.

In a remote control system according to the. present invention, the first light-emitting element and the second light-emitting element have light axes that are inclined to opposite sides with respect to the central axis, and the third light-emitting element and the fourth light-emitting element have light axes that are inclined to opposite sides with respect to the central axis.

With this configuration, the position detection reception signal corresponding to the position detection light signal is significantly influenced by a displacement of the remote control transmitter, so that it is possible to improve the detection sensitivity and the detection accuracy for a displacement of the remote control transmitter.

In a remote control system according to the present invention, the displacement of the remote control transmitter is a swing angle of the remote control transmitter.

With this configuration, it is possible to detect a displacement with high accuracy.

In a remote control system according to the present invention, the output detection unit performs waveform conversion on the first reception signal to the fourth reception signal to obtain envelope waveforms of the first reception signal to the fourth reception signal as the first output signal to the fourth output signal.

With this configuration, it is possible to readily detect the amplitudes of the first output signal to the fourth output signal with high accuracy.

A remote control system according to the present invention includes a noise filter that removes high-frequency noise contained in the envelope waveforms of the first output signal to the fourth output signal.

With this configuration, it is possible to remove high-frequency noise contained in the envelope waveforms, thereby determining the amplitude values of the envelope waveforms more accurately. Accordingly, the arithmetic processing unit can calculate the displacement of the remote control transmitter with high accuracy, so that it is possible to provide a remote control system that can control the cursor position with higher accuracy.

In a remote control system according to the present invention, the light-reception signal processing unit includes an amplifier whose gain is adjusted by a gain adjustment circuit.

With this configuration, it is possible to perform signal processing when disturbance light noise is received, and when an excessive amount of light is received.

In a remote control system according to the present invention, the amplitude correlation is an amplitude ratio.

With this configuration, it is possible to reliably determine the correlation by a simple calculation.

In a remote control system according to the present invention, the amplitude ratio, a swing angle of the remote control transmitter, and position information specifying the position of the cursor correspond to one another.

With this configuration, the cursor position can be readily referenced for the computation output (amplitude ratio), so that it is possible to readily control the cursor position with high accuracy.

In the remote control system according to the present invention, the amplitude correlation is a logarithm of an amplitude ratio.

With this configuration, it is possible to set the correlation such that it has a linear characteristic of being symmetrical for the swing angles in the positive and negative directions, thereby readily and reliably determining the correlation.

In a remote control system according to the present invention, the logarithm of the amplitude ratio, a swing angle of the remote control transmitter, and position information specifying the position of the cursor correspond to one another.

With this configuration, the cursor position can be readily referenced for the computation output (logarithm of the amplitude ratio), so that it is possible to readily control the cursor position with high accuracy.

In a remote control system according to the present invention, the amplitude correlation is a linear approximation of a logarithm of an amplitude ratio.

With this configuration, the correlation can be more simplified, so that it is possible to readily perform signal processing.

In a remote control system according to the present invention, the logarithm of the amplitude ratio, a swing angle of the remote control transmitter, and position information specifying the position of the cursor correspond to one another based on an approximating straight line obtained by the linear approximation.

With this configuration, the correlation can be more simplified, so that it is possible to readily perform signal processing.

In a remote control system according to the present invention, the position information is set corresponding to a variation in the swing angle.

With this configuration, it is possible to control the position information of the cursor in correspondence with the movement amount, thereby controlling the cursor position smoothly and quickly.

In a remote control system according to the present invention, at least two types of position information, namely coarse adjustment position information for moving the cursor in a large amount and fine adjustment position information for moving the cursor in a small amount, are set as the position information of the cursor.

With this configuration, it is possible to switch the movement amount (position information) of the cursor that corresponds to the same swing angle (absolute value or relative value) between at least two types of large and small amounts, thereby switching between coarse adjustment and fine adjustment, and selecting the resolution of controlling the cursor position. Accordingly, it is possible to improve the operability.

In a remote control system according to the present invention, the fine adjustment position information is used after using the coarse adjustment position information.

With this configuration, it is possible to initially perform coarse adjustment with a large movement amount and finally perform fine adjustment with a small movement amount, thereby providing a highly accurate remote control system that can be operated smoothly.

In a remote control system according to the present invention, switching between the coarse adjustment position information and the fine adjustment position information is carried out by changing an emission pattern of light signals constituted by the position detection light signals and the detection start light signal that are emitted from the position detection light-emission unit.

With this configuration, it is possible to switch between coarse adjustment and fine adjustment using light signals, thereby providing a system and a transmitter that have a simplified configuration.

A remote control system according to the present invention includes: a remote control transmitter including a position detection light-emission unit that emits position detection light signals; a remote control receiver including a light-reception signal processing unit that detects position detection reception signals from the position detection light signals that are received, and a displacement detection unit that detects a displacement of the remote control transmitter based on the position detection reception signals; and a cursor control unit that controls a cursor displayed on a display screen by coarse adjustment and fine adjustment, wherein the coarse adjustment is carried out based on the displacement of the remote control transmitter, and, after a fine adjustment optical code signal as position information for finely adjusting a position of the cursor is transmitted from a fine adjustment alternative signal generating means included in the remote control transmitter to the remote control receiver, the fine adjustment is carried out based on the fine adjustment optical code signal received by the remote control receiver.

With this configuration, it is possible to perform fine adjustment of the cursor position using the fine adjustment optical code signal, without any influence by the swing angle of the transmitter. Accordingly, it is possible to carry out a stable fine adjustment of the cursor position with higher accuracy.

In a remote control system according to the present invention, the fine adjustment alternative signal generating means is operated with a cross-shaped key.

With this configuration, it is possible to carry out a stable fine adjustment with good operability.

In a remote control system according to the present invention, the fine adjustment alternative signal generating means is operated with a capacitance touch pad.

With this configuration, it is possible to carry out a stable fine adjustment with good operability.

In a remote control system according to the present invention, a function of the coarse adjustment is disabled when the fine adjustment alternative signal generating means is operated.

With this configuration, it is possible to perform a stable fine adjustment, without any influence by the swing angle of the transmitter.

A remote control system according to the present invention includes: a light-emission control button that controls an on/off operation of the light-emitting element control unit, wherein the position detection light signals are emitted when the light-emission control button is pressed, emission of the position detection light signals is suspended when pressure is released from the light-emission control button, and the position of the cursor is determined when a non-detection state of the position detection output signals has continued for a predetermined time period.

With this configuration, it is possible to control the cursor position quickly, smoothly and very accurately.

A remote control system according to the present invention includes: a light-emission control button that controls an on/off operation of the light-emitting element control unit, wherein the position detection light signals are switched between emission and non-emission states each time the light-emission control button is pressed, and the position of the cursor is determined when a non-detection state of the position detection output signals has continued for a predetermined time period.

With this configuration, it is possible to control the cursor position quickly, smoothly and very accurately.

A remote control system according to the present invention includes: a light-emission control button that controls an on/off operation of the light-emitting element control unit, wherein the position detection light signals are emitted when the light-emission control button is pressed, emission of the position detection light signals is suspended when pressure is released from the light-emission control button, and the fine adjustment alternative signal generating means is enabled when a non-detection state of the position detection output signals has continued for a predetermined time period.

With this configuration, it is possible to control the cursor position quickly, smoothly and very accurately.

A remote control system according to the present invention includes: a light-emission control button that controls an on/off operation of the light-emitting element control unit, wherein the position detection light signals are switched between emission and non-emission states each time the light-emission control button is pressed, and the fine adjustment alternative signal generating means is enabled when a non-detection state of the position detection output signals has continued for a predetermined time period.

With this configuration, it is possible to control the cursor position quickly, smoothly and very accurately.

In a remote control system according to the present invention, the light-emission control button is constituted by a spring-loaded slide switch.

With this configuration, it is possible to prevent the transmitter from swaying, thereby performing a stable operation.

In a remote control system according to the present invention, the light-emission control button is constituted by a touch activated switch.

With this configuration, it is possible to prevent the transmitter from swaying, thereby performing a stable operation.

In a remote control system according to the present invention, the light-emission control button is constituted by a pressure sensor.

With this configuration, it is possible to prevent the transmitter from swaying, thereby performing a stable operation.

In a remote control system according to the present invention, the light-emission control button is constituted by a wired switch that is connected to the remote control transmitter by wire.

With this configuration, it is possible to prevent the transmitter from swaying, thereby performing a stable operation.

In a remote control system according to the present invention, the light-emission control button is constituted by a trigger of a remote control transmitter having a pistol shape.

With this configuration, it is possible to prevent the transmitter from swaying, thereby performing a stable operation.

In a remote control system according to the present invention, the remote control system is placed on a support table that rotatably supports the remote control transmitter.

With this configuration, it is possible to firmly fix the origin of swinging, thereby accurately control the cursor position based on the swing angle.

In a remote control system according to the present invention, the transmitter includes a command button for controlling emission of a command optical code signal, and the command optical code signal is emitted from at least one of the first light-emitting element, the second light-emitting element, the third light-emitting element, the fourth light-emitting element, and the start signal light-emitting element.

With this configuration, it is possible to prevent an increase of the light-emitting elements LED with an increase of the functions of the transmitter, thereby reducing the number of light-emitting elements LED.

A remote control system according to the present invention includes: a distance measuring means that measures a communication distance between the transmitter and the receiver, wherein the position of the cursor is controlled using a measured communication distance.

With this configuration, it is possible to control the cursor position three-dimensionally.

A display device according to the present invention is a display device in which a cursor displayed on a display screen is controlled by a remote control system, wherein the remote control system is the remote control system according the present invention.

With this configuration, it is possible to provide a display device including an optical remote control system that can readily control the cursor position with high accuracy.

An electronic device according to the present invention includes a drag and drop function of dragging and dropping an icon displayed on a monitor screen while the icon is selected by a pointer, using a remote operation device, thereby executing an application corresponding to the dropped icon in a predetermined mode, wherein one or a plurality of content icons and device icons are displayed on the monitor screen, and an arbitrary content icon is dragged and dropped onto an arbitrary device icon, thereby executing an application corresponding to the device icon in a predetermined mode.

Specifically, device icons of a television, a recording device such as a VTR and a DVD recorder, a video camera, and a PC and the like, and content icons of content-providing media (e.g., terrestrial broadcasting, satellite broadcasting, cable television and DVD disks) are provided on the monitor screen. Then, in the case of a DVD recorder for example, playback, recording, preprogrammed recording and the like are carried by dragging and dropping the content icons onto the device icons.

Furthermore, in an electronic device according to the present invention, one or a plurality of content icons, device icons and operation icons, and setting fields for the icons are displayed on the monitor screen, and an arbitrary content icon is dragged and dropped onto the corresponding setting field, an arbitrary device icon is dragged and dropped into the corresponding setting field, and an arbitrary operation icon is dragged and dropped onto the corresponding setting field, thereby executing an application corresponding to the icons that are set.

Specifically, device icons of a television, a VTR, a HDD-containing DVD recorder, a video camera, a PC and the like, content-providing media (e.g., terrestrial broadcasting, satellite broadcasting, cable television and DVD disks) are provided on the monitor screen. Furthermore, operation icons of playback, recording, preprogrammed recording and the like, and setting fields for the icons are provided on the monitor screen. Then, an arbitrary content icon is dragged and dropped onto the corresponding setting field, an arbitrary device icon is then dragged and dropped onto the corresponding setting field, and an arbitrary operation icon is dragged and dropped onto the corresponding setting field, thereby executing a predetermined application in accordance with the contents of the icons set in the setting field.

Furthermore, in an electronic device according to the present invention, one or a plurality of content icons and household appliance icons are displayed on the monitor screen, and, when a household appliance icon is selected, locations in which a household appliance corresponding to the above-mentioned household appliance icon is installed are displayed on a floor plan on the monitor screen, and a desired location of the household appliance is selected from the above-mentioned locations. The selection of a household appliance to be operated can be performed, for example, by moving the pointer on the monitor screen to a location in which the household appliance is installed on the floor plan such that the setting screen for the appliance is displayed on the monitor screen. By inputting the operational information for the appliance on the setting screen, it is possible to differentiate the setting of the appliance from that of other appliances.

With an electronic device according to the present invention may be configured such that the remote operation device includes a light-emission unit that emits as output a position detection light signal, a light-receiving unit that receives as input the position detection light signal and obtains a position signal from a detected light-reception signal is provided at the body of the electronic device, and the drag and drop operation is performed by moving the pointer on the monitor screen vertically and laterally by moving the remote operation device itself vertically and laterally. In this case, a movement direction of the remote operation device is detected based on a reception amount of the position detection light signal. Examples of the method for detecting the orientation of the remote operation device based on the amount of light received from the remote operation device include: (1) a method that uses two elliptical LEDs having different wavelengths; (2) a method that uses a PSD (Position Sensitive Detector); and (3) a method that lights an LED in varied directions, and performs detection based on the ratio of the amounts of light received. The movement direction of the remote operation device can be determined by using one of these methods, and it is therefore possible to move the pointer to the corresponding position to operate the device. Thus, since it is possible to move the pointer on the monitor screen vertically and laterally by moving the remote operation device itself vertically and laterally, the user can operate the pointer intuitively while looking at the monitor screen, without having to looking at the keys disposed on the remote operation device.

In this case, the relationship between the manner of moving the remote operation device and the movement of the pointer can be set such that the pointer is moved in a swung direction by a preset minimum movement amount by swinging the remote operation device back and forth once. With this configuration, the swinging direction and the number of times of swinging of the remote operation device match the movement direction and the number of times of movement of the pointer on the monitor screen, so that the user can operate the pointer intuitively while looking at the monitor screen.

In addition to the above, the relationship between the manner of moving the remote operation device and the movement of the pointer can be set such that by holding the remote operation device inclined in a swung direction for a fixed time period, the pointer on the monitor screen is continuously moved in the inclined direction. With this configuration, it is possible to improve the operability when the pointer has a long moving distance.

Furthermore, an electronic device according to the present invention may be configured such that a lever that can be tilted forward or backward and can be pressed down at a right angle is provided in the remote operation device, a center of enlargement is specified by pressing the lever down at a right angle, and then a screen display is enlarged or reduced by tilting the lever forward or backward. With this configuration, for example, in the case of viewing small prints or when the characters are too small to recognize, the characters can be made easy to recognize by enlarging the necessary region. Additionally, in the case of watching a Web screen of a PC on a television, text written in small characters may be contained. It will be convenient if it is possible to enlarge the necessary region in such a case. Further, the operation of enlarging or reducing a map viewed on the Web is generally performed by clicking on a predetermined scale, and this cannot be called an intuitive method. In contrast, the screen is enlarged by tilting the lever forward, and reduced by tilting the lever backward, thus realizing an intuitive operation.

Furthermore, an electronic device according to the present invention may be configured such that a device to be operated is switched using the lever. For example, the lever is used to switch the operation screens for devices connected to a television, including for example, a DVD recorder, a digital camera, a game console, terrestrial broadcasting TV, satellite broadcasting TV and a PC and so on. By switching the device-specific content, such as a program recorded on a DVD recorder, images captured with a digital camera and a game, for each screen in this way, it is possible to display a listing of an enormous number of titles, and allow the necessary title to be selected from the listing. This makes it possible to reduce the number of operations necessary for the selection.

Furthermore, an electronic device according to the present invention may be configured such that an operation menu screen for a device to be operated is switched using the lever. For example, in the case of switching the search condition for recorded programs, it is possible to sort the programs “by date”, “by title”, “by genre” and so on, or perform scroll in ascending order or descending order by tilting the lever. This is a very convenient function for a user to locate a desired program in a currently available hard disk recorder having a very large capacity and capable of recording an enormous number of programs. For example, in the case of selecting a desired program from an enormous number of programs of CATV, for example, it is possible to sort the programs “by channel viewing frequency”, “by title”, “by genre” and so on, or to scroll in ascending order or descending order by tilting the lever.

Furthermore, an electronic device according to the present invention may be configured such that a cross-shaped key for inputting a vertical command and a lateral command is provided in the remote operation device, and a screen display is enlarged or reduced by pressing an up key or a down key of the cross-shaped key. When the remote operation device is equipped with a cross-shaped key, it is not necessary to provide a lever in addition to the cross-shaped key if the forward and backward operations of the lever are assigned to the up key and the down key of the cross-shaped key. Accordingly, it is possible to reduce the number of keys provided on the remote operation device.

Furthermore, an electronic device according to the present invention may be an electronic device including a remote operation device that emits as output various light signals from a light-emission unit, wherein a light-reception detection unit that receives the light signals and detects a change in a light reception amount, and a method for operating a screen is switched based on a change in a light reception amount detected by the light-reception detection unit by swinging the remote operation device forward and backward. Specifically, at a changing point of the movement direction of the remote operation device, for example, the volume is increased when the initial movement direction is upward, and decreased when the initial movement direction is downward, and the channel is changed by one in the forward direction (up direction) when the initial movement direction is rightward, and changed by one in the backward direction (down direction) when the initial movement direction is leftward. This makes it possible to adjust the volume and to switch the channels without looking at the remote control transmitter to search for the necessary button.

Furthermore, an electronic device according to the present invention may be an electronic device including a remote operation device that emits as output various light signals from a light-emission unit, wherein a light-reception detection unit that receives the light signals and detects a change in a light reception amount, and a method for operating a screen is switched based on a change in a light reception amount detected by the light-reception detection unit by swinging the remote operation device forward and backward. The forward and backward movements of the remote operation device can be detected by equipping the remote operation device with, for example, a light-emitting element having isotropic directivity, and making the detection based on the amount of light received by the light-emitting element. In this case, the light amount does not change very much even if the orientation of the remote operation device changes, and it changes only when the distance to the light-reception detection unit changes. Accordingly, it is possible to distinguish between a change in orientation and a change in distance.

Furthermore, an electronic device according to the present invention may be an electronic device that can control a camera device and includes a remote operation device that emits as output various light signals from a light-emission unit, wherein a light-reception detection unit that receives the light signals and detects a change in a light reception amount, and an orientation of the camera device is moved in a lateral direction or a vertical direction based on a change in a light reception amount detected by the light-reception detection unit by swinging the remote operation device in the lateral or the vertical direction. Thus, since the orientation of the camera device can be changed by changing the orientation of the remote operation device, it is possible to operate the camera device more intuitively as compared with, for example, a case where the camera device is operated by pressing a cross-shaped key disposed on the remote operation device. This technique is applicable not only to camera devices used in video telephone systems, but also to security cameras, monitoring cameras and the like.

As described above, with the electronic device according to the present invention, it is possible to perform all the various sophisticated functions of the device by looking at the display screen, so that it is not necessary to look at the remote operation device. Accordingly, it is possible to realize a simple remote operation device in which only a minimum number of buttons and levers for directly transmitting channel numbers or commands for increasing and decreasing the volume are disposed. Consequently, the remote operation device according to the present invention can be operated by a more intuitive and simpler procedure than in operations of conventional remote operation devices using a cross-shaped key, so that anyone, including children, elderly people and persons who are not very familiar with electronic devices, can freely make use of highly advanced household appliances.

### BRIEF DESCRIPTION OF THE DRAWINGS

FIGS. 1(A) and 1(B) are conceptual diagrams schematically showing a relevant part of a display device to which a remote control system according to the present invention is applied. FIG. 1(A) shows a positional state of a cursor displayed on the display screen of the display device before transmitting a remote control signal, and FIG. 1(B) shows a positional state of a cursor displayed on the display screen of the display device after transmitting remote control signals.

FIGS. 2(A) and 2(B) are explanatory diagrams schematically showing an external view of the remote control transmitter according to Embodiment 1 of the present invention. FIG. 2(A) is a plan view as viewed from vertically above during use, and FIG. 2(B) is a front view as viewed from the arrow B direction in FIG. 2(A).

FIG. 3(A) is a schematic circuit diagram showing a position detection light-emission unit of the remote control transmitter according to Embodiment 1 of the present invention, and FIG. 3(B) is a waveform chart showing light-emission timing of light signals emitted from light-emitting elements of the same position detection light-emission unit of the remote control transmitter according to Embodiment 1.

FIG. 4 is a circuit block diagram illustrating a schematic circuit configuration and a cursor control unit of the remote control receiver according to Embodiment 1 of the present invention.

FIG. 5(A) is a waveform chart of light signals emitted from the position detection light-emission unit shown in FIG. 3(B), FIG. 5(B) is a waveform chart of position detection reception signals received and detected by the remote control receiver shown in FIG. 4, and FIG. 5(C) is a waveform chart of the same position detection output signals.

FIG. 6 is a circuit diagram showing a working example of the output detection unit shown in FIG. 4.

FIG. 7 is a block diagram schematically showing a configuration of the arithmetic processing unit shown in FIG. 4.

FIG. 8 is a diagram showing a layout of a relevant part of a remote control system according to Embodiment 2 of the present invention.

FIG. 9 is a graph of measured values showing a relationship between the swing angle and the amplitude of the position detection output signals in the remote control system according to Embodiment 2 of the present invention.

FIG. 10 is a graph showing the amplitude ratios of the position detection output signals in the first axis direction as logarithms for the measured values shown in FIG. 9.

FIG. 11 is a graph showing the amplitude ratios of the position detection output signals in the second axis direction as logarithms for the measured values shown in FIG. 9.

FIG. 12 is a chart for illustrating a form of coordinate transformation for letting the logarithm of the amplitude ratio of the position detection output signals correspond to the position information of the cursor in the remote control system according to Embodiment 2 of the present invention.

FIG. 13 is an explanatory diagram for describing a relationship between the X-axis position information and the cursor position determined with reference to FIG. 12.

FIG. 14 is a graph showing a relationship between the swing angle and the logarithm of the amplitude ratio of the position detection output signals when linear approximation is applied to the logarithm of the amplitude ratio of the position detection output signals in a remote control system according to Embodiment 3 of the present invention.

FIG. 15 is a chart illustrating a form of coordinate transformation for letting a linearly approximated logarithm correspond to the position information of the cursor when the logarithm of the amplitude ratio of the position detection output signals is linearly approximated in the remote control system according to Embodiment 3.

FIG. 16 is an explanatory diagram illustrating a form of coordinate transformation for changing the cursor position in correspondence with a variation in the swing angle in a remote control system according to Embodiment 4.

FIGS. 17(A) and 17(B) are diagrams for illustrating a case where coarse adjustment and fine adjustment are made possible using two types of large and small movement amounts of a cursor for the same swing angle of the transmitter in a remote control system according to Embodiment 5 of the present invention. FIG. 17(A) is an explanatory diagram showing a state of movement of the cursor displayed on the display screen, and FIG. 17(B) is a chart showing a relationship between the swing angle of the transmitter and the movement amount (position information) of the cursor that corresponds to movement of the cursor.

FIG. 18 is a chart for describing how two types of X-axis position information are set for coarse adjustment and fine adjustment in correspondence with the swing angle of the transmitter in variation control with the resolutions shown in FIG. 17.

FIGS. 19(A), 19(B) and 19(C) are diagrams for schematically illustrating a configuration of the resolution switching means in variation control with the resolutions shown in FIG. 17. FIG. 19(A) shows an external view of the transmitter, FIG. 19(B) is a diagram showing the resolution switching means being held with a strong force, and FIG. 19(C) is a diagram showing the resolution switching means being held with a weak force.

FIGS. 20(A), 20(B) and 20(C) are diagrams schematically showing how operations are carried out when coarse adjustment and fine adjustment are performed in a remote control system according to Embodiment 6 of the present invention. FIG. 20(A) is an explanatory diagram showing a state of movement of a cursor displayed on the display screen, FIG. 20(B) is a diagram showing how the transmitter is operated in coarse adjustment indicated by the arrow B in FIG. 20(A), and FIG. 20(C) is a diagram showing how the transmitter is operated in fine adjustment indicated by the arrow C in FIG. 20(A).

FIGS. 21(A), 21(B) and 21(C) are diagrams schematically showing how operations are carried out when coarse adjustment and fine adjustment are performed in the remote control system according to Embodiment 6, similarly to FIGS. 20(A) to 20(C). FIG. 21(A) is an explanatory diagram showing a state of movement of the cursor displayed on the display screen, FIG. 21(B) is a diagram showing how the transmitter is operated in the coarse adjustment indicated by the arrow B in FIG. 21(A), and FIG. 21(C) is a diagram showing how the transmitter is operated in the fine adjustment indicated by the arrow C in FIG. 21(A).

FIG. 22 is a flowchart of a first flow example showing the relation between an on/off operation of the light-emitting element control unit and determination of the cursor position in the remote control systems according to Embodiment 1 to Embodiment 5.

FIG. 23 is a flowchart of a second flow example showing the relation between an on/off operation of the light-emitting element control unit and determination of the cursor position in the remote control systems according to Embodiment 1 to Embodiment 5.

FIG. 24 is a flowchart of a first flow example showing the relation between an on/off operation of the light-emitting element control unit and a fine adjustment alternative signal generating means in the remote control systems according to Embodiment 6.

FIG. 25 is a flowchart of a second flow example showing the relation between an on/off operation of the light-emitting element control unit and the fine adjustment alternative signal generating means in the remote control system according to Embodiment 6.

FIG. 26 is a plan view conceptually showing a state in which a spring-loaded slide switch is used as the light-emission control button.

FIGS. 27(A) and 27(B) are explanatory diagrams conceptually showing a state in which a touch activated switch is used as the light-emission control button. FIG. 27(A) shows a plan view and FIG. 27(B) shows a side view.

FIGS. 28(A), 28(B) and 28(C) are diagrams conceptually showing a state in which a pressure sensor is used as the light-emission control button. FIG. 28(A) is a plan view, FIG. 28(B) is a conceptual diagram showing a state in which the pressure sensor is held with a weak force, and FIG. 28(C) is a conceptual diagram showing a state in which the pressure sensor is held with a strong force.

FIG. 29 is a diagram conceptually showing a state in which a wired switch is used as the light-emission control button.

FIG. 30 is a diagram conceptually showing a state in which the remote control transmitter is formed into a pistol shape and the trigger of the pistol is used as the light-emission control button.

FIG. 31 is a perspective view showing a remote control transmitter that is mounted to a support table to control a cursor.

FIG. 32 is a diagram conceptually showing a remote control transmitter that is provided with command buttons.

FIG. 33 is an explanatory diagram conceptually showing a remote control system that is provided with a distance measuring means and controls the cursor three-dimensionally.

FIGS. 34(A) and 34(B) are charts for illustrating the magnitude of amplitudes detected in FIG. 33. FIG. 34(A) is a waveform chart for a short communication distance, and FIG. 34(B) a waveform chart for a long communication distance.

FIG. 35 is a block diagram showing the basic configuration of a television receiver provided with such a drag and drop function, which is an electronic device according to one embodiment of the present invention.

FIG. 36 is a diagram for describing one embodiment of the schematic configuration of a relevant part of the remote operation device and a monitor according to the present invention.

FIG. 37 is a diagram for illustrating the operation principles of a remote operation device according to the present invention, and schematically shows an optical indicating device and a light-reception device (position detection light-receiving element) of the remote operation device.

FIG. 38 is a diagram for describing the operation principles of the same remote operation device according to the present invention, and is a graph showing correlation between the relative light intensity of the position detection light signal (light-reception signal) detected by the position detection light-receiving element and the reference axis displacement angle as a relative light intensity to reference axis displacement angle characteristic.

FIG. 39 is a waveform chart showing an example waveform of light emission pulse signals at an optical indicating device of a remote operation device according to the present invention.

FIG. 40 is a block diagram showing a working example of a circuit configuration of a light-reception device of a remote operation device according to the present invention.

FIG. 41 is a diagram showing another embodiment of a schematic configuration of a relevant part of a remote operation device and a monitor according to the present invention.

FIGS. 42(A) is a front view of a PSD, and FIG. 42(B) is a front view of the PSD as viewed from another direction.

FIG. 43 is a block diagram showing another working example of a circuit configuration of a light-reception device of a remote operation device according to the present invention.

FIG. 44 is a cross-sectional view illustrating the structure and the operation principles of the PSD.

FIG. 45 is a diagram schematically showing how a position of an optical operation device is detected using a PSD, and a pointer on a screen is moved.

FIGS. 46(A) and FIG. 46(B) are plan views showing how a moving distance of a pointer on a screen changes depending on the distance between the optical operation device and the screen.

FIG. 47(A) is a front view showing a relevant part of a form of a displacement position of an optical indicating device (position detection light-emitting element) of a remote operation device according to the present invention, and FIG. 47(B) is a perspective view showing the relevant part taken along the arrows X-X in FIG. 47(A).

FIG. 48(A) is a front view showing a relevant part of another form of a displacement position of an optical indicating device (position detection light-emitting element) of a remote operation device according to the present invention, and FIG. 48(B) is a perspective view showing the relevant part taken along the arrows X-X in FIG. 48(A).

FIG. 49(A) is a front view showing a relevant part of a still another form of a displacement position of an optical indicating device (position detection light-emitting element) of a remote operation device according to the present invention, and FIG. 49(B) is a perspective view showing the relevant part taken along the arrows X-X in FIG. 49(A).

FIG. 50(A) is a front view showing a relevant part of another form of a displacement position of an optical indicating device (position detection light-emitting element) of a remote operation device according to the present invention, and FIG. 50(B) is a perspective view showing the relevant part taken along the arrows X-X in FIG. 50(A).

FIG. 51(A) is a front view showing a relevant part of a still another form of a displacement position of an optical indicating device (position detection light-emitting element) of a remote operation device according to the present invention, and FIG. 51(B) is a perspective view showing the relevant part taken along the arrows X-X in FIG. 51(A).

FIG. 52 is an explanatory diagram for describing the principles of detecting the reference axis displacement angle of a remote operation device according to the present invention and is a graph showing correlation between the relative light intensity of the position detection light signal (light-reception signal) detected by the position detection light-receiving element and the reference axis displacement angle as a relative light intensity to reference axis displacement angle characteristic.

FIGS. 53(A) to 53 (D) are diagrams for describing the principles of remote control in which a remote operation device according to the present invention is operated by being swung.

FIGS. 54(A) to 54 (D) are diagrams for describing the principles of remote control in which a remote operation device according to the present invention is operated by being swung.

FIG. 55 is an explanatory diagram for describing the principles of remote control in which a remote operation device according to the present invention is operated by being swung.

FIG. 56 is an explanatory diagram showing Working Example 1 in which a device connected to a television is operation using a remote operation device according to the present invention.

FIG. 57 is an explanatory diagram showing Working Example 2 in which a device connected to a television is operation using a remote operation device according to the present invention.

FIG. 58 is an explanatory diagram showing Working Example 3 in which a device connected to a television is operation using a remote operation device according to the present invention.

FIG. 59 is an explanatory diagram showing Working Example 4 in which a device connected to a television is operation using a remote operation device according to the present invention.

FIGS. 60(A) and 61(B) are explanatory diagrams showing a processing action of Working Example 5 in which a device connected to a television is operation using a remote operation device according to the present invention.

FIG. 61 is an explanatory diagram showing Working Example 6 in which a device connected to a television is operation using a remote operation device according to the present invention.

FIG. 62(A) is an explanatory diagram showing a lever that is include in a remote controller for performing enlargement and reduction of a screen display, and FIG. 62(B) is an explanatory diagram showing a cross-shaped key and a lever that are included in a remote controller for performing enlargement and reduction of a screen display.

FIG. 63(A) is a diagram showing Working Example 8 in which volume is adjusted by vertically swinging a remote operation device according to the present invention up and down, and FIG. 63(B) is also an explanatory diagram showing Working Example 8 in which channels are switched by laterally swinging a remote operation device according to the present invention.

FIG. 64 is an explanatory diagram showing Working Example 9 in which an operation method is switched by swinging a remote operation device according to the present invention back and forth.

FIG. 65 is an explanatory diagram showing a video telephone system with which a camera of another user is operated by swinging a remote operation device according to the present invention.

FIG. 66 is an explanatory diagram showing a video telephone system with which a camera of another user is operated by swinging a remote operation device according to the present invention.

### DESCRIPTION OF THE PREFERRED EMBODIMENTS

Embodiments of the present invention are described below with reference to the accompanying drawings.

<Principles of Remote Control System of the Present Invention>

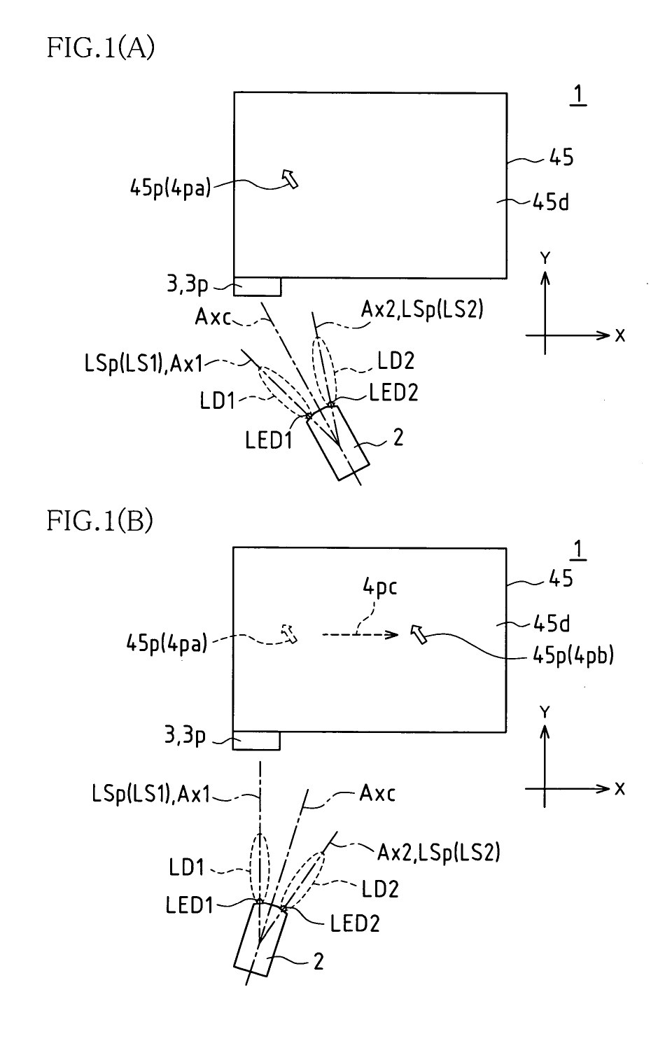

FIGS. 1(A) and 1(B) are conceptual diagrams schematically showing a relevant part of a display device to which a remote control transmitter, a remote control receiver and a remote control system constituting a remote control system according to the present invention are applied. FIG. 1(A) shows a positional state of a cursor displayed on a display screen of the display device before transmitting a remote control signal, and FIG. 1(B) shows a positional state of a cursor displayed on the display screen of the display device after transmitting remote control signals.

A remote control system 1 (hereinafter, may be simply referred to as “system 1”) according to the present invention is a so-called infrared optical remote controller system (infrared remote control system) that includes, as its main components, an optical remote control transmitter 2 (hereinafter, may be simply referred to as “transmitter 2”) that transmits position detection light signals LSp as remote control signals and a remote control receiver 3 (hereinafter, may be simply referred to as “receiver 3”) that receives the position detection light signals LSp and recognizes (detects) the details of remote control instruction (displacement of the transmitter 2) based on the magnitude of the signals. It should be noted that the transmitter 2 is shown in a plan (top) view as viewed from vertically above during use.

In the present invention, remote control using the system 1 is performed for a cursor 45p, such as a pointer, displayed on a display screen 45d of a display device 45. The display device 45 may be, for example, a monitor or a television receiver, which displays information such as images and data. It should be noted that a front view of the display screen 45d, which has a plane extending in vertical direction, as viewed horizontally, is shown.

A light-receiving unit 3p of the receiver 3 is disposed (contained) in a front frame portion of the display device 45, but the light-receiving unit 3p also may be disposed overlaying on the display screen 45d. The main components of the receiver 3 are disposed (contained) inside the display device 45.

The transmitter 2 is operated (e.g., panned or swung) in a free space, and therefore a central axis Axc of the transmitter 2 can be freely panned (the transmitter 2 can be freely swung) in a first axis direction X (for example, corresponding to a horizontal direction), a second axis direction Y (for example, corresponding to a vertical direction that is orthogonal to the horizontal direction), or in a direction that is inclined to these directions.

Preferably, the first axis direction X and the second axis direction Y are defined such that they are orthogonal to each other. However, there is no limitation to this, and they may intersect at an angle close to a right angle such that a light signal in the first axis direction X and a light signal in the second axis direction Y can be distinguished and detected.

The system 1 is configured such that the position detection light signals LSp transmitted from the transmitter 2 are received by the receiver 3, the panning state of the transmitter 2 is detected based on the contents (magnitude of absolute values, and relative ratio) of the received (received and detected) position detection light signals LSp (remote control signals), and the position of the cursor 45p displayed on the display screen of the display screen 45 is controlled according to the panning state (for example, swinging or panning to the right and swinging or panning to the left).

FIG. 1(A) shows a cursor 4pa before the movement, and FIG. 1(B) shows a cursor 4pb after the movement and a movement trajectory 4pc. That is, when the transmitter 2 is panned rightward, the cursor 45p displayed on the display screen 45d is panned from the left (the cursor 4pa) to the right (the cursor 4pb) on the screen, corresponding to the panning.

The transmitter 2 has the central axis Axc as a reference axis serving as a positional reference corresponding to the transmission direction of the position detection light signal LSp. A first light-emitting element LED1 and a second light-emitting element LED2 are disposed spaced apart from each other such that they are symmetrical with respect to the central axis Axc of the transmitter 2 in a horizontal direction as the first axis direction X that intersects the central axis Axc of the transmitter 2. That is, the intersection point between the central axis Axc and the horizontal direction X can be defined as an origin, and the first light-emitting element LED1 and the second light-emitting element LED2 are arranged symmetrically with respect to the origin.

For simplicity, here (in the description of the general principle), remote control of the cursor 45p in a horizontal direction (a lateral direction of the display screen 45d) using the first light-emitting element LEDI and the second light-emitting element LED2 is described.

The first light-emitting element LED1 has a light axis Ax1 and a light intensity distribution characteristic LD1. The second light-emitting element LED2 has a light axis Ax2 and a light intensity distribution characteristic LD2. It is preferable that the light axes Ax1 and Ax2 are inclined in opposite directions with respect to the central axis Axc in order to improve the sensitivity and the accuracy, but there is no limitation to this. For example, it is also possible to achieve a similar effect by widening the space between the first light-emitting element LED1 and the second light-emitting element LED2.

It is preferable that the light intensity distribution characteristics LD1 and LD2 are substantially equivalent in order to improve the sensitivity and the accuracy, but there is no limitation to this, as long as their correlation is specified.

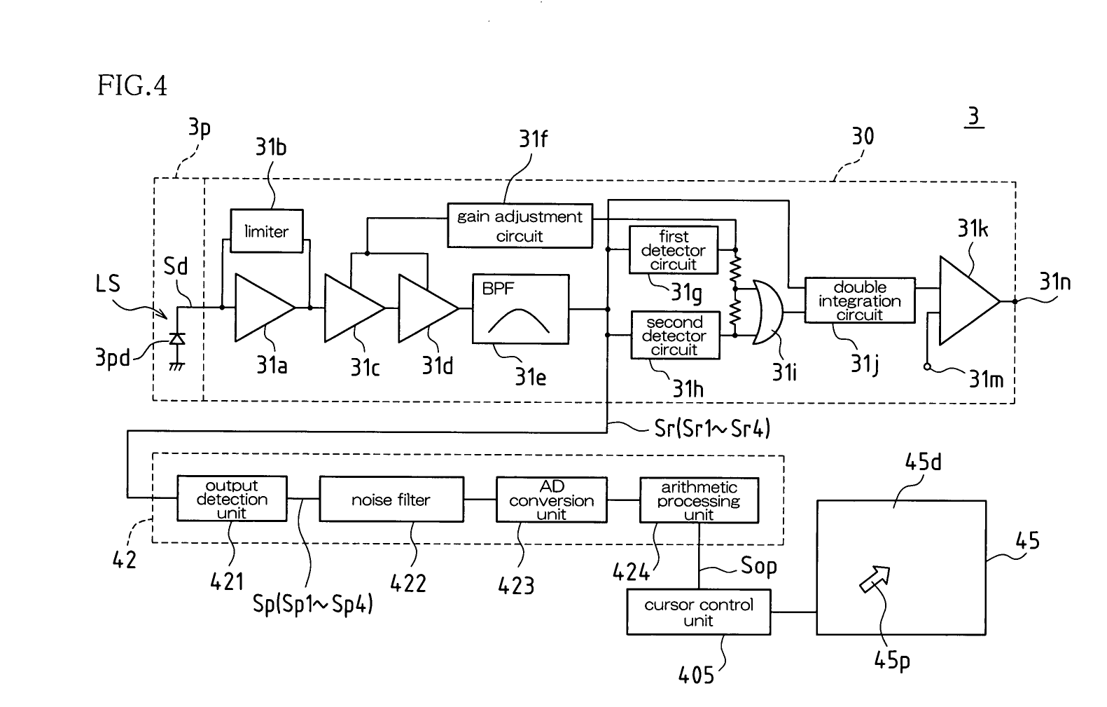

In the state shown in FIG. 1(A), the central axis Axc (the transmitter 2) is directly facing the light-receiving unit 3p, and therefore the magnitudes of the position detection light signals LSp received by the receiver 3 for the position detection light signals LSp transmitted from the first light-emitting element LED1 and the second light-emitting element LED2 (a position detection light signal from the first light-emitting element LED1 is referred to as a “first light signal LS1”, and a position detection light signal from the second light-emitting element LED2 is referred to as a “second light signal LS2”; however, these signals are both simply referred to as “position detection light signals LSp” when it is not necessary to distinguish between them) are detected as position detection reception signals Sr (see Embodiment 1, FIG. 4) and position detection output signals Sp (see Embodiment 1, FIG. 4) that are substantially equivalent. Accordingly, the cursor 45p maintains (displays) its state before movement (the cursor 4pa).

Since the central axis Axc is depicted as being inclined to the light-receiving unit 3p in the drawings, it appears to be not directly facing the light-receiving unit 3p. However, in the actual system 1, the distance between the transmitter 2 and the light-receiving unit 3p is sufficiently long in comparison to the structures of the transmitter 2 and the light-receiving unit 3p. Therefore, as described above, the position detection light signals LSp transmitted from the first light-emitting element LED1 and the second light-emitting element LED2 are detected as being substantially equivalent by the receiver 3, so that it is possible to treat that transmitter 2 as being directly facing the light-receiving unit 3p.

Next, when the light axis Ax1 of the first light-emitting element LED1 is caused to be, for example, directly facing the light-receiving unit 3p of the receiver 3 by horizontally moving the transmitter 2, the amount of light from the first light-emitting element LED1 (first light signal LS1) becomes larger than the amount of light from the second light-emitting element LED2 (second light signal LS2). Accordingly, a rightward movement of the transmitter 2 can be detected by the light-receiving unit 3p (receiver 3).

The state of FIG. 1(B) shows a state in which the position of the cursor 45p is controlled to move as shown in the movement trajectory 4pc by moving the transmitter 2, and this position is shown as the after-movement cursor 4pb.

It should be noted that the first light signal LS1 from the first light-emitting element LED1 and the position detection light signal LSp from the second light-emitting element LED2 can be distinguished by making the emission timing of these signals different from each other. That is, the transmitter 2 is configured such that it can transmit the position detection light signal LSp as a pulse position modulation (PPM) signal by driving the first light-emitting element LED1 and the second light-emitting element LED2 by a time division driving system. With pulse position modulation, it is possible to obviate the influence of scattering light, EMC (electromagnetic compatibility) noise and the like.

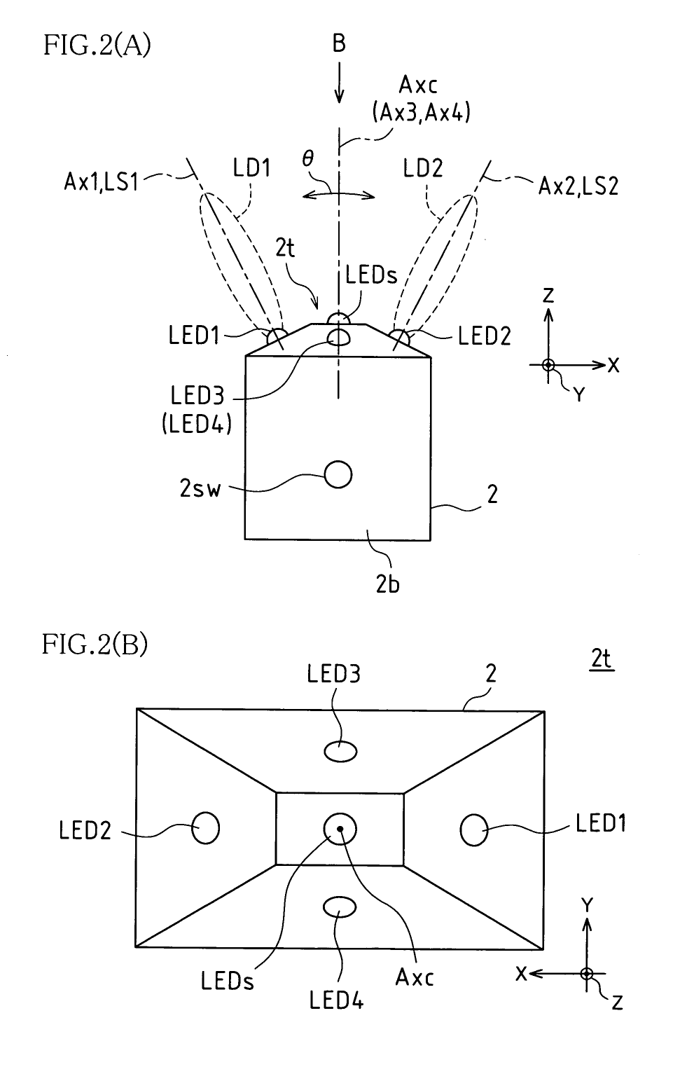

In this description of the principles, horizontal control of the cursor 45p using the horizontally arranged first light-emitting element LED1 and second light-emitting element LED2 arranged horizontally was described. It is also possible to perform vertical control of the cursor 45p in the same manner as in the case of the horizontal control, by vertically arranging light-emitting elements (a third light-emitting element LED3 and a fourth light-emitting element LED4 (see Embodiment 1, FIG. 2)). That is, it is possible to perform movement control of the position of the cursor 45p on two-dimensional plane of the display screen 45d.

The display device 45 can control the position of the cursor 45p very accurately and readily by using the optical remote control system 1 to control the position of the cursor 45p displayed on the display screen 45d.

### Embodiment 1

FIGS. 2(A) and 2(B) are explanatory diagrams schematically showing an external view of the remote control transmitter according to Embodiment 1 of the present invention. FIG. 2(A) is a plan view as viewed from vertically above during use, and FIG. 2(B) is a front view as viewed from the arrow B direction in FIG. 2(A).

A first light-emitting element LED1 (disposed on the right side in the front view) and a second light-emitting element LED2 (disposed on the left side in the front view) are arranged at a tip portion 2t of a transmitter 2 such that they are symmetrical about the intersecting point between a central axis Axc of the transmitter 2 and a first axis direction X (corresponding to a horizontal direction) of the tip portion 2t (a front portion of the transmitter 2 that is made opposite to a light-receiving unit 3p) of the transmitter 2.

The first light-emitting element LED1 and the second light-emitting element LED2 are disposed on inclined planes appropriately formed at the tip portion 2t so as to form a light axis Ax1 and a light axis Ax2 that are inclined to opposite sides with respect to the central axis Axc. The purpose of making the light axis Ax1 and the light axis Ax2 inclined to opposite sides with respect to the central axis Axc is to improve the detection accuracy and the detection sensitivity, as mentioned in the description of the principles.

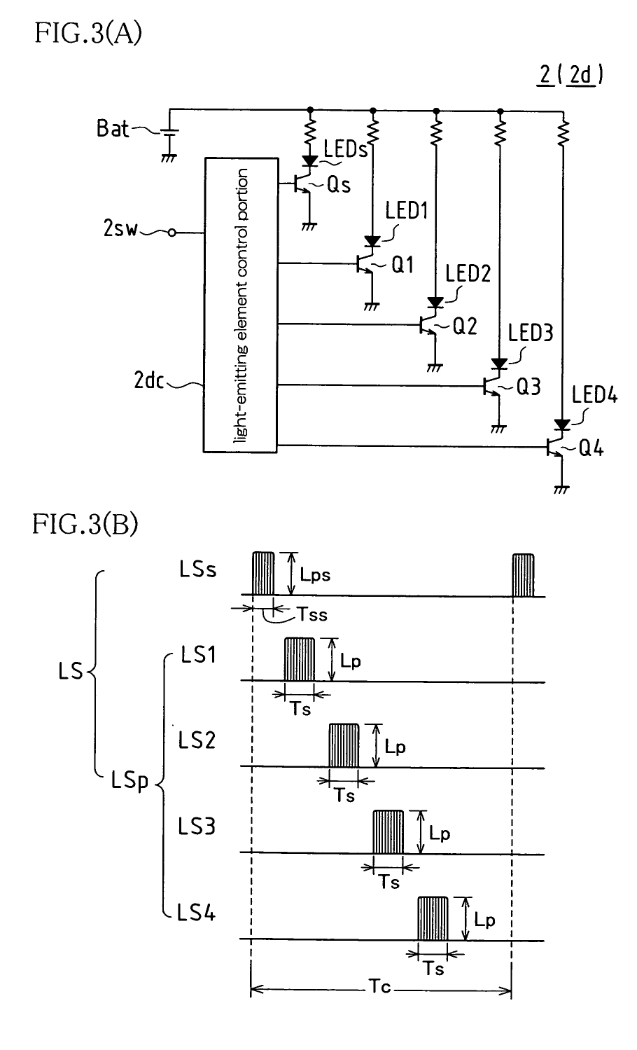

The first light-emitting element LED1 and the second light-emitting element LED2 are configured to emit position detection light signals LSp (a first light signal LS1 and a second light signal LS2 (see FIG. 3)) at different timing.

Also for a second axis direction Y (corresponding to a vertical direction) intersecting (here, for simplicity, intersecting at a right angle) the first axis direction X, the third light-emitting element LED3 (disposed on the upper side in the front view) and the fourth light-emitting element LED4 (disposed on the lower side in the front view) are arranged at the tip portion 2t of the transmitter 2 such that they are vertically symmetrical about the intersecting point between the central axis Axc and the second axis direction Y, as in the case of the first axis direction X.

The third light-emitting element LED3 and the fourth light-emitting element LED4 are disposed on inclined planes appropriately formed at the tip portion 2t so as to form a light axis Ax3 and a light axis Ax4 that are inclined to opposite sides with respect to the central axis Axc. The purpose of making the light axis Ax3 and the light axis Ax4 inclined to opposite sides with respect to the central axis Axc is to improve the detection accuracy and the detection sensitivity, as with the light axis Ax1 and the light axis Ax2.

The third light-emitting element LED3 and the fourth light-emitting element LED4 are configured to emit position detection light signals LSp (a third light signal LS3 and a fourth light signal LS4 (see FIG. 3)) at different timing.

The state of horizontal (lateral) movement (state of swinging, swing angle θ) of the transmitter 2 can be detected due to the first light-emitting element LED1 and the second light-emitting element LED2, and the state of vertical (up-down) movement (state of swinging, swing angle θ) of the transmitter 2 can be detected by the third light-emitting element LED3 and the fourth light-emitting element LED4. Since the state of horizontal movement and the state of vertical movement of the transmitter 2 can be respectively detected, it is possible to detect two-dimensional movement of the transmitter 2 by combining them. Accordingly, it is possible to perform two-dimensional movement control of the position of the cursor 45p on the display screen 45d.

The tip portion 2t is provided with a start signal light-emitting element LEDs that emits a detection start light signal LSs (see FIG. 3(A)) indicating start of a light-emission cycle (detection cycle) Tc (see FIG. 3(A)) of the position detection light signal LSp on a plane orthogonal to the central axis Axc (plane parallel to the plane defined by the first axis direction X and the second axis direction Y intersecting each other).

A body portion 2b of the transmitter 2 is provided with a light-emission control button 2sw. By turning on (e.g., pressing) the light-emission control button 2sw, detection of the movement (swinging) state of the transmitter 2 is started, and the system 1 (receiver 3 (see FIG. 4)) starts detection of the movement state of the transmitter 2 (movement control of the position of the cursor 45p). That is, the start signal light-emitting element LEDs, the first light-emitting element LED1, the second light-emitting element LED2, the third light-emitting element LED3 and the fourth light-emitting element LED4 are successively driven, and the detection start light signal LSs, and the first light signal LS1, the second light signal LS2, the third light signal LS3 and the fourth light signal LS4 as the position detection light signals LSp are successively emitted and transmitted to the light-receiving unit 3p.

As described above, the transmitter 2 is provided with four position detection light-emitting elements (the first light-emitting element LED1, the second light-emitting element LED2, the third light-emitting element LED3 and the fourth light-emitting element LED4) and a single light-emitting element (the start signal light-emitting element LEDs) that indicates start of a detection cycle (hereinafter, these light-emitting elements are simply referred to as “light-emitting elements LED” where it is not particularly necessary to distinguish between them).

It should be noted that the arrangement of the first light-emitting element LED1 to the fourth light-emitting element LED4 is not limited to a cross-shaped configuration. For example, they can be arranged in a T-shaped or L-shaped configuration. That is, in each of the first axis direction X and the second axis direction Y, the corresponding two light-emitting elements LED may be arranged symmetrically with respect to the central axis Axc.

FIG. 3(A) is a schematic circuit diagram showing a position detection light-emission unit of the remote control transmitter according to Embodiment 1 of the present invention, and FIG. 3(B) is a waveform chart showing light-emission timing of light signals emitted from light-emitting elements of the same position detection light-emission unit of the remote control transmitter according to Embodiment 1.

The transmitter 2 contains a battery Bat as a power source, and a position detection light-emission portion 2d is connected to the battery Bat. The position detection light-emission unit 2d is provided with the light-emitting elements LED (the start signal light-emitting element LEDs, as well as the first light-emitting element LED1, the second light-emitting element LED2, the third light-emitting element LED3, and the fourth light-emitting element LED4) and a light-emitting element control unit 2dc that controls the driving of the light-emitting elements LED.

The light-emitting element control unit 2dc drives the light-emitting elements LED such that the light-emitting elements LED emit light at appropriate timing, using switching elements Qs, Q1, Q2, Q3 and Q4. The start signal light-emitting element LEDs is driven with a switching element Qs and emits a detection start light signal LSs. The first light-emitting element LED1, the second light-emitting element LED2, the third light-emitting element LED3 and the fourth light-emitting element LED4 are driven with the switching element Q1, the switching element Q2, the switching element Q3 and the switching element Q4, respectively, and emit the first light signal LS1, the second light signal LS2, the third light signal LS3 and the fourth light signal LS4, respectively, as the position detection light signals LSp.

When the light-emission control button 2sw is pressed (turned on), the start signal light-emitting element LEDs is driven, and the detection start light signal LSs is emitted with a light-emission cycle (detection cycle) Tc and a light-emission pulse width Tss. Following the detection start light signal LSs, the first light-emitting element LED1, the second light-emitting element LED2, the third light-emitting element LED3 and the fourth light-emitting element LED4 are successively driven within the light-emission cycle Tc through pulse position modulation by a time division driving system.

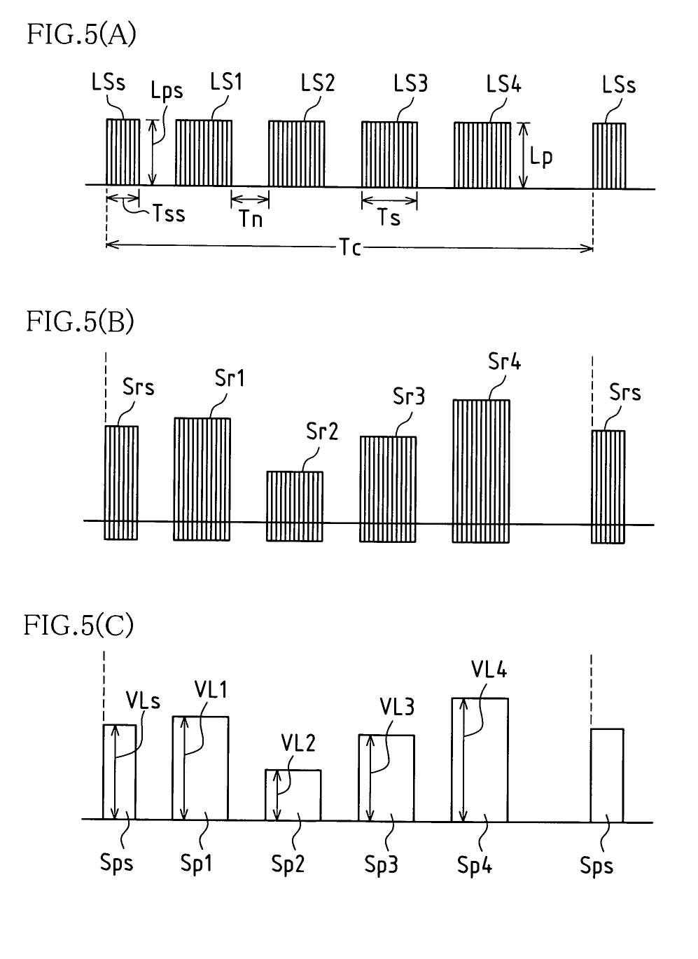

That is, the first light signal LS1, the second light signal LS2, the third light signal LS3 and the fourth light signal LS4 are emitted from the first light-emitting element LED1, the second light-emitting element LED2, the third light-emitting element LED3 and the fourth light-emitting element LED4, respectively, with the light-emission pulse width Ts. Although only one cycle is shown in the chart, highly accurate detection can be carried out by repeating the cycle a suitable number of times. In addition, a suitable signal-less period Tn (see FIG. 5(A)) is provided between the detection start light signal LSs, the first light signal LS1, the second light signal LS2, the third light signal LS3 and the fourth light signal LS4.

It is possible to reliably detect start of the light-emission cycle Tc by making the light-emission pulse width Tss and the light-emission pulse width Ts different from each other, making it possible to perform accurate signal processing in the receiver 3. For the ease of signal processing, it is preferable that the light-emission pulse widths Ts of the first light signal LS1, the second light signal LS2, the third light signal LS3 and the fourth light signal LS4 are the same, but it is not necessary to match them completely.

It is preferable that the light-emission intensities Lp of the first light signal LS1, the second light signal LS2, the third light signal LS3 and the fourth light signal LS4 are the same, but there is no limitation to this. In other words, it is sufficient if their correlation is clear and fixed. However, it is preferable to set the same light-emission intensity Lp for the signals corresponding to the same axis direction (i.e. X or Y), namely, the first light signal LS1 and the second light signal LS2, and the third light signal LS3 and the fourth light signal LS4.

The light-emission intensity Lps of the detection start light signal LSs may be any value that can be detected by the receiver 3, and the circuit configuration of the light-emitting element control unit 2dc can be simplified by making the light-emission intensity Lps and the light-emission intensity Lp the same. The absolute values of the light-emission intensities Lp and Lps may be determined experimentally in consideration with the specifications of the system 1.

Although the start signal light-emitting element LEDs needs to be caused to emit first, the first light-emitting element LED1, the second light-emitting element LED2, the third light-emitting element LED3 and the fourth light-emitting element LED4 may be caused to emit in any order, as long as their corresponding positions at the tip portion 2t are clearly specified.

The detection start light signal LSs and the position detection light signals LSp (the first light signal LS1, the second light signal LS2, the third light signal LS3 and the fourth light signal LS4) are modulated by pulse position modulation, as with commonly used infrared remote control systems. Furthermore, the influence of noise from the ambient environment is suppressed by driving the light-emitting elements LED in a state in which frequency modulation has been performed by superimposing suitable high-frequency modulation waves (carrier waves).

It should be noted that the detection start light signal LSs, and the first light signal LS1, the second light signal LS2, the third light signal LS3 and the fourth light signal LS4 as the position detection light signals LSp, which are emitted from the position detection light-emission unit 2d, may be simply referred to as “light signals LS” when it is not particularly necessary to distinguish between these signals.

FIG. 4 is a circuit block diagram illustrating a schematic circuit configuration and a cursor control unit of the remote control receiver according to Embodiment 1 of the present invention.

The light signals LS (the detection start light signal LSs, and the first light signal LS1, the second light signal LS2, the third light signal LS3 and the fourth light signal LS4 as the position detection light signals LSp) emitted from the position detection light-emission unit 2d are received by a photodiode 3pd included in the light-receiving unit 3p of the receiver 3, photoelectrically converted, and input to a light-reception signal processing unit 30 as light-reception signals Sd.

The light-reception signal processing unit 30 is constituted by a light-receiving unit that is used in a common infrared remote control system. That is, the light-reception signal processing unit 30 includes, in its front stage, an amplifier 31a that amplifies a light-reception signal Sd into a signal in a fixed range (amplitude) so that signal processing can be performed reliably, a limiter 31b that is connected to the amplifier 31a so as to form a feedback loop and adjusts the amplitude of the signal to a fixed range, an amplifier 31c and an amplifier 31d that amplify the output from the amplifier 31a into a signal with an appropriate amplitude so as to facilitate signal processing, a band-pass filter 31e that performs frequency filtering on the signal that has been input from the amplifier 31d and reduce noise by passing only a signal of a predetermined frequency, and a gain adjustment circuit 31f that adjust the gains of the amplifier 31c and the amplifier 31d. It should be noted that, with the band-pass filter 31e, it is possible to significantly reduce noise of frequency components that are distant from the frequency of the modulation wave (modulation frequency).

The band-pass filter 31e outputs, as position detection reception signals Sr, a first reception signal Sr1, a second reception signal Sr2, a third reception signal Sr3 and a fourth reception signal Sr4 corresponding respectively to the first light signal LS1, the second light signal LS2, the third light signal LS3 and the fourth light signal LS4 as the position detection light signal LSp. In other words, the light-reception signal processing unit 30 detects the first reception signal Sr1 to the fourth reception signal Sr4 as the position detection reception signals Sr, and the position detection reception signals Sr are input to a displacement detection unit 42 from the band-pass filter 31e.

The gain adjustment circuit 31f is configured to adjust the gains (amplification factors) of the amplifier 31c and the amplifier 31d based on the feedback control amount, which is caused to correspond to the detected position detection reception signal Sr (output from the band-pass filter 31e). The cycles of the light signals LS (the detection start light signal LSs, and the first light signal LS1, the second light signal LS2, the third light signal LS3 and the fourth light signal LS4 as the position detection light signals LSp) emitted by a time division driving system are set to a high duty ratio at which the gain adjustment circuit 31f functions. Furthermore, the gain adjustment circuit 31f has a high-speed response circuit configuration that can quickly reduce the gain approximately within a light-emission cycle Tc or less.

With the circuit configuration of the gain adjustment circuit 31f, when continuous scattering light noise with a high duty ratio (e.g., scattering light noise from an inverter fluorescent lamp) is input to the photodiode 3pd of the light-receiving unit 3p in a light amount larger than a predetermined value and with a duty ratio higher than a predetermined value, it is possible to reduce the gains of the amplifier 31c and the amplifier 31d (measures against scattering light noise from an inverter fluorescent lamp and the like).

Furthermore, with the circuit configuration of the gain adjustment circuit 31f, when a light signal LS emitted from a transmitter 2 (position detection light-emission unit 2d) that is disposed at the close range is received, it is possible to reduce a saturation phenomenon caused in the light-reception signal processing unit 30 (the amplifiers 31c and 31d) by an excessive light reception amount (measures against the saturation phenomenon of the amplifiers). Since the gain adjustment circuit 31f is configured to provide a high-speed response, it is possible to minimize the amplitude fluctuation period of the position detection reception signal Sr corresponding to a light signal LS received at the initial reception stage (about several light-emission cycles Tc) in the case of reducing the gain.

The displacement detection unit 42 is made up of an output detection unit 421, a noise filter 422, an AD conversion unit 423 and an arithmetic processing unit 424, and configured to be able to perform appropriate signal processing.

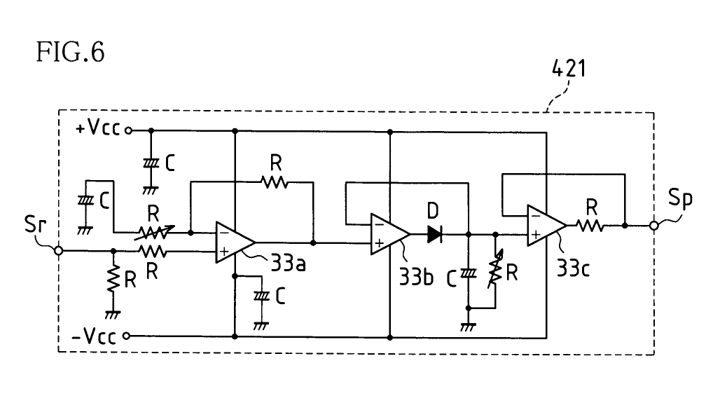

The output detection unit 421 performs wave form transformation processing (see FIG. 5(B)), which will be described later, on the position detection reception signals Sr to obtain, as position detection output signals Sp, a first output signal Sp1, a second output signal Sp2, a third output signal Sp3 and a fourth output signal Sp4 corresponding respectively to the first reception signal Sr1, the second reception signal Sr2, the third reception signal Sr3 and the fourth reception signal Sr4. The output detection unit 421 is configured as an envelope waveform transformation circuit (see FIG. 6) that removes the modulation waves from the position detection reception signals Sr containing modulation waves to obtain an envelope. That is, the position detection output signals Sp can be converted into amplitude values (the respective amplitude values of the first output signal Sp1, the second output signal Sp2, the third output signal Sp3 and the fourth output signal Sp4).

The noise filter 422 is constituted by a CR filter, a LC filter or the like, and removes noise that cannot be removed by the band-pass filter 31e from the position detection output signals Sp. With the noise filter 422, it is possible to further improve the accuracy of the envelope (the amplitude values of the position detection output signals Sp).

The AD conversion unit 423 converts the amplitude values of the position detection output signal Sp, which are obtained as analog values, into digital values, and makes it possible to readily perform computation (digital computation) at the arithmetic processing unit 424.

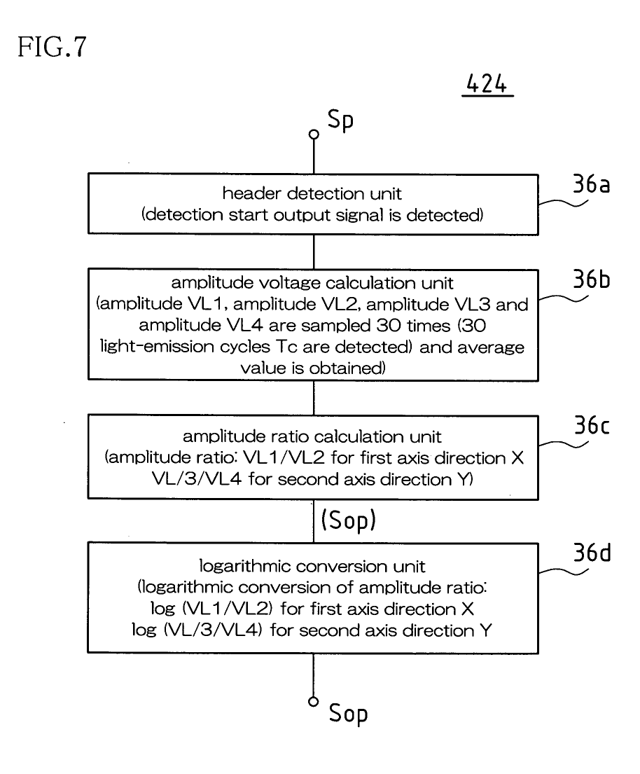

The arithmetic processing unit 424 detects the state of movement (displacement) of the transmitter 2 by performing digital computation on the digitally converted position detection output signals Sp, and outputs a control signal to a cursor control unit 405 that controls the position of the cursor 45p (computation output Sop (see FIG. 7)). The cursor control unit 405 controls the position of the cursor 45p displayed on the display screen 45d based on the computation output Sop from the arithmetic processing unit 424.

The arithmetic processing unit 424 and the cursor control unit 405 may be configured by using a central processing unit (CPU: microcomputer) contained in the receiver 3 or the display device 45 for both of them. By using a CPU, it is possible to control the position of the cursor 45p based on a computer program.

In addition, detector circuits (a first detector circuit 31g and a second detector circuit 31h), an OR circuit 31i, an integration circuit (double integration circuit 31j) and a comparator (hysteresis comparator 31k), which are arranged in a rear stage of the light-reception signal processing unit 30 perform modulation processing of signals that are transmitted via commands by an ordinary infrared remote control system. One of the two input terminals of the hysteresis comparator 31k is configured as a threshold level setting terminal 31m that can appropriately adjust the comparator characteristics. Since a command reception signal corresponding to a command transmission signal that is transmitted by an ordinary infrared remote control system is output from an output terminal 31n of the hysteresis comparator 31k, it is possible to perform the command operation for an ordinary infrared remote control system.

Further, it is also possible to provide a light-reception signal processing unit 30 that is dedicated to the remote control system 1 by configuring a light-reception signal processing unit 30 only by the front stage of the light-reception signal processing unit 30, without including the rear stage (the detector circuits, the integration circuit, the comparator, etc.) of the light-reception signal processing unit 30

FIG. 5(A) is a waveform chart of light signals that are emitted from the position detection light-emission unit shown in FIG. 3(B), FIG. 5(B) is a waveform chart of position detection reception signals that are received and detected by the remote control receiver shown in FIG. 4, and FIG. 5(C) is a waveform chart of the same position detection output signals.

As described above, the light signals LS are constituted by the detection start light signal LSs, and the first light signal LS1, the second light signal LS2, the third light signal LS3 and the fourth light signal LS4 as the position detection light signals LSp. For simplicity, the light-emission intensity Lps of the detection start light signal LSs and the light-emission intensity Lp of the first light signal LS1, the second light signal LS2, the third light signal LS3 and the fourth light signal LS4 are set equal in this embodiment. Additionally, a signal-less period Tn is appropriately set between the detection start light signal LSs, the first light signal LS1, the second light signal LS2, the third light signal LS3 and the fourth light signal LS4. The rest of the characteristics are the same as those described with reference to FIG. 3(B), and therefore their detailed description is omitted.

Since the inclination of the first light signal LS1, the second light signal LS2, the third light signal LS3 and the fourth light signal LS4 to the central axis Axc are different from one another, the magnitude of the light-reception signal Sd detected in the photodiode 4pd varies depending on the displacement (inclination) of the central axis Axc with respect to the light-receiving unit 3p. Accordingly, the position detection reception signals Sr (the first reception signal Sr1, the second reception signal Sr2, the third reception signal Sr3 and the fourth reception signal Sr4 corresponding respectively to the first light signal LS1, the second light signal LS2, the third light signal LS3 and the fourth light signal LS4), which are detected as the output of the light-reception signal processing unit 30 (band-pass filter 31e) by performing signal processing on the light-reception signals Sd, have amplitudes (voltage values) corresponding to their respective inclinations to the central axis Axc.

Furthermore, a detection start reception signal Srs corresponding to the detection start light signal LSs is similarly output from the band-pass filter 31e. It should be noted that the position detection reception signal Sr and the detection start reception signal Srs are obtained as waveforms containing modulation waves.

The position detection reception signal Sr and the detection start reception signal Srs are converted into envelope waveforms by the output detection unit 421 serving as an envelope waveform transformation circuit, and respectively obtained as the corresponding position detection output signals Sp (the first output signal Sp1, the second output signal Sp2, the third output signal Sp3 and the fourth output signal Sp4) and detection start output signal Sps. For example, a first output signal Sp1, a second output signal Sp2, a third output signal Sp3 and a fourth output signal Sp4 are shown with an amplitude VL1, an amplitude VL2, an amplitude VL3 and an amplitude VL4, respectively. It should be noted that the amplitude VL1, the amplitude VL2, the amplitude VL3 and the amplitude VL4 may be simply referred to as “amplitude VL” where it is not necessary to distinguish between them.

That is, the first light signal LS1, the second light signal LS2, the third light signal LS3 and the fourth light signal LS4 are converted by the output detection unit 421 into the amplitudes VL1, VL2, VL3 and VL4, which correspond to their inclinations to the central axis Axc. Accordingly, it is possible to detect the movement direction (displacement) of the transmitter 2 by comparing the amplitudes corresponding to the same axis direction (see FIG. 7).

It should be noted that the amplitude VLs of the detection start output signal Sps may be at a level at which the detection start output signal Sps (light-emission cycle Tc) can be detected by a header detection unit 424a (see FIG. 7).

FIG. 6 is a circuit diagram showing a working example of the output detection unit shown in FIG. 4.

As described above, the output detection unit 421 functions as an envelope waveform transformation circuit, and it forms the envelope waveforms of the position detection reception signals Sr, and outputs them as the position detection output signals Sp. It should be noted that the working example shown in FIG. 6 is merely an example, and there is no limitation to this.

A basic circuit is configured by connecting operational amplifiers 33a, 33b and 33c in a three-stage cascade arrangement, and connecting power terminals to +Vcc and −Vcc. This circuit can be readily configured by appropriately connecting C (electrolytic capacitors), R (resistors, variable resistors) and a diode D that have a suitable circuit constant as a bias circuit. With the circuit configuration shown in FIG. 6, it is possible to detect modulation waves and obtain envelope waveforms.

FIG. 7 is a block diagram schematically showing a configuration of the arithmetic processing unit shown in FIG. 4.

The arithmetic processing unit 424 is made up of the header detection unit 424a, an amplitude voltage calculation unit 36b, an amplitude ratio calculation unit 36c and a logarithmic conversion unit 36d that are cascade-connected. The position detection output signals Sp are input to the header detection unit 424a, and the computation output Sop is calculated (output) from the logarithmic conversion unit 36d as a displacement (value representing displacement) of the transmitter 2. The computation output Sop is input to the cursor control unit 405 (see FIG. 4), and converted by the cursor control unit 405 into position information (position coordinates: an X coordinate corresponding to the first axis direction X; and a Y coordinate corresponding to the second axis direction Y) of the cursor 45p. In other words, the cursor control unit 405 controls the position of the cursor 45p based on the displacement of the transmitter 2.

The header detection unit 424a detects the detection start output signal Sps based on the light-emission pulse width Tss, and detects (specifies) the first output signal Sp1, the second output signal Sp2, the third output signal Sp3 and the fourth output signal Sp4 as the position detection output signals Sp by appropriately counting the light-emission pulse width Ts and the signal-less period Tn corresponding to the light-emission cycle (detection cycle) Tc.

The amplitude voltage calculation unit 36b samples the light-emission cycle Tc, for example, 30 times (detects 30 light-emission cycles Tc), determines the average value of the 30 cycles for each of the amplitudes VL1, VL2, VL3 and VL4, and calculates (specifies) amplitudes VL1, VL2, VL3 and VL4 for control (for amplitude correlation comparison).

The amplitude ratio calculation unit 36c calculates the ratio of the amplitude VL1 to the amplitude VL2 (amplitude ratio as amplitude correlation, or output ratio), i.e., amplitude VL1/amplitude VL2 for the first axis direction X, and calculates the ratio of the amplitude VL3 to the amplitude VL4, i.e., amplitude VL3/amplitude VL4 for the second axis direction Y.

The logarithmic conversion unit 36d calculates the logarithms of the amplitude ratios (VL1/VL2 and VL3/VL4) determined by the amplitude ratio calculation unit 36c (logarithms of the amplitude ratios as an amplitude correlation, or logarithms of the output ratios). That is, log (VL1/VL2) and log (VL3/VL4) are calculated, and a computation output Sop is obtained by performing appropriate coefficient processing on these logarithms.

While various computations in the amplitude voltage calculation unit 36b, the amplitude ratio calculation unit 36c and the logarithmic conversion unit 36d can be performed by a hardware configuration, they can also be performed using the central processing unit (CPU) contained in the receiver 3 or the display device 45 in combination, as described above. By using a CPU, it is possible to control the position of the cursor 45p based on a computer program (software configuration).

It should be noted that although the computation output Sop of the logarithmic conversion unit 36d was output in FIG. 7, it is also possible to use a computation result from the amplitude ratio calculation unit 36c as the computation output Sop.

### Embodiment 2

The detection of displacement and the state of display to the display screen in the remote control system 1 shown in Embodiment 1 are specifically described as Embodiment 2. To facilitate understanding, this embodiment is described for the case where the transmitter 2 is moved (displaced, swung) only in a horizontal direction (the first axis direction X). Therefore, no description is given for movement in a vertical direction (the second axis direction Y), but it is possible to similarly apply this embodiment. Detection of movement (detection of displacement, detection of swinging) in two-dimensional directions can be carried out by performing suitable combining processing based on the values (the amplitude ratios as an amplitude correlation, the logarithms of the amplitude ratios as an amplitude correlation) obtained for movement in both the horizontal direction and the vertical direction, and therefore its description is omitted.

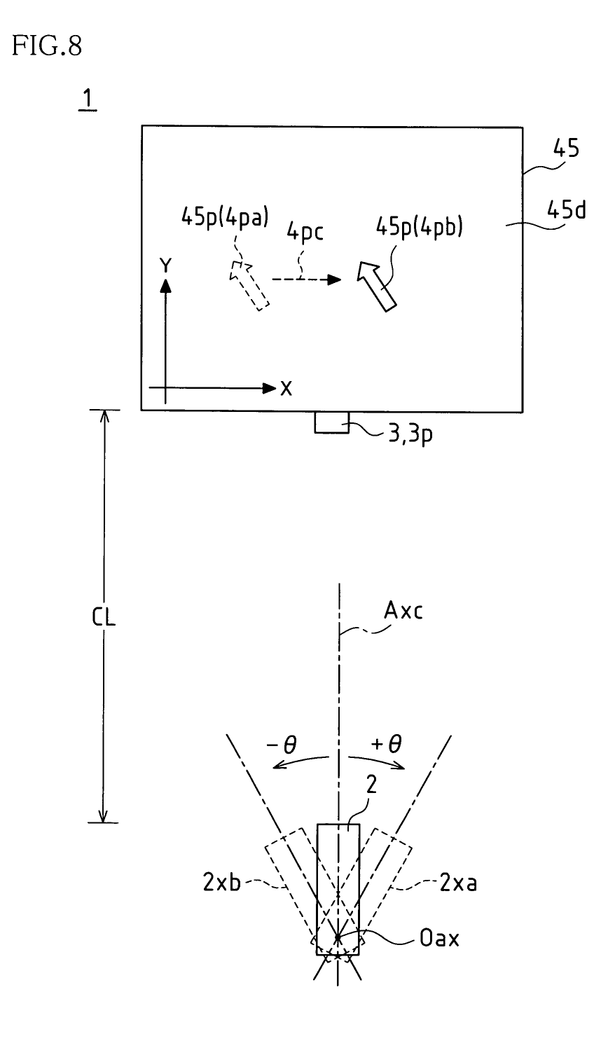

FIG. 8 is a diagram showing a layout of a relevant part of a remote control system according to Embodiment 2 of the present invention.

A system 1 is the same as that shown in Embodiment 1, and is provided with a transmitter 2 and a receiver 3 (light-receiving unit 3p). The system 1 is shown in a front view in a state in which a cursor 45p is displayed on a display screen 45d of a display device 45. The display screen 45d laterally defines an X-axis corresponding to the first axis direction X (horizontal direction) of the transmitter 2, and longitudinally defines a Y-axis corresponding to the second axis direction Y (vertical direction) of the transmitter 2.

The transmitter 2 is shown in a plan view as viewed from vertically above during use as in the case of FIG. 1. The transmitter 2 is disposed at a position at a communication distance CL from the display device 45 (receiver 3, light-receiving unit 3p). Here, the communication distance CL is taken to be about 2 m. The transmitter 2 is in a state of swinging to the left and right around the origin Oax, and its state of inclination from the central axis Axc, which is directly facing the light-receiving unit 3p, is defined as the swing angle θ. Correspondingly, taking a state of the transmitter 2 swinging rightward (transmitter 2xa) as +θ and a state of the transmitter 2 swinging leftward (transmitter 2xb) as −θ, the receiver 3 determines an amplitude VL corresponding to a swing angle θ, and performs arithmetic processing in the arithmetic processing unit 424.

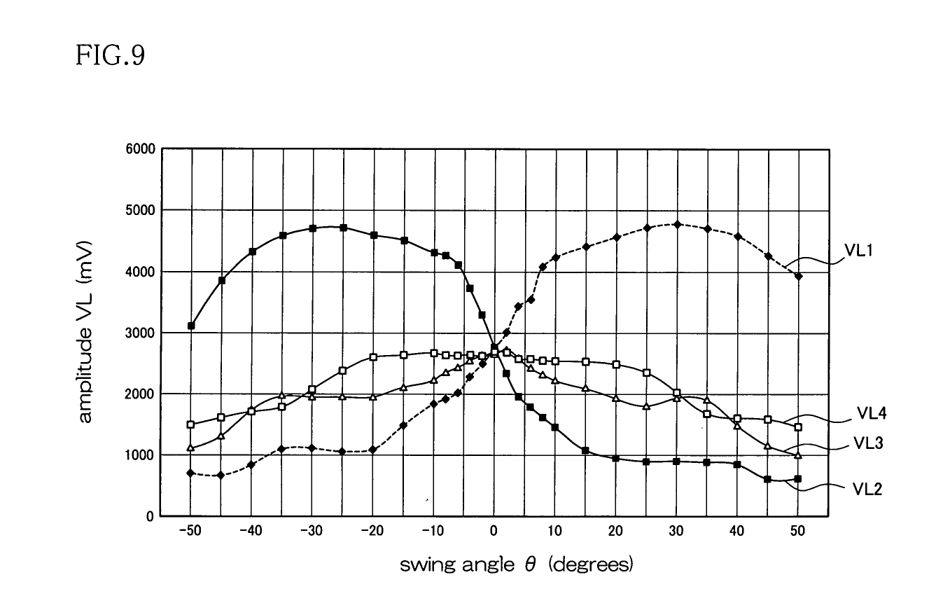

FIG. 9 is a graph of measured values showing a relationship between the swing angle and the amplitude of the position detection output signals in the remote control system according to Embodiment 2 of the present invention.

The lateral axis denotes the swing angles θ (degrees) and the longitudinal axis denotes the amplitudes VL (mV) of the position detection output signals Sp. The measured values of the amplitude VL1 of the first output signal Sp1, the amplitude VL2 of the second output signal Sp2, the amplitude VL3 of the third output signal Sp3 and the amplitude VL4 of the fourth output signal Sp4 are shown corresponding to the swing angles θ. It should be noted that the graph shows the average values of the measured values (the above-described 30 times of sampling).

The amplitude VL1 corresponding to the first light-emitting element LED1 disposed on the left side in the plan view (see FIG. 2(A)) exhibits a characteristic of gradually increasing from the left (−θ) to the right (+θ), following the change in the swing angle θ, and shows a maximum value at about 25 degrees to 35 degrees. That is, this indicates that the first light-emitting element LED1 is directly facing the light-receiving unit 3p at this angle.

Similarly, the amplitude VL2 corresponding to the second light-emitting element LED2 disposed on the right side exhibits a characteristic of gradually increasing from the left (−θ) to the right (+θ), following the change in the swing angle θ, and shows a maximum value at about −25 to −35 degrees. That is, this indicates that the second light-emitting element LED2 is directly facing the light-receiving unit 3p at this angle.

Further, since the amplitude VL1 and the amplitude VL2 are arranged symmetrically with respect to the light-receiving unit 3p when the swing angle θ is 0 degree, the amplitudes VL1 and VL2 basically coincide with each other. That is, the amplitudes VL1 and VL2 exhibit a characteristic of being symmetrical about the swing angle θ=0 degrees.

Unlike the first light-emitting element LED1 and the second light-emitting element LED2 disposed in the first axis direction X, the amplitudes corresponding to the third light-emitting element LED3 and the fourth light-emitting element LED4 disposed in the second axis direction Y show the maximum value when the swing angle θ is 0 degrees, and their change due to the swing angle θ is less than that of the amplitudes corresponding to the first light-emitting element LED1 and the second light-emitting element LED2. Since the third light-emitting element LED3 and the fourth light-emitting element LED4 have the same positional relationship with respect to the swing angle θ (vertically symmetrical), they show amplitudes VL3 and VL4 that are similar to each other. That is, the ratio of the amplitude VL3 to the amplitude VL4 (amplitude VL3/amplitude VL4) is approximately 1, and does not change.

It should be noted that this embodiment shows that when the swing angle θ exceeds the range of 25 degrees to 35 degrees in absolute value, the measured values as a whole decrease and the reliability of the swing angle θ as a signal is lost. Therefore, it is preferable that a fixed range is set as the effective swing angle. In this embodiment and the following embodiments, ±25 degrees is set as the effective swing angle. That is, the cursor 45p is controlled assuming that the displacement detection of the transmitter 2 is effective only for the amplitude ratio (and the logarithm of the amplitude ratio) value when the swing angle θ can be judged as being within the range of the effective swing angle.

Within the range of the effective swing angle (±25 degrees), the ratio of the amplitude VL1 to the amplitude VL2 (amplitude VL1/amplitude VL2) greatly changes in response to the change in the swing angle θ. Further, within the range of the effective swing angle (−25 degrees to +25 degrees), the amplitude ratio (VL1/VL2) simply increases.

Accordingly, the swing angle θ corresponding to the detected amplitude ratio (VL1/VL2) is specified (the displacement of the transmitter 2 is detected) by measuring a relationship between the swing angle θ and the amplitude ratio (VL1/VL2) in advance, and storing the relationship in a storage means (not shown) of the receiver 3. That is, it is possible to control the position of the cursor 45p based on the detected displacement (swing angle θ). In this case, the amplitude ratio (VL1/VL2) corresponds to the computation output Sop (output from the amplitude ratio calculation unit 36c).

For example, based on the measured amplitude value obtained when the swing angle θ is 20 degrees, amplitude ratio VL1/VL2=4563 mV/956 mV=4.77 is given. Accordingly, it is possible to detect that the swing angle θ is 20 degrees when the amplitude ratio is calculated as 4.77, so that the cursor 45p can be moved to the place corresponding to 20 degrees.

In addition, intermediate values can be determined as necessary, by carrying out more detailed measurement or performing arithmetic processing for the intermediate values of the measured values by interpolation (linear approximation).

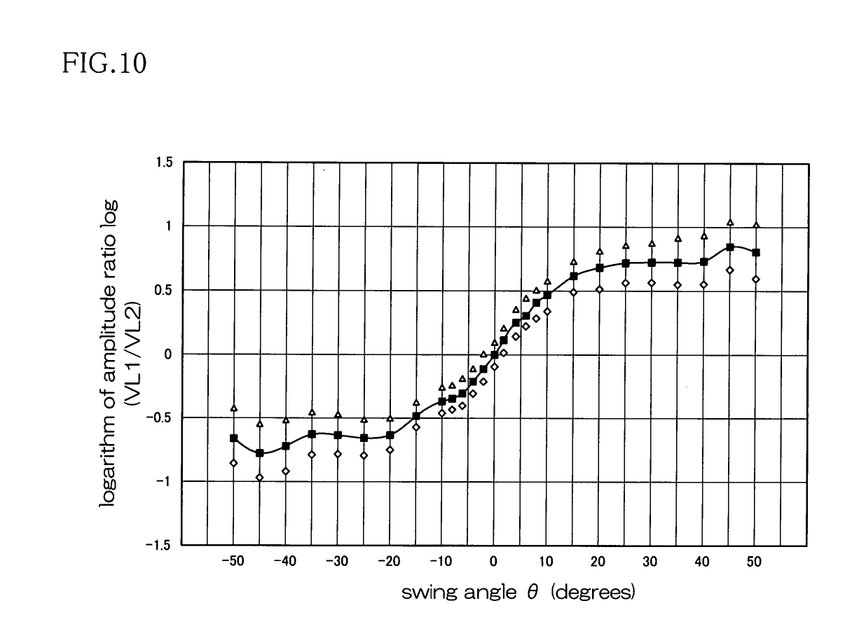

FIG. 10 is a graph showing the amplitude ratios of the position detection output signals in the first axis direction as logarithms for the measured values shown in FIG. 9.

The lateral axis denotes the swing angle θ (degrees), and the longitudinal axis denotes the logarithm log (VL1/VL2) of the amplitude ratio. Since the subject is the amplitude ratio in the first axis direction X, the logarithm of the amplitude ratio is log (VL1/VL2), and log (average value of VL1/average value of VL2) at various swing angles θ are shown as a curve. It should be noted that VL1max/VL2min (maximum value of VL1/minimum value of VL2) are shown as a data range (triangle marks) above the curve, and VL1min/VL2max (minimum value of VL1/maximum value of VL2) are shown as a data range (diamond marks) below the curve.

As described above, within the range of the effective swing angle (±25 degrees), the amplitude ratio (VL1/VL2) shows a characteristic of greatly changing in response to the change in the swing angle θ and simply increasing. Further, it can be seen that the logarithm (log (VL1/VL2)) of the amplitude ratio (VL1/VL2) exhibits characteristics that can be approximated by a straight line within the range of the effective swing angle. It should be noted that control using linear approximation will be described separately in Embodiment 3 and Embodiment 4.

Accordingly, the swing angle θ corresponding to the logarithm (log (VL1/VL2)) of the detected amplitude ratio is specified (the displacement of the transmitter 2 is detected) by measuring a relationship between the swing angle θ and the logarithm (log (VL1/VL2)) of the amplitude ratio (VL1/VL2) in advance, and storing the relationship in a storage means of the receiver 3. That is, it is possible to control the position of the cursor 45p based on the detected displacement (swing angle θ). In this case, the logarithm log (VL1/VL2) of the amplitude ratio (VL1/VL2) corresponds to the computation output Sop (output from the logarithmic conversion unit 36d).

For example, the measured amplitude value obtained when the swing angle θ is 20 degrees is given as amplitude ratio VL1/VL2=4.77, as described above, and the logarithm of the amplitude ratio is given as log 4.77=0.679. Accordingly, it is possible to detect that the swing angle θ is 20 degrees when the logarithm of the amplitude ratio is calculated as 0.679, so that the cursor 45p can be moved to the place corresponding to 20 degrees.

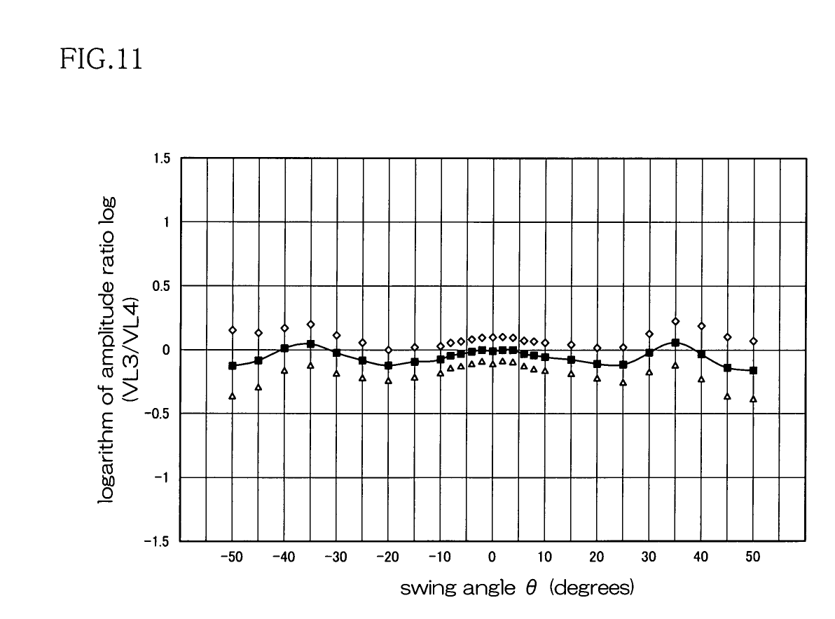

FIG. 11 is a graph showing the amplitude ratios of the position detection output signals in the second axis direction as logarithms for the measured values shown in FIG. 9.

The lateral axis denotes the swing angle θ (degrees), and the longitudinal axis denotes the logarithm log (VL3/VL4) of the amplitude ratio. Sine the subject is the amplitude ratio in the second axis direction Y, the logarithm of the amplitude ratio is log (VL3/VL4), and log (average value of VL3/average value of VL4) at various swing angles θ are shown as a curve. It should be noted that VL3max/VL4min (maximum value of VL3/minimum value of VL4) are shown as a data range (diamond marks) above the curve, and VL3min/VL4max (minimum value of VL3/maximum value of VL4) are shown as a data range (triangle marks) below the curve.

As described above, the ratio of the amplitude VL3 to the amplitude VL4 (amplitude VL3/amplitude VL4) is approximately 1, and does not change, so that it can be seen that the logarithm of the amplitude ratio log (VL3/VL4) is approximately 0, and has no influence on the detection in the first axis direction X.

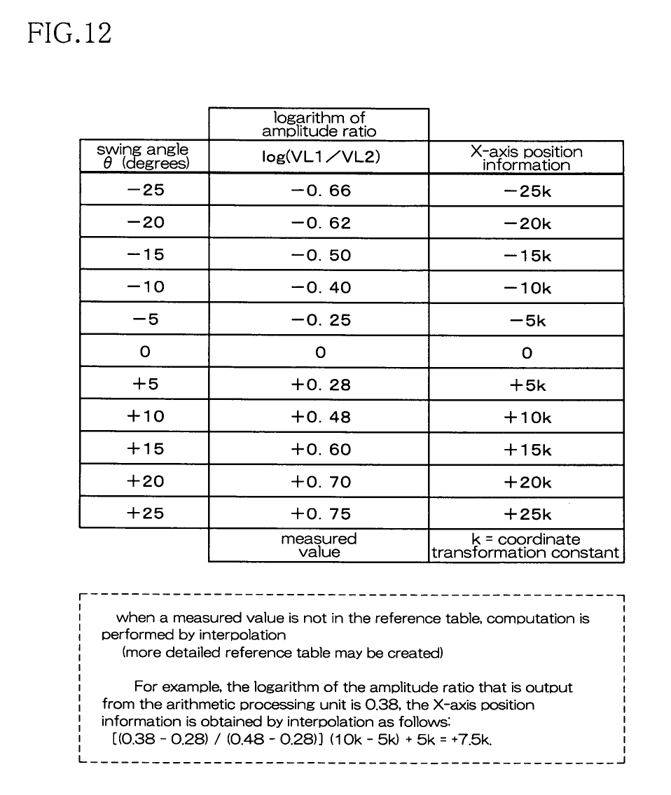

FIG. 12 is a chart for illustrating a form of coordinate transformation for causing the logarithm of the amplitude ratio of the position detection output signals to correspond to the position information of the cursor in the remote control system according to Embodiment 2 of the present invention.

In FIG. 12, the columns of the swing angle θ (degrees) and the logarithm of the amplitude ratio log (VL1/VL2) show numerical values corresponding to the graph of FIG. 10, which were determined experimentally. For example, log (VL1/VL2) is −0.66 when the swing angle θ is −25 degrees, log (VL1/VL2) is 0 when the swing angle θ is 0 degree, and log (VL1/VL2) is +0.75 when the swing angle θ is +25 degrees. The rest of the corresponding numerical values are as shown in the chart.

The three values (the swing angle θ, the logarithm of the amplitude ratio (logarithm value), and X-axis position information) are correlated with each other in advance by setting the position information in the first axis direction X (X-axis position information: specifying the position of the cursor 45p on the display screen 45d and correlating it to the position coordinates of the cursor 45p) in correspondence with the logarithm of the amplitude ratio corresponding to the swing angle θ. It should be noted that although only the X-axis position information is described here, it is also possible to set Y-axis position information for the second axis direction Y in the same manner.

The X-axis position information can be obtained by performing appropriate coefficient processing on the swing angle θ such that the logarithm of the amplitude ratio is correlated to the position of the cursor 45p (coordinates of the cursor 45p) on the display screen 45d. Namely, the X-axis position information can be determined (subjected to a coordinate transformation) by setting an appropriate coordinate transformation constant k and multiplying the swing angle θ by this.

The correspondence among the swing angle θ, the logarithm of the amplitude ratio and the X-axis position information may be stored in a storage means as a reference table, for example, and the X-axis position information corresponding to the logarithm of the amplitude ratio that is detected as the computation output Sop may be obtained. Then, the position of the cursor 45p can be controlled corresponding to the determined X-axis position information by the cursor control unit 405.

Preferably, the values in the reference table are set to appropriate numerical values that can minimize errors in practical use, by obtaining multiple data by setting various conditions and performing statistical processing.

It is also possible to adopt a configuration in which the computation for obtaining the X-axis position information corresponding to the detected the logarithm of the amplitude ratio (comparison with the reference table) is performed by the arithmetic processing unit 424. Alternatively, it is possible to adopt a configuration in which this is performed by the cursor control unit 405. Further, the storage means storing the reference table may be provided in a suitable place in the receiver 3, such as the arithmetic processing unit 424 or the cursor control unit 405.

When a logarithm of an amplitude ratio that is not in the reference table is output as the computation output Sop during comparison with the reference table, it is possible to obtain the corresponding X-axis position information by interpolation. For example, when the logarithm of the amplitude ratio that is output from the arithmetic processing unit 424 is 0.38, the X-axis position information can be obtained by interpolation as follows: [(0.38−0.28)/(0.48−0.28)](10 k−5 k)+5 k=+7.5 k. Interpolation can also be applied to the following embodiments in the same manner. It should be noted that it is also possible to create a more detailed reference table such that interpolation is not necessary.

Since the X-axis position information can be readily referenced for the computation output Sop (logarithm of the amplitude ratio) by letting the three values of the swing angle θ, the logarithm of the amplitude ratio and the X-axis position information correspond to each other, it is possible to control the cursor position simply and highly accurately. In addition, by using the logarithm of the amplitude ratio for the amplitude correlation, it is possible to set the correlation between the swing angle θ and the logarithm of the amplitude ratio such that it has a simply increasing characteristic in which the absolute values are symmetrical in the positive and negative directions, so that the X-axis position information can be referenced for the logarithm of the amplitude ratio simply and reliably, making it possible to readily control the cursor position.

Although the swing angle θ and the X-axis position information are correlated with the logarithm of the amplitude ratio in FIG. 12, it is also possible to correlate the swing angle θ and the X-axis position information with the amplitude ratio. In this case, the X-axis position information can be easily referenced for the computation output Sop (amplitude ratio) by letting the three values of the swing angle θ, the amplitude ratio and the X-axis position information correspond to each other, so that it is possible to control the cursor position easily and highly accurately.

In addition, since the configuration of the arithmetic processing unit 424 can be simplified by using the amplitude ratio as the amplitude correlation, the correlation between the swing angle θ and the amplitude ratio can be determined easily. Accordingly, the X-axis position information can be readily referenced for the amplitude ratio, thus making it possible to control the cursor position easily.

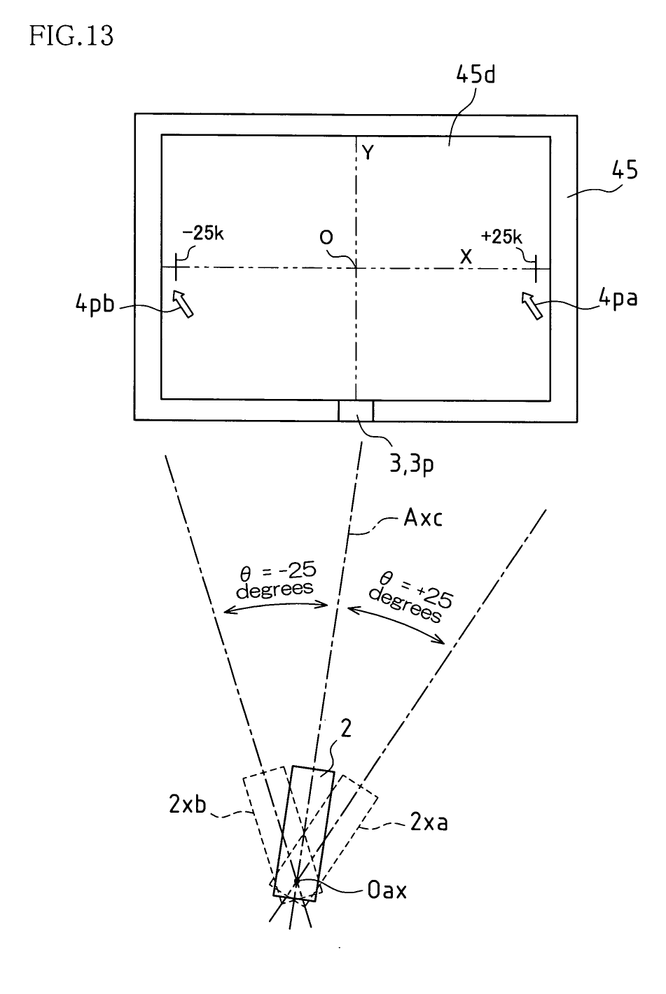

FIG. 13 is an explanatory diagram illustrating a relationship between the X-axis position information and the cursor position determined with reference to FIG. 12.

When the transmitter 2 is swung leftward and thus brought into the state indicated by the transmitter 2xb, the swing angle θ corresponds to −25 degrees (left-side effective swing angle), and the X-axis position information is −25 k, as shown in FIG. 12. Accordingly, the −25 k as the X-axis position information is assigned as corresponding to the left end position on the display screen 45d, and the cursor 4pb is displayed at the left end.

When the transmitter 2 is swung rightward and thus brought into the state indicated by the transmitter 2xa, the swing angle θ corresponds to +25 degrees (right-side effective swing angle), and the X-axis position information is +25 k, as shown in FIG. 12. Accordingly, +25 k as the X-axis position information is assigned as corresponding to the right end position on the display screen 45d, and the cursor 4pa is displayed at the right end.

When the transmitter 2 directly faces to the receiver 3 (light-receiving unit 3p) and thus is brought into the state indicated by the transmitter 2, the swing angle θ corresponds to 0 degree, and the X-axis position information is 0, as shown in FIG. 12. Accordingly, the X-axis position information 0 is correlated with the center (on the Y-axis including the origin O) position on the display screen 45d.

This establishment of correspondence between the X-axis position information and the position of the cursor 45p on the display screen 45d can be readily carried out by reflecting the characteristics of the cursor control unit 405 in the coordinate transformation constant k. Further, in this embodiment, the absolute value of the swing angle θ and the position information of the cursor 45p on the display screen 45d (the absolute value of the position coordinates) are correlated with each other such that they are symmetrical between −25 k and +25 k, so that they are made to correspond to each other symmetrically. It should be noted that the Y-axis corresponding to the second axis direction Y can also be controlled in the same manner, and therefore the description is omitted.

### Embodiment 3

In this embodiment, the logarithm of the amplitude ratio shown in Embodiment 2 is linearly approximated to detect a displacement of the transmitter 2. That is, a linear approximation of the logarithm of the amplitude ratio is used as the amplitude correlation.

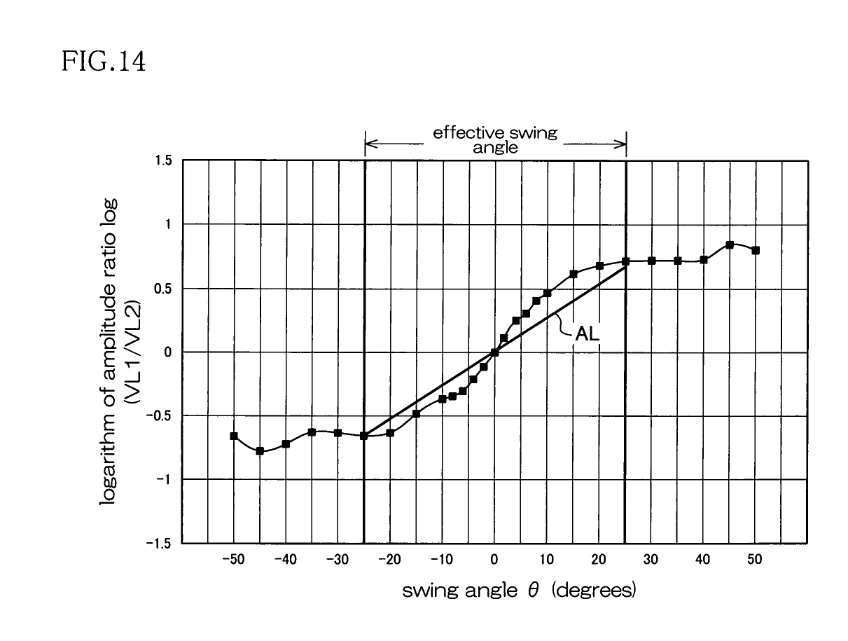

FIG. 14 is a graph showing a relationship between the swing angle and the logarithm of the amplitude ratio of the position detection output signals when linear approximation is applied to the logarithm of the amplitude ratio of the position detection output signals in a remote control system according to Embodiment 3 of the present invention.

The data in this embodiment is the same as that used in Embodiment 2, and the lateral axis denotes the swing angle θ (degrees), and the longitudinal axis denotes the logarithm of the amplitude ratio log (VL1/VL2), as in FIG. 10. In a system 1 (receiver 3) according to this embodiment, the logarithm of the amplitude ratio is regarded as an approximating straight line AL within the range of the effective swing angle ±25 degrees.

While there are various possible methods for setting the approximating straight line AL, the approximating straight line AL was set in this embodiment under the following basic conditions. On the approximating straight line AL, the logarithm of the amplitude ratio is set to log (VL1/VL2)=0 so as to match with the measured value when the swing angle θ=0 (degree), the logarithm of the amplitude ratio is set smaller than the measured value (log (VL1/VL2)=0.75) when the swing angle θ is +25 degrees, which is the maximum value of the effective swing angle, the logarithm of the amplitude ratio is set larger than the measured value (log (VL1/VL2)=−0.66) when the swing angle θ is −25 degrees, which is the minimum value of the effective swing angle, and the logarithm of the amplitude ratio is symmetrical in ± directions (the maximum value and the minimum value have the same absolute value).

That is, the approximating straight line AL is defined as a straight line that passes through log (VL1/VL2)=−0.65 when the swing angle θ is −25 degrees, log (VL1/VL2)=0 when the swing angle θ is 0 degree, and log (VL1/VL2)=0.65 when the swing angle θ is +25 degrees. Accordingly, when the logarithm of the amplitude ratio is −0.65, −0.26, 0.39 and 0.65, the swing angle θ is detected as −25 degrees, −10 degrees, +15 degrees and +25 degrees, respectively.

For example, on the approximating straight line AL, the swing angle θ corresponding to log (VL1/VL2)=0.5 is 18 degrees. Accordingly, when the detected the logarithm of the amplitude ratio is calculated as 0.5, the swing angle θ is detected to be 18 degrees. By using linear approximation, it is possible to simplify and thus readily determine the relationship between the swing angle θ and the logarithm of the amplitude ratio (VL1/VL2) that is measured and stored in advance.

However, since linear approximation is used, on the approximating straight line AL in this embodiment, the detected swing angle θ indicates a larger value (absolute value) than the actual swing angle θ. For example, the actual swing angle θ corresponding to the above-described logarithm of the amplitude ratio log (VL1/VL2)=0.5 for which the swing angle θ was detected to be 18 degrees is 11 degrees. That is, an angle that is larger than the actual swing angle θ is detected as a swing angle θ. Accordingly, the approximating straight line AL can also be used for coarse adjustment, in which low accuracy is sufficient. Additionally, it is possible to store the correspondence among the swing angle θ, the linearly approximated logarithm and the X-axis position information in the case of using linear approximation in the storage means as a reference table, as with Embodiment 2.

As with Embodiment 2 (FIG. 12), it is possible to simply multiply the swing angle (linearly approximated swing angle θa) corresponding to the linearly approximated logarithm obtained in FIG. 14 by the coordinate transformation constant k to obtain the X-axis position information, and create a reference table in which the swing angle θ, the logarithm of the amplitude ratio and the X-axis position information are made to correspond to each other. For example, when the logarithm of the amplitude ratio as the computation output Sop is 0.52, the corresponding linearly approximated logarithm 0.52 corresponds to the linearly approximated swing angle θa=+20 degrees, so that it is possible to set the X-axis position information to +20 k. In this case, there may be some error, as described above.

FIG. 15 is a chart illustrating a form of coordinate transformation for letting a linearly approximated logarithm correspond to the position information of the cursor when the logarithm of the amplitude ratio of the position detection output signals is linearly approximated in the remote control system according to Embodiment 3.

In FIG. 15, the columns of the swing angle θ (degrees) and the logarithm of the amplitude ratio log (VL1/VL2) show numerical values corresponding to the graph of FIG. 10, which were determined experimentally. Accordingly, as with FIG. 12, log (VL1/VL2) is −0.66 when the swing angle θ is −25 degrees, and log (VL1/VL2) is 0 when the swing angle θ is 0 degree, and log (VL1/VL2) is +0.75 when the swing angle θ is +25 degrees. The rest of the corresponding numerical values are as shown in the chart.

The column of the linearly approximated logarithm shows numerical values of the approximating straight line AL (values of the linearly approximated logarithm) that are shown as a straight line in FIG. 14. As described with reference to FIG. 14, the linearly approximated logarithm is −0.65 when the swing angle θ is −25 degrees, the linearly approximated logarithm is 0 when the swing angle θ is 0 degree, and the linearly approximated logarithm is +0.65 when the swing angle θ is +25 degrees. The rest of the corresponding numerical values are as shown in the chart.

Since the value of the logarithm of the amplitude ratio on the approximating straight line AL when the effective swing angle is +25 degrees is +0.65, the linearly approximated swing angle θa is calculated by determining the logarithm per degree of the swing angle θ (0.65/25) from 0.65/25 and dividing the logarithm of the amplitude ratio (log (VL1/VL2)) as the actually measured value by the logarithm per degree (0.65/25). Then, the X-axis position information is set (specified) corresponding to the linearly approximated swing angle θa (transformation formula).

For example, in the case where swing angle θ=+15 degrees, and log (VL1/VL2)=+0.60, the linearly approximated swing angle θa is given as follows: +0.60/(0.65/25)=+23.08. +23.08 k, which is obtained by multiplying +23.08 by the coordinate transformation constant k, is used as the position information (X-axis position information) in the first axis direction X.

The X-axis position information as a result of linear approximation is, for example, −25.38 k for swing angle θ=−25 degrees, −19.23 k for swing angle θ=−15 degrees, 0 for swing angle θ=0 degrees, 23.08 k for swing angle θ=+15 degrees, and +28.85 k for swing angle θ=+25 degrees. That is, in the case of linear approximation, the actual measured value of the logarithm of the amplitude ratio and the linearly approximated logarithm of the approximating straight line AL are different as described above, so that the swing angle θ and the X-axis position information (position coordinates) of the cursor 45p are not symmetrical.

For example, −25.38 k as the X-axis position information corresponding to the swing angle θ=−25 degrees is located about −25 (arbitrary length unit) left from the screen center on the display screen 45d, and +28.85 k as the X-axis position information corresponding to the swing angle θ=+25 degrees is located about 29 (arbitrary length unit) right from the screen center on the display screen 45d. That is, even if the swing angle θ is laterally symmetrical, the positions of the cursor 45p are not symmetrical between the plus side and the minus side.

However, in the case of using the approximating straight line AL, it is possible, for example, to swing the cursor 45p with a large angle relative to the actual value of the swing angle θ of the transmitter 2, so that the approximating straight line AL can also be used for coarse adjustment.

### Embodiment 4

In Embodiment 2 and Embodiment 3, the position information (X-axis position information) corresponding to the absolute value of the swing angle θ is defined in correspondence with the absolute position (position coordinates) of the cursor 45p on the display screen 45d. However, in this embodiment, continuous control of the position of the cursor 45p is performed smoothly and quickly by performing a relative control of the position of the cursor 45p on the display screen 45d in correspondence with a variation (relative value) in the swing angle θ. That is, this embodiment is characterized by controlling the position information of the cursor position as a variation (movement amount) based on a change in the swing angle θ. It should be noted that the description of structural details that are the same as those of Embodiment 2 and Embodiment 3 are omitted as appropriate.

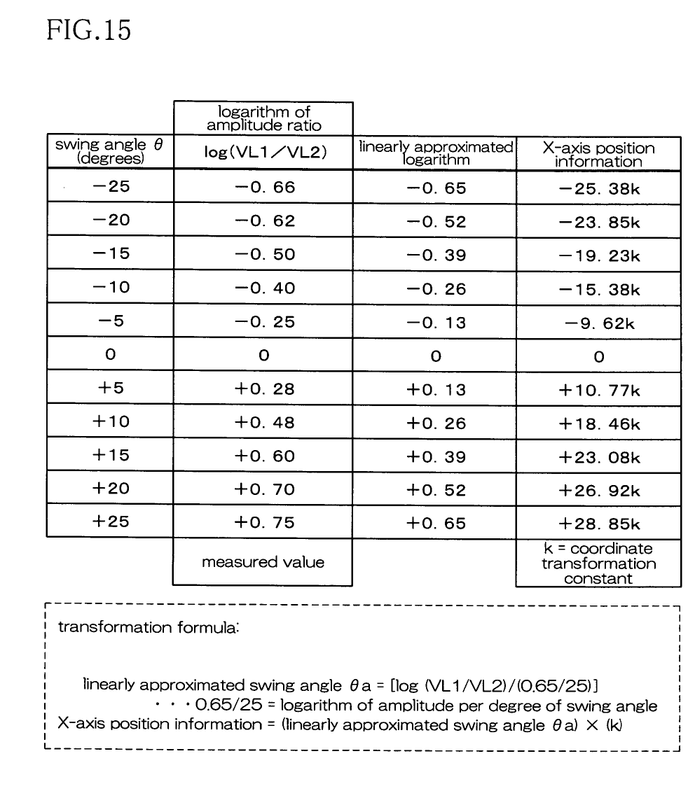

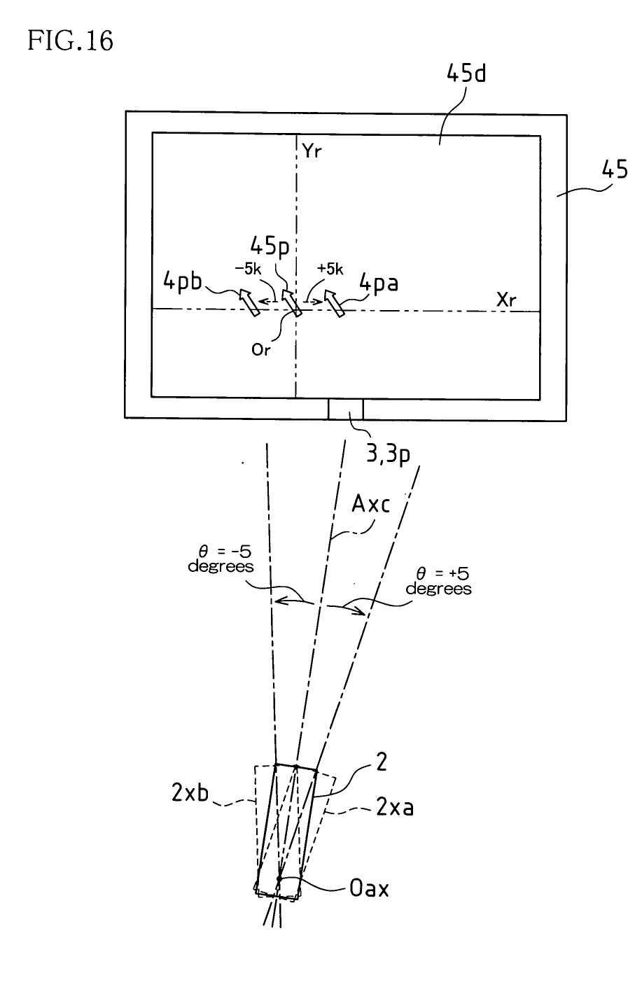

FIG. 16 is an explanatory diagram illustrating a form of coordinate transformation for changing the cursor position in correspondence with a variation in the swing angle in a remote control system according to Embodiment 4.

In a case where the cursor 45p at its position immediately before displacement of the transmitter 2 is located at a relative origin (Or) of the most recent relative coordinate axes (a relative Xr axis and a relative Yr axis), when the transmitter 2 is swung, for example, with a swing angle θ=−5 degrees to the left from the central axis Axc (when the transmitter 2 is displaced to a position of the transmitter 2xb), −5 k (see FIG. 12) can be used as the X-axis position information. Accordingly, it is possible to control the cursor to move to the cursor 4pb having a coordinate location corresponding to the X-axis position information −5 k, with respect to the cursor 45p.

Similarly, when the transmitter 2 is swung, for example, with a swing angle θ=+5 degrees to the right from the central axis Axc (when the transmitter 2 is displaced to the position of the transmitter 2xa), +5 k (see FIG. 12) can be used as the X-axis position information. Accordingly, it is possible to use the X-axis position information −5 k (see FIG. 12). Accordingly, it is possible to control the cursor to move to the cursor 4pa having a coordinate location corresponding to the X-axis position information +5 k, with respect to the cursor 45p.

When the transmitter 2 is placed directly facing the receiver 3 (light-receiving unit 3p), shows the state indicated by the transmitter 2, and maintains that state, the swing angle θ corresponds to 0 degree, and the X-axis position information is 0, as shown in FIG. 12. Accordingly, the cursor 45p does not change its position, and maintains its most recent position (relative origin Or) on the display screen 45d.

The relative coordinate axes (relative Xr axis, relative Yr axis) may be set with respect to a position at which the most recent cursor 45p is present as the relative origin Or, and the movement amount from the relative origin Or may be caused to correspond to the X-axis position information, which is set as a relative value (variation), so that control can be performed very easily.

To facilitate understanding, a variation in the swing angle θ was described based on the swing angle θ=0. However, there is no limitation to this, and this embodiment also can be applied to such a case where the swing angle changes by +5 degrees, from swing angle θ=10 degrees to swing angle θ=15 degrees. That is, by applying a variation in the X-axis position information (15 k−10 k=+5), it is possible to displace the cursor 45p from the most recent relative coordinates in correspondence with the variation in the swing angle θ (to move the cursor 45p in correspondence with the change in the X-axis position information corresponding to the variation in the swing angle θ=+5 degrees, i.e., +5 k).

The detection of the relative value (variation) of the swing angle θ may be carried out by periodically performing sampling at an appropriate timing. For example, the detection can be carried out by installing in advance a program suitable for determining a difference of between the swing angle θ at the last sampling and the swing angle θ at the current sampling, in synchronization with the light-emission cycle Tc, and calculating the movement amount based on the position information corresponding to the difference. In addition, a variation in the X-axis position information also can be obtained by performing appropriate arithmetic processing on the X-axis position information corresponding to the swing angle θ (variation) with reference to the reference table.

In this embodiment, a variation in the swing angle θ is converted into a variation in the position of the cursor 45p, so that this embodiment can also be applied in a case where the position of the cursor 45p is finely adjusted. Furthermore, it is possible to readily switch from the processing mode of Embodiment 2 or Embodiment 3 (the absolute mode in which an absolute value is used for the swing angle and the position information, or the relative mode in which a relative value is used) to that of this embodiment by appropriately controlling the arithmetic processing unit 424 or the cursor control unit 405, for example.

It is also possible to use at least two types of position information (X-axis position information) corresponding to the swing angle θ, thereby making it possible to perform coarse adjustment and fine adjustment (see Embodiment 5). For example, although it was explained that the position information was +5 k when the variation in the swing angle θ is +5 degrees, it is possible to let the position information correspond to +1 k when the variation in the swing angle θ is +5 degrees, thereby performing fine adjustment.

### Embodiment 5

In this embodiment, the resolution of cursor position control is made variable. That is, coarse adjustment in which the cursor is moved by a large amount and fine adjustment in which the cursor is moved by a small amount can be performed for the same swing angle θ.

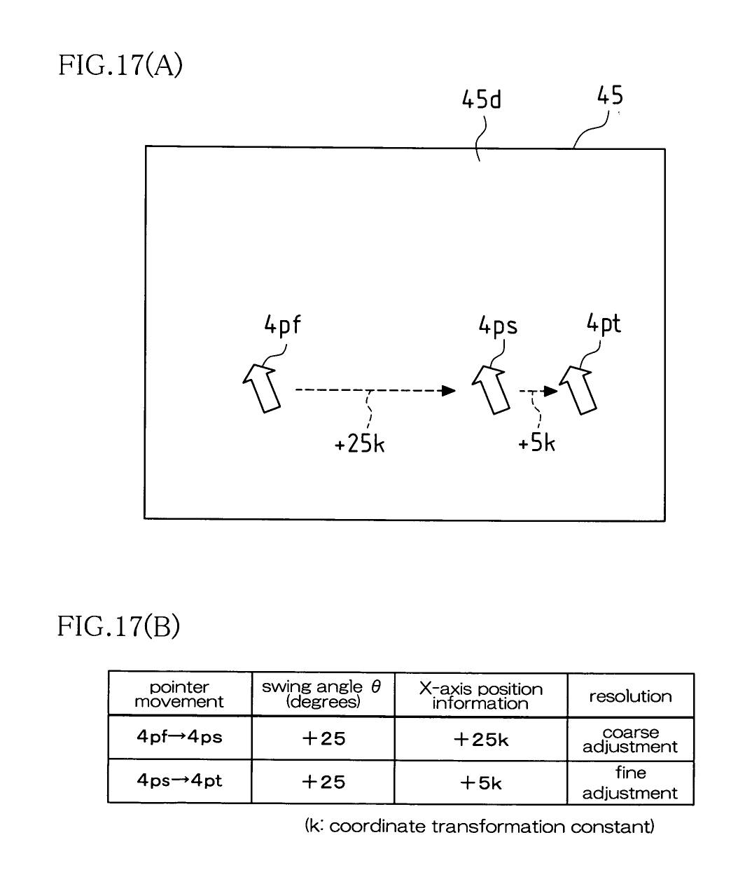

FIGS. 17(A) and 17(B) are diagrams for illustrating a case where coarse adjustment and fine adjustment are made possible using two types of large and small movement amounts of a cursor for the same swing angle of the transmitter in a remote control system according to Embodiment 5 of the present invention. FIG. 17(A) is an explanatory diagram showing a state of movement of the cursor displayed on the display screen, and FIG. 17(B) is a chart showing a relationship between the swing angle of the transmitter and the movement amount (position information) of the cursor that corresponds to movement of the cursor.

In FIG. 17(A), the cursor 45p displayed on the display screen 45d is initially at the position indicated by the cursor 4pf, and subjected to a large amount of movement control (coarse adjustment corresponding to the X-axis position information +25 k) at a first stage of position control, and moves to the position indicated by the cursor 4ps near the cursor 4pt, which is the target position.

At the subsequent second stage, the cursor 4ps is subjected to a small amount of movement control (fine adjustment corresponding to the X-axis position information+5 k), and moves to the target position indicated by the cursor 4pt. As with Embodiment 2 to Embodiment 4, this embodiment is described for a case where control is performed in the first axis direction X. However, this embodiment can also be similarly applied to the second axis direction Y

That is, when movement control of the cursor 45p is performed at the first stage (the movement from the cursor 4pf to the cursor 4ps) based on the swing angle θ (for example, a variation of +25 degrees) of the transmitter 2, a large amount of movement control is performed by setting the X-axis movement amount to +25 k (k: coordinate transformation constant).

On the other hand, when the movement control of the cursor 45p is performed at the second stage (the movement from the cursor 4ps to the cursor 4pt) based on the same swing angle θ as that of the first stage (for example, a variation of +25 degrees), a smaller amount of movement control than that of the first stage is performed by setting the X-axis movement amount to +5 k (k: coordinate transformation constant). Since a smaller movement amount than that of the first stage is set for the same variation in the swing angle θ, it is possible to perform control with higher accuracy than in the first stage.

By switching between the X-axis position information that causes the cursor 45p to move by a large amount (coarse adjustment position information) and the X-axis position information that causes the cursor 45p to move by a small amount (fine adjustment position information) for the same swing angle θ (variation) of the transmitter 2, it is possible to realize a configuration in which the resolution of the position control of the cursor 45p is variable, thus making it possible to improve the accuracy and the operability. Since coarse adjustment is performed first, and then fine adjustment is carried out subsequently, it is possible to realize smooth operations.

For example, as in the coarse adjustment of this embodiment, when the position of the cursor 45p is controlled by setting the effective swing angle θ of the transmitter 2 to +25 degrees and letting −25 degrees and +25 degrees respectively correspond to the lateral two ends of the display screen 45d, the X-axis position information corresponding to the swing angle θ=+25 degrees is +25 k. In this case, in order to control the position of the cursor 45p for each one-fiftieth pitch (corresponding to the X-axis position information 1 k) by laterally dividing the display screen 45d into 50 segments, it is necessary to operate and control the swing angle θ of the transmitter 2 in one-degree increments/decrements. However, controlling the swing angle θ in one-degree increments/decrements requires very exact operations, being very stressful for the operator and actually making position control very difficult.

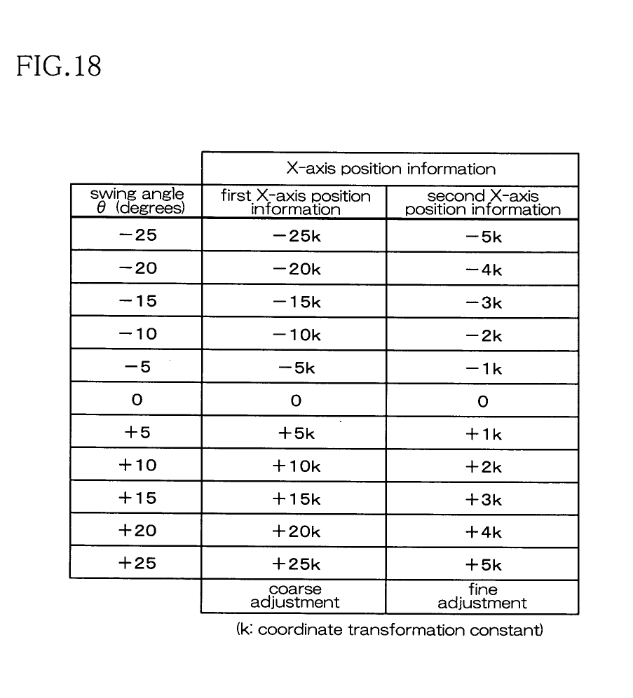

In contrast, as with this embodiment, by performing the position control of the cursor 45p in two stages in which adjustment is first made using large X-axis position information (first X-axis position information (see FIG. 18)) as coarse adjustment and adjustment is made using small position information (second X-axis position information (see FIG. 18)) as fine adjustment after performing the coarse adjustment, it is possible to perform highly accurate position control very easily and smoothly.

For example, after switching to the fine adjustment, control is performed by setting the X-axis position information corresponding to effective swing angle θ=+25 degrees (second X-axis position information) to +5 k. That is, on the display screen 45d, control is performed with accuracy five times higher than the accuracy in the coarse adjustment. In this case, in order to control the position of cursor 45p for each one-fiftieth pitch (corresponding to the X-axis position information 1 k) by laterally dividing the screen into 50 segments, the swing angle θ of the transmitter 2 may be operated and controlled in five-degree increments/decrements. That is, it is possible to ensure a resolution that is five times higher (high resolution) and hence operability that is five times better, thus providing a transmitter 2 that is very easy for an operator to operate.

It should be noted that the switching of the X-axis position information of the cursor corresponding to the same swing angle θ is not limited to two types (first position information and second position information), and may be performed with at least two types that result in coarse and fine adjustments in comparison. It is possible to perform position control with even higher accuracy by further increasing the number of switching stages.

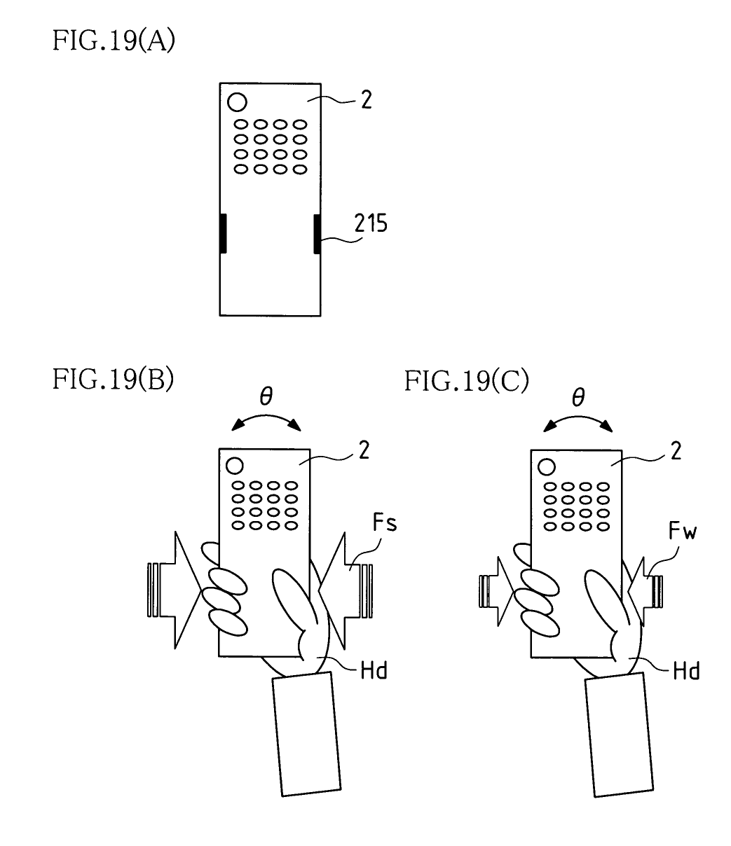

Furthermore, FIG. 19(A) to FIG. 19(C) show a working example of a resolution switching means that switches the X-axis position information of the cursor corresponding to the same swing angle θ. By appropriately driving the resolution switching means, it is possible to switch between two types of position information.

FIG. 18 is a chart for describing how two types of X-axis position information are set for coarse adjustment and fine adjustment in correspondence with the swing angle of the transmitter in variation control with the resolutions shown in FIG. 17.

Two types of X-axis movement amounts (X-axis position information) are set as first X-axis position information (coarse adjustment position information) and second X-axis position information (fine adjustment position information) in correspondence with the same swing angle θ (variation). The first X-axis position information corresponds to the first stage (coarse adjustment), and the second X-axis position information corresponds to the second stage (fine adjustment), as described with reference to FIG. 17. Since the relative ratio of the first X-axis position information to the second X-axis position information is set to 5, it is possible to change the resolution of the X-axis position information corresponding to the swing angle θ, thus making it possible to perform fine adjustment with accuracy five times higher than the accuracy of the coarse adjustment.

It should be noted that it is possible to carry out coarse adjustment and fine adjustment very simply by creating a reference table showing the correspondence between the swing angle θ and the X-axis position information within the range of the effective swing angle (±25 degrees).

By creating a reference table in which the first X-axis position information and the second X-axis position information are caused to correspond to the swing angle θ (variation), the X-axis position information can be readily referenced from the computation output Sop, thus making it possible to control the cursor position simply and very accurately.

FIGS. 19(A), 19(B) and 19(C) are diagrams for schematically illustrating a configuration of the resolution switching means in variation control with the resolutions shown in FIG. 17. FIG. 19(A) shows an external view of the transmitter, FIG. 19(B) is a diagram showing the resolution switching means being held with a strong force, and FIG. 19(C) is a diagram showing the resolution switching means being held with a weak force.

In this embodiment, a pressure sensor 215 is provided in the holding portion of the transmitter 2 on the side face of the transmitter 2 as a resolution switching means. Strongly holding the pressure sensor 215 by a hand Hd of an operator is made to correspond to the first stage (coarse adjustment) of the movement control of the cursor 45p, and weakly holding the pressure sensor 215 by the hand Hd of the operator is made to correspond to the second stage (fine adjustment) of the movement control of the cursor 45p. It is sufficient if the pressure sensor 215 can detect a holding force, and, specifically, it may be constituted by a grasping force sensor or the like.

That is, when the pressure sensor 215 detects a strong pressure Fs, the first stage control is recognized, and the above-described first X-axis position information is selected. When the pressure sensor 215 detects a weak pressure Fw, the second stage control is recognized, and the above-described second X-axis position information is selected. Since the holding force at the second stage is caused to correspond to the weak pressure Fw, a strong holding force is not necessary in the fine adjustment, thereby making it possible to control the position of the transmitter 2 finely and stably, and controlling the cursor 45p stably with high accuracy.

Although a case was described where the pressure sensor 215 is used as the resolution switching means, it is possible to use a button, a capacitance touch pad and other suitable switching means as the resolution switching means.

The resolution switching (switching between the coarse adjustment position information and the fine adjustment position information) can be performed by changing the emission pattern of the light signals LS constituted by the position detection light signals LSp (the first light signal LS1 through the fourth light signal LS4) and the detection start light signal (LSs) emitted from the position detection light-emission unit 2, when the resolution switching means is operated.

For example, it is possible to install in advance a program for switching the position information between a coarse adjustment mode when there is a single detection start light signal LSs and a fine adjustment mode when there are two consecutive detection start light signals LSs. It is also possible to change between coarse adjustment and fine adjustment, for example, by changing the light-emission pulse width Ts of the position detection light signals LSp (the first light signal LS1 to the fourth light signal LS4) by a factor of 2, for example.

### Embodiment 6

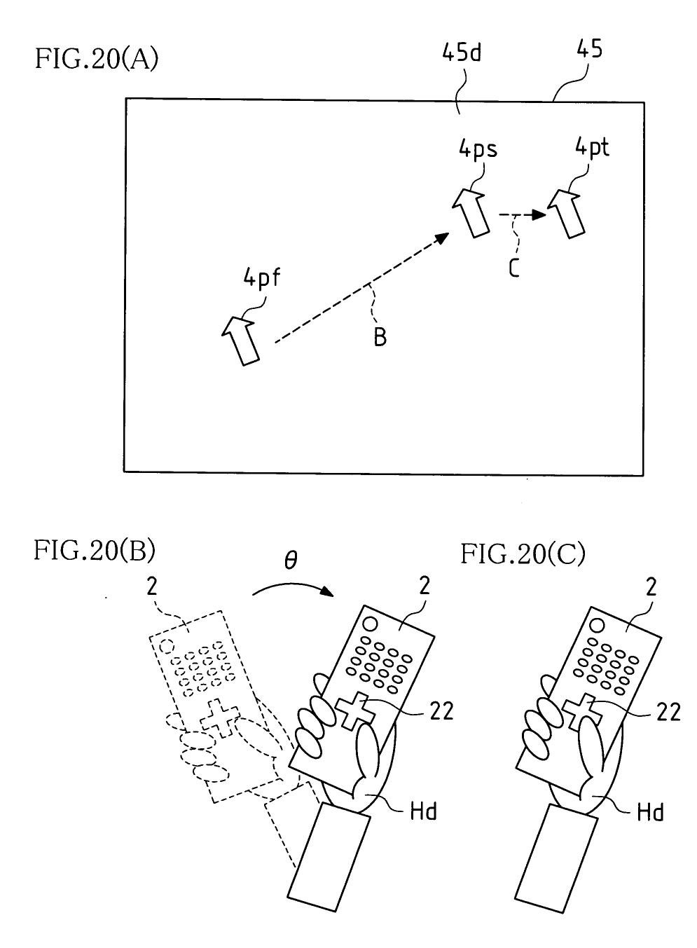

FIGS. 20(A), 20(B) and 20(C) are diagrams schematically showing how operations are carried out when coarse adjustment and fine adjustment are performed in a remote control system according to Embodiment 6 of the present invention. FIG. 20(A) is an explanatory diagram showing a state of movement of a cursor displayed on the display screen, FIG. 20(B) is a diagram showing how the transmitter is operated in coarse adjustment indicated by the arrow B in FIG. 20(A), and FIG. 20(C) is a diagram showing how the transmitter is operated in fine adjustment indicated by the arrow C in FIG. 20(A).

In Embodiment 5, coarse adjustment and fine adjustment are carried out for controlling the cursor position for the same swing angle θ of the transmitter 2 by using at least two types of large and small position information of the cursor. In other words, fine adjustment is carried out also based on the swing angle θ.

In this embodiment, coarse adjustment and fine adjustment are carried out for controlling the position of the cursor 45p, as with Embodiment 5. However, this embodiment is different from Embodiment 5 in that fine adjustment is carried out using a fine adjustment alternative signal generating means.

In FIG. 20 (A), the cursor 45p displayed on the display screen 45d is initially at the position indicated by the cursor 4pf, and subjected to a large amount of movement control (coarse adjustment) at a first stage of position control, and moves as indicated by the arrow B to the position indicated by the cursor 4ps near the cursor 4pt, which is the target position. It should be noted that the coarse adjustment in this embodiment is carried out based on the swing angle θ of the transmitter 2 (see Embodiment 1 to Embodiment 5), as shown in FIG. 20(B).

In the subsequent second stage, the cursor 4ps is subjected to a small amount of movement control (fine adjustment) by controlling drive of the fine adjustment alternative signal generating means (not shown) using a cross-shaped key 22, and moves as indicated by the arrow C to the position indicated by the cursor 4pt, which is the target position.

The fine adjustment is carried out based on a fine adjustment optical code signal as position information (position information signal) from the fine adjustment alternative signal generating means installed in the transmitter 2. That is, the fine adjustment optical code signal as the position information signal for delimiting (controlling) the position to which the cursor 45p moves (from 4ps to 4pt) is transmitted from the fine adjustment alternative signal generating means contained in the transmitter 2 to the receiver 3, and fine adjustment is carried out on the position of the cursor 45p (from 4ps to 4pt) by the cursor control unit 405, based on the fine adjustment optical code signal (position information) received (optically received) by the receiver 3

Although a dedicated light-emitting element may be used for emitting the fine adjustment optical code signal, it is also possible to repurpose the light-emitting elements (the start signal light-emitting element LEDs, and the first light-emitting element LED1 to the fourth light-emitting element LED4), which were used in other embodiments.

In this embodiment, the fine adjustment is carried out based on the fine adjustment optical code signal, and therefore is not influenced by the swing angle θ of the transmitter 2, so that it is possible to carry out highly accurate and stable fine adjustment for the position of the cursor 45p. Furthermore, since the fine adjustment alternative signal generating means is driven using the cross-shaped key 22, it is possible to perform fine adjustment with good operability.

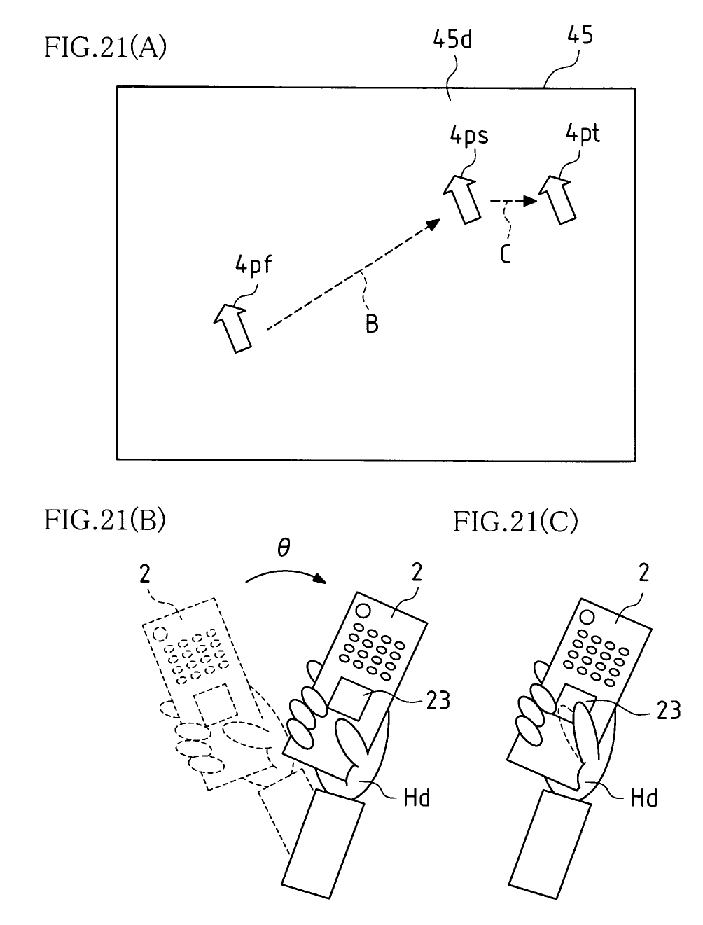

FIGS. 21(A), 21(B) and 21(C) are diagrams schematically showing how operations are carried out when coarse adjustment and fine adjustment are performed in the remote control system according to Embodiment 6, similarly to FIGS. 20(A) to 20(C). FIG. 21(A) is an explanatory diagram showing a state of movement of the cursor displayed on the display screen, FIG. 21(B) is a diagram showing how the transmitter is operated in the coarse adjustment indicated by the arrow B in FIG. 21(A), and FIG. 21(C) is a diagram showing how the transmitter is operated in the fine adjustment indicated by the arrow C in FIG. 21(A).

The basic configuration is the same as that shown in FIGS. 20(A) to 20(C), and therefore its detailed description is omitted. In FIGS. 21(A) to 21(C), the fine adjustment alternative signal generating means is driven using a capacitance touch pad 23. Accordingly, it is possible to achieve an effect similar to that achieved in the case shown in FIGS. 20(A) to 20(C).

It should be noted that in FIGS. 20(A) to 20(C) and FIGS. 21(A) to 21(C), the function of coarse adjustment is disabled when the fine adjustment alternative signal generating means is driven. With this configuration, it is possible to perform stable fine adjustment without any influence by the swing angle θ of the transmitter 2.

### Embodiment 7

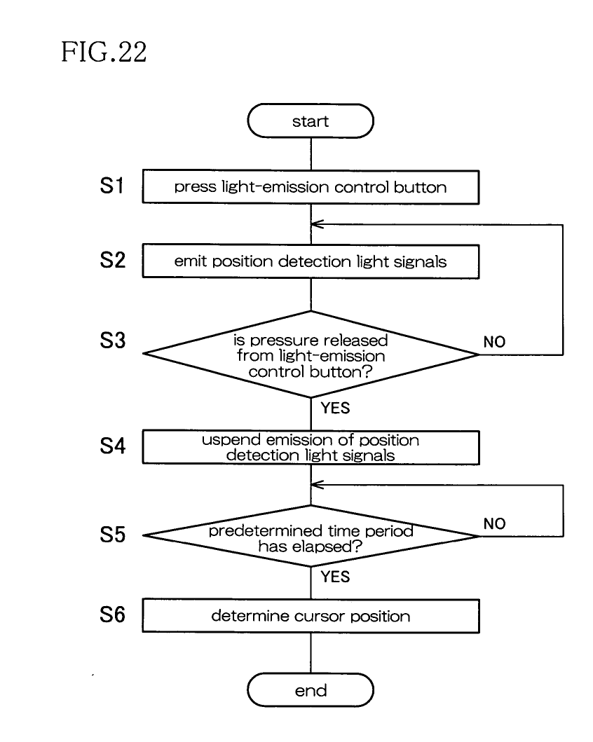

FIG. 22 is a flowchart of a first flow example showing the relation between an on/off operation of the light-emitting element control unit and determination of the cursor position in the remote control systems according to Embodiment 1 to Embodiment 5.

Step S1:

The light-emission control button 2sw is pressed.

Step S2:

The light-emitting elements LED (the first light-emitting element LED1 to the fourth light-emitting element LED4) emit position detection light signals LSp in response to pressing of the light-emission control button 2sw.

Step S3:

It is judged whether the light-emission control button 2sw is kept pressed. In other words, it is judged whether pressure is released from the light-emission control button 2sw. If it is kept pressed (Step S3: NO), then the flow returns to Step S2, in which emission of the position detection light signals LSp is continued. If the pressure is released (Step S3: YES), then the flow advances to Step S4.

Step S4:

Emission of the position detection light signals LSp is suspended in response to release of pressure from the light-emission control button 2sw.

Step S5:

The suspension of emission of the position detection light signals LSp causes a non-detection state of the position detection output signals Sp, and it is judged whether this state has continued for a predetermined time period. In other words, it is judged whether a predetermined time period has elapsed in the non-detection state of the position detection output signals Sp. If the predetermined time period has not elapsed (Step S5: NO), then counting of time is continued. If the predetermined time period has elapsed (Step S5: YES), then the flow advances to Step S6.

Step S6:

The position control of the cursor 45p based on the swing angle 0 is judged to be completed, and the position of the cursor 45p is determined.

The flow of Step S1 to Step S6 above can be appropriately performed by providing a predetermined light-emission control button 2sw suitable for the flow, and installing in advance a flow program, using the microcomputer included in the transmitter 2 or the receiver 3 of the system 1.

That is, the remote control systems 1 according to this embodiment is applied to the remote control systems 1 according to Embodiment 1 to Embodiment 5. Furthermore, the light-emission control button 2sw that controls the on/off operation of the light-emitting element control unit 2dc is provided, so that the position detection light signals LSp are emitted when the light-emission control button 2sw is pressed, emission of the position detection light signals LSp is suspended when pressure is released from the light-emission control button 2sw, and the position of the cursor 45p is determined when the non-detection state of the position detection output signals Sp has continued for a predetermined time period. Accordingly, it is possible to control the cursor position quickly and smoothly.

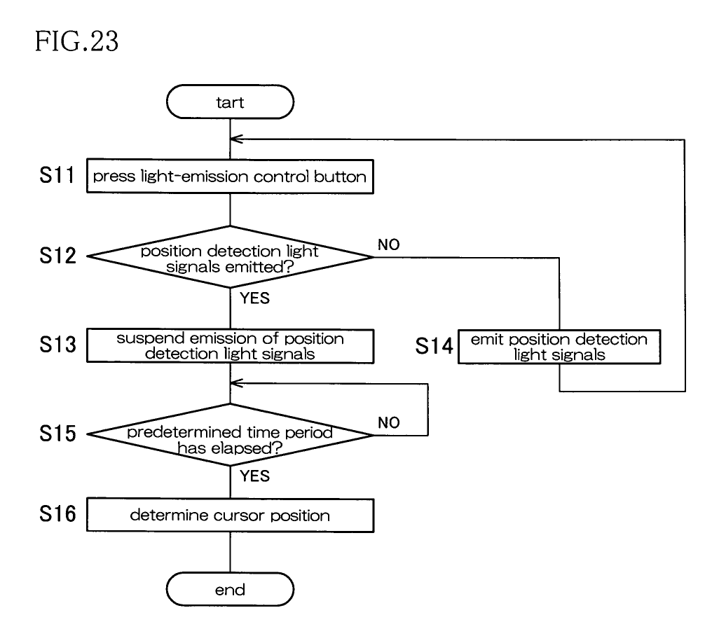

FIG. 23 is a flowchart of a second flow example showing the relation between an on/off operation of the light-emitting element control unit and determination of the cursor position in the remote control systems according to Embodiment 1 to Embodiment 5.

Step S11:

The light-emission control button 2sw is pressed.

Step S12:

It is judged whether the light-emitting elements LED (the first light-emitting element LED1 to the fourth light-emitting element LED4) emit position detection light signals LSp in response to pressing of the light-emission control button 2sw. If the position detection light signals LSp are emitted (Step S12: YES), then the flow advances to Step S13. If the position detection light signals LSp are not emitted (Step S12: NO), then the flow advances to Step S14.

Step S13:

Since the light-emission control button 2sw is pressed while the position detection light signals LSp are emitted, emission of the position detection light signals LSp is suspended.

Step S14:

Since the light-emission control button 2sw is pressed while the position detection light signals LSp are not emitted, the position detection light signals LSp are emitted, and the flow returns to the state prior to Step S11.

Step S15:

The suspension of emission of the position detection light signals LSp causes a non-detection state of the position detection output signals Sp, and it is judged whether this state has continued for a predetermined time period. In other words, it is judged whether a predetermined time period has elapsed in the non-detection state of the position detection output signals Sp. If the predetermined time period has not elapsed (Step S15: NO), then counting of time is continued. If the predetermined time period has elapsed (Step S15: YES), then the flow advances to Step S16.

Step S16:

The position control of the cursor 45p based on the swing angle 0 is judged to be completed, and the position of the cursor 45p is determined.

The flow of Step S11 to Step S16 above can be appropriately performed by providing a predetermined light-emission control button 2sw suitable for the flow, and installing in advance a flow program, using the microcomputer included in the transmitter 2 or the receiver 3 of the system 1.

That is, the remote control systems 1 according to this embodiment is applied to the remote control systems 1 according to Embodiment 1 to Embodiment 5. Furthermore, the light-emission control button 2sw that controls the on/off operation of the light-emitting element control unit 2dc is provided, so that the position detection light signals LSp are switched between emission and non-emission states each time the light-emission control button 2sw is pressed, and the position of the cursor 45p is determined when the non-detection state of the position detection output signals Sp has continued for a predetermined time period. Accordingly, it is possible to control the cursor position quickly and smoothly.

### Embodiment 8

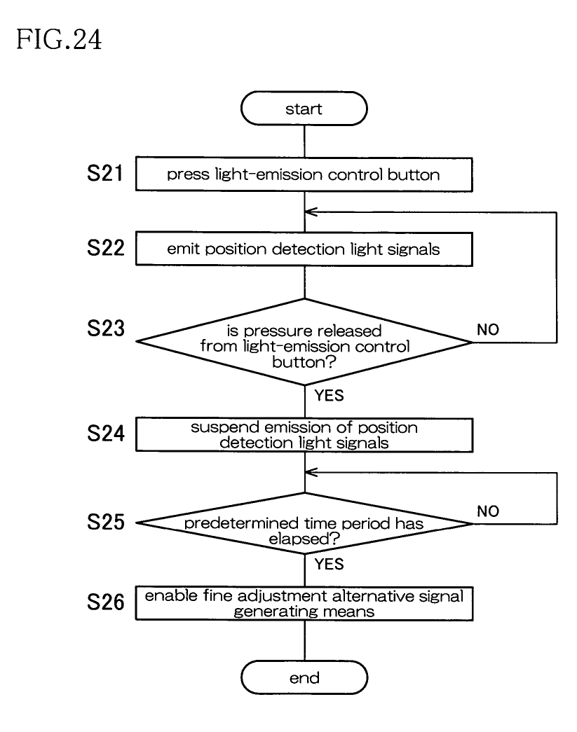

FIG. 24 is a flowchart of a first flow example showing the relation between an on/off operation of the light-emitting element control unit and a fine adjustment alternative signal generating means in the remote control systems according to Embodiment 6.

Step S21:

The light-emission control button 2sw is pressed.

Step S22:

The light-emitting elements LED (the first light-emitting element LED1 to the fourth light-emitting element LED4) emit position detection light signals LSp in response to pressing of the light-emission control button 2sw.

Step S23:

It is judged whether the light-emission control button 2sw is kept pressed. In other words, it is judged whether pressure is released from the light-emission control button 2sw. If it is kept pressed (Step S23: NO), then the flow returns to Step S22, in which emission of the position detection light signals LSp is continued. If the pressure is released (Step S23: YES), then the flow advances to Step S24.

Step S24:

Emission of the position detection light signals LSp is suspended in response to release of pressure from the light-emission control button 2sw.

Step S25:

The suspension of emission of the position detection light signals LSp causes a non-detection state of the position detection output signals Sp, and it is judged whether this state has continued for a predetermined time period. In other words, it is judged whether a predetermined time period has elapsed in the non-detection state of the position detection output signals Sp. If the predetermined time period has not elapsed (Step S25: NO), then counting of time is continued. If the predetermined time period has elapsed (Step S25: YES), then the flow advances to Step S26.

Step S26:

The fine adjustment alternative signal generating means (operated with the cross-shaped key 22 or the capacitance touch pad 23, for example) is enabled. At this time, the control based on the swing angle θ is disabled.

The flow of Step S21 to Step S26 above can be appropriately performed by providing a predetermined light-emission control button 2sw suitable for the flow, and installing in advance a flow program, using the microcomputer included in the transmitter 2 or the receiver 3 of the system 1.

That is, the remote control system 1 according to this embodiment is applied to the remote control system according to Embodiment 6. Furthermore, the light-emission control button 2sw that controls the on/off operation of the light-emitting element control unit 2dc is provided, so that the position detection light signals LSp are emitted when the light-emission control button 2sw is pressed, emission of the position detection light signals LSp is suspended when pressure is released from the light-emission control button 2sw, and the fine adjustment alternative signal generating means is enabled when the non-detection state of the position detection output signals Sp has continued for a predetermined time period. Accordingly, it is possible to control the cursor position quickly, smoothly and highly accurately.

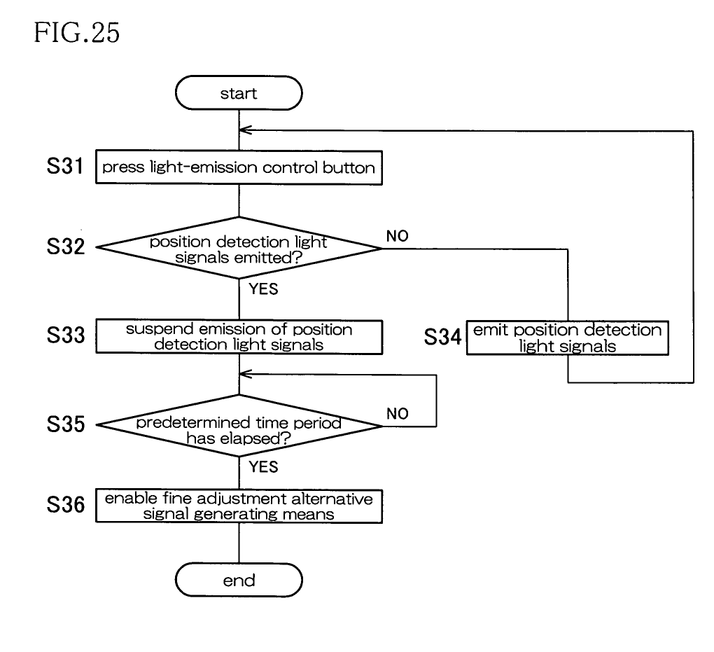

FIG. 25 is a flowchart of a second flow example showing the relation between an on/off operation of the light-emitting element control unit and the fine adjustment alternative signal generating means in the remote control system according to Embodiment 6.

Step S31:

The light-emission control button 2sw is pressed.

Step S32:

It is judged whether the light-emitting elements LED (the first light-emitting element LED1 to the fourth light-emitting element LED4) emit position detection light signals LSp in response to pressing of the light-emission control button 2sw. If the position detection light signals LSp are emitted (Step S32: YES), then the flow advances to Step S33. If the position detection light signals LSp are not emitted (Step S32: NO), then the flow advances to Step S34.

Step S33:

Since the light-emission control button 2sw is pressed while the position detection light signals LSp are emitted, emission of the position detection light signals LSp is suspended.

Step S34:

Since the light-emission control button 2sw is pressed while the position detection light signals LSp are not emitted, the position detection light signals LSp are emitted, and the flow returns to the state prior to Step S31.

Step S35:

The suspension of emission of the position detection light signals LSp causes a non-detection state of the position detection output signals Sp, and it is judged whether this state has continued for a predetermined time period. In other words, it is judged whether a predetermined time period has elapsed in the non-detection state of the position detection output signals Sp. If the predetermined time period has not elapsed (Step S35: NO), then counting of time is continued. If the predetermined time period has elapsed (Step S35: YES), then the flow advances to Step S36.

Step S36:

The fine adjustment alternative signal generating means (driven with the cross-shaped key 22 or the capacitance touch pad 23, for example) is enabled. At this time, the control based on the swing angle θ is disabled.

The flow of Step S31 to Step S36 above can be appropriately performed by providing a predetermined light-emission control button 2sw suitable for the flow, and installing in advance a flow program, using the microcomputer included in the transmitter 2 or the receiver 3 of the system 1.

That is, the remote control system 1 according to this embodiment is applied to the remote control system 1 according to Embodiment 6. Furthermore, the light-emission control button 2sw that controls the on/off operation of the light-emitting element control unit 2dc is provided, so that the position detection light signals LSp are switched between emission and non-emission states each time the light-emission control button 2sw is pressed, and the fine adjustment alternative signal generating means is enabled when the non-detection state of the position detection output signals Sp has continued for a predetermined time period. Accordingly, it is possible to control the cursor position quickly, smoothly and highly accurately.

### Embodiment 9

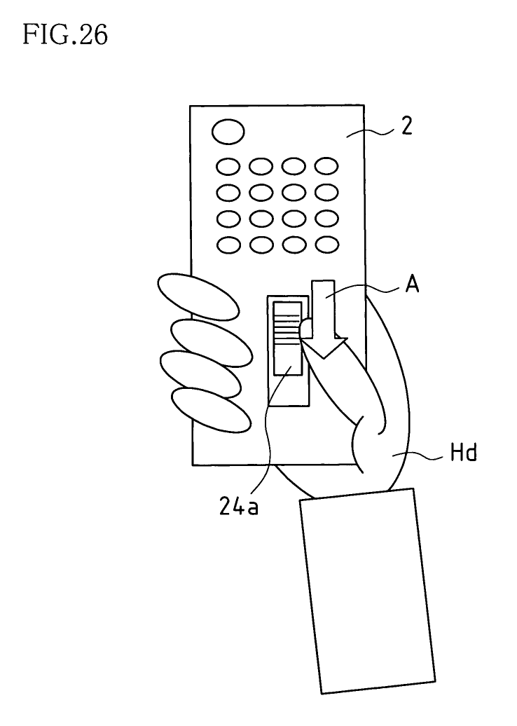

This embodiment relates to modified examples of the light-emission control button that controls emission of the light-emitting elements LED. Modified examples of the light-emission control button 2sw are described with reference to FIGS. 26 to 30.

In the case of a push-button light-emission control button 2sw, when the button is pushed in (pressed), the transmitter 2 may sway and cause the swing angle θ to be displaced in an unexpected direction. With this embodiment, it is possible to prevent such swaying of the transmitter 2, thereby realizing stable operations and detection of the swing angle θ.

FIG. 26 is a plan view conceptually showing a state in which a spring-loaded slide switch is used as the light-emission control button.

A spring-loaded slide switch 24a is disposed on the upper flat surface of the transmitter 2. For example, the switch 24a may be set to the on state when it is being slid by a hand Hd (thumb) in a direction of the arrow A, and may be set to the off state when it is returned to the original position as a result of releasing the hand Hd. The off state can be made to correspond to a state in which control of the cursor 45p based on the angle θ is completed.

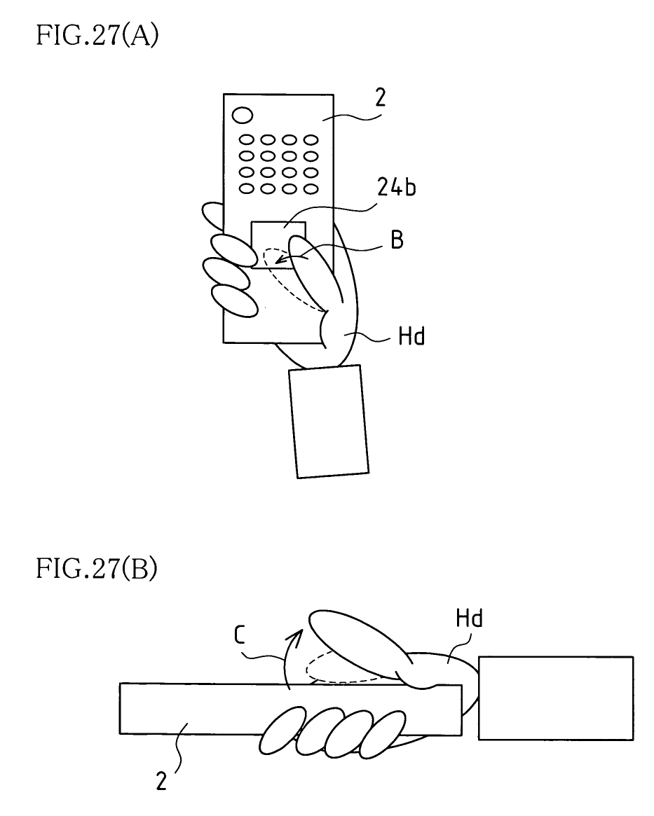

FIGS. 27(A) and 27(B) are explanatory diagrams conceptually showing a state in which a touch activated switch is used as the light-emission control button. FIG. 27(A) shows a plan view and FIG. 27(B) shows a side view.

A touch activated switch 24b is disposed on the upper flat surface of the transmitter 2. For example, the switch 24b may be set to the on state when it is being touched by a hand Hd (thumb) in a direction of the arrow C, and to the off state when it is returned to the original position as a result of releasing the hand Hd in a direction of the arrow B. The off state can be made to correspond to a state in which control of the cursor 45p based on the angle θ is completed. It is also possible to provide a configuration in which the switch between the on and off states is effected by repeated touching.

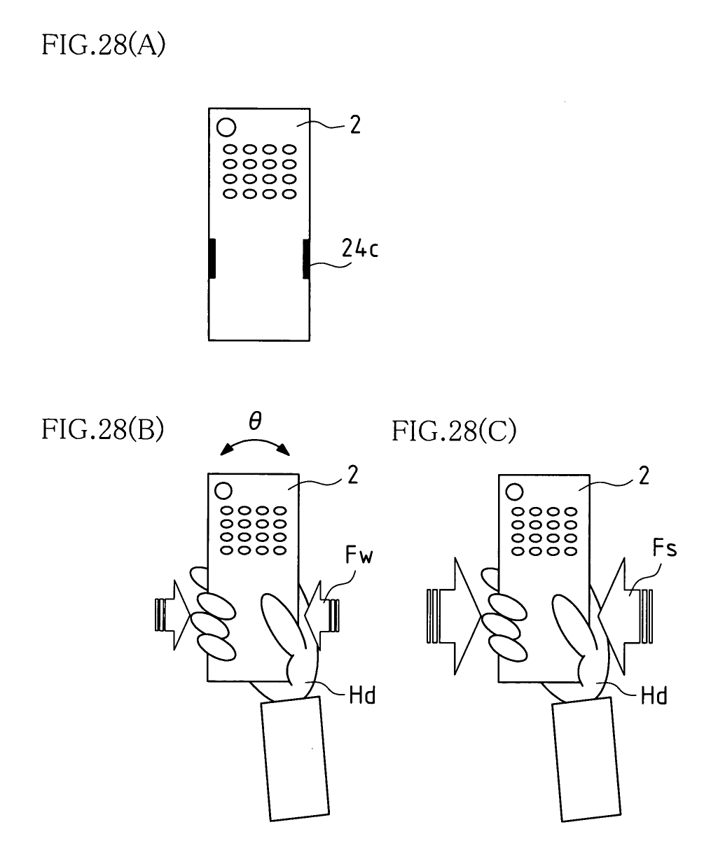

FIGS. 28(A), 28(B) and 28(C) are diagrams conceptually showing a state in which a pressure sensor is used as the light-emission control button. FIG. 28(A) is a plan view, FIG. 28(B) is a conceptual diagram showing a state in which the pressure sensor is held with a weak force, and FIG. 28(C) is a conceptual diagram showing a state in which the pressure sensor is held with a strong force.

A pressure sensor 24c capable of detecting a pressure when the transmitter 2 is held is provided on the side of the transmitter 2 (FIG. 28A). When the pressure sensor 24c is held with a weak force (FIG. 28B), it detects a weak pressure Fw and set to a first state. When it is held with a strong force (FIG. 28A), it detects a strong pressure Fs and set to a second state. Additionally, it is preferable to dispose the pressure sensor 24c at a position corresponding to the positions of the fingertips so as to detect a pressure from the fingertips.

It is possible to switch the operations by appropriately making the first state and the second state to correspond to the controlling operations of the cursor. For example, the position of the cursor 45p can be controlled in correspondence with the swing angle θ in the first state, and the position of the cursor 45p can be determined in the second state.

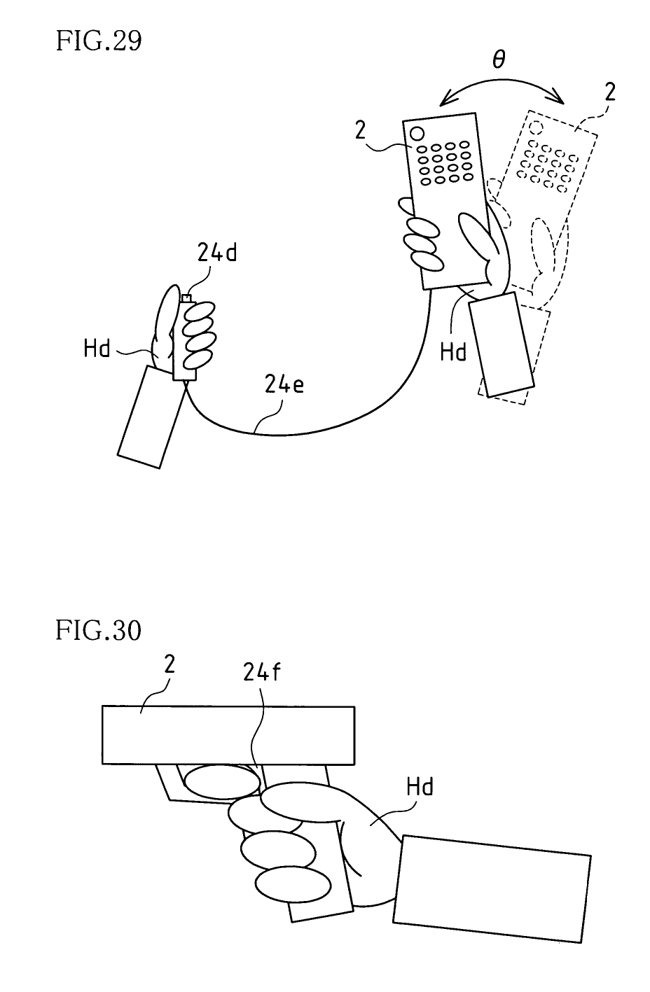

FIG. 29 is an explanatory diagram conceptually showing a state in which a wired switch is used as the light-emission control button.

A wired switch 24d is connected to the transmitter 2 via a conductive wire 24e so that it can be disposed at a position distant from the transmitter 2. The wired switch 24d can be operated in the same manner as the light-emission control button 2sw by pressing its button. Since the on/off control is performed at a position distant from the transmitter 2, no influence is exerted on the swing angle θ. Accordingly, it is possible to perform accurate control based on the swing angle θ.

FIG. 30 is an explanatory diagram conceptually showing a state in which the transmitter is formed into a pistol shape and the trigger of the pistol is used as the light-emission control button.

A trigger 24f of the pistol-shaped transmitter 2 can be operated in the same manner as the light-emission control button 2sw by being pressed (pulled).

### Embodiment 10

In this embodiment, other working examples are described as Embodiment 10.

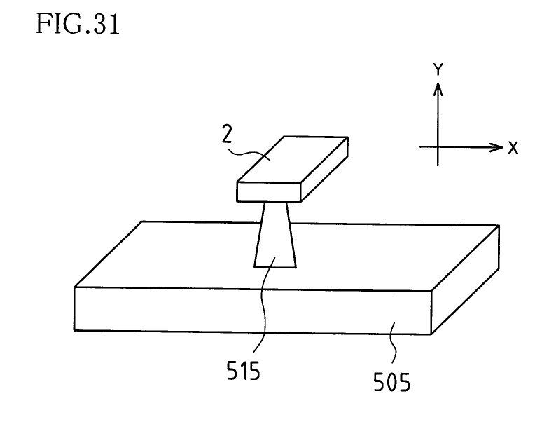

FIG. 31 is a perspective view showing a remote control transmitter that is mounted to a support table to control a cursor.

A support table 515 is formed on the upper surface of a horizontal table 505 serving as a reference table, and the transmitter 2 is rotatably mounted at the tip of the support table 515. Accordingly, the transmitter 2 can be freely displaced (swung) in a first axis direction X (corresponding to a horizontal direction) and a second axis direction Y (corresponding to a vertical direction), with the tip of the support table 515 as its origin. Since the origin of the transmitter 2 placed on the support table 515 can be strictly fixed during swinging, it is possible to perform more accurate position control of the cursor 45p based on the swing angle θ.

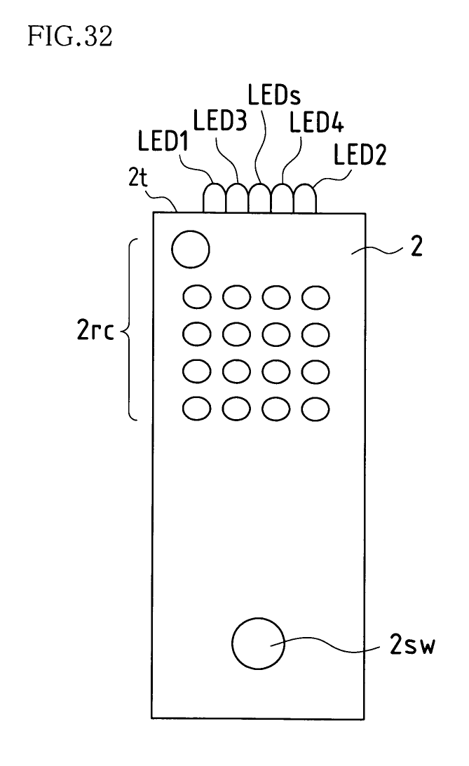

FIG. 32 is a diagram conceptually showing a remote control transmitter that is provided with command buttons.

The transmitter 2 is provided with command buttons 2rc used in a common infrared remote controller, in addition to the light-emission control button 2sw. In other words, the transmitter 2 is configured to be usable as a common infrared remote controller.

The command buttons 2rc are configured to control emission of command optical code signals (not shown). It should be noted that the command buttons 2rc may not necessarily be in a button shape, and may be configured as a different type of switch (interface) such as a touch activated switch.

The basic configuration of the transmitter 2 is the same as those shown in Embodiment 1 to Embodiment 9, and includes, at its tip portion 2t, a start signal light-emitting element LEDs, a first light-emitting element LED1, a second light-emitting element LED2, a third light-emitting element LED3 and a fourth light-emitting element LED4 as the light-emitting elements LED. (It should be noted that although the light-emitting elements LED are simply arranged side by side in FIG. 32 for simplicity, the actual arrangement is as shown in Embodiment 1 to Embodiment 9.)

In this embodiment (FIG. 32), when emission of the command optical code signals is controlled with the command buttons 2rc, the command optical code signals are emitted using at least one of the start signal light-emitting element LEDs, and the first light-emitting element LED1 to the fourth light-emitting element LED4 as the light-emitting elements LED.

Since the light-emitting elements LED are redundantly used for different functions, it is possible to prevent an increase of the light-emitting elements LED with an increase of the functions of the transmitter 2, thus making it possible to reduce the number of the light-emitting elements LED.

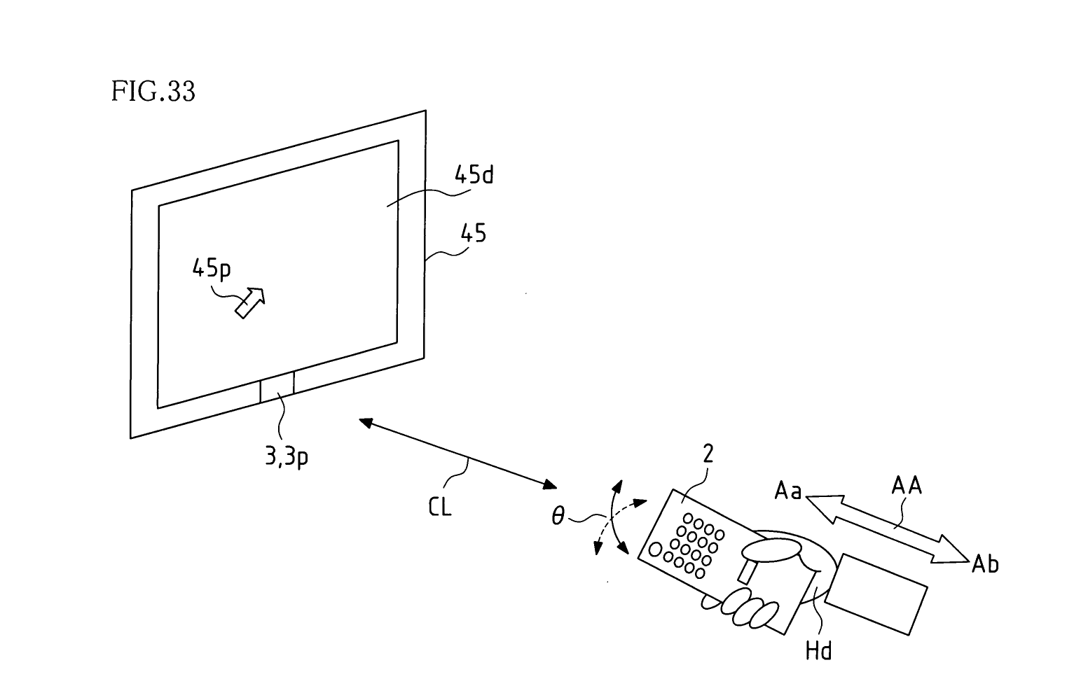

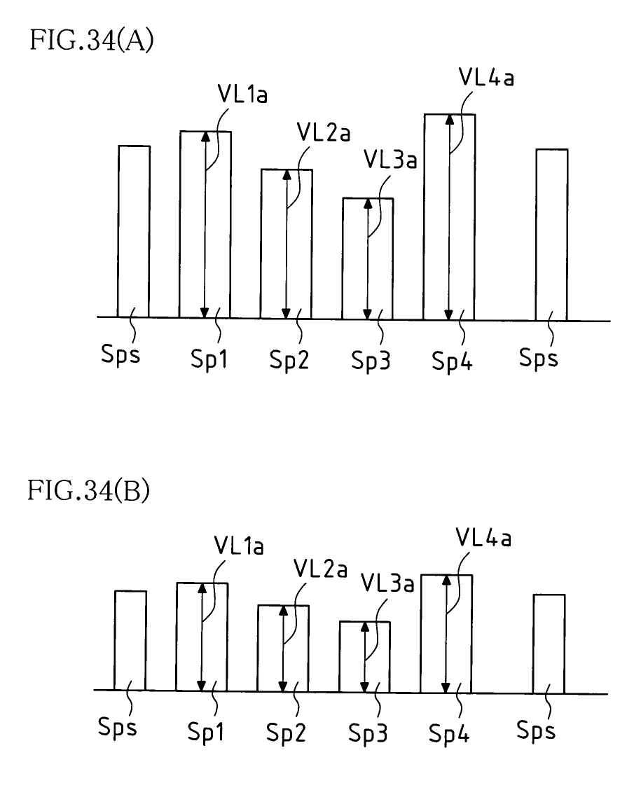

FIG. 33 is an explanatory diagram conceptually showing a remote control system that is provided with a distance measuring means and controls the cursor three-dimensionally. FIGS. 34(A) and 34(B) are charts for illustrating the magnitude of amplitudes detected in FIG. 33. FIG. 34(A) is a waveform chart for a short communication distance, and FIG. 34(B) a waveform chart for a long communication distance.

A system 1 according to this embodiment (FIG. 33) contains a distance measuring means (not shown) that detects a communication distance CL between the transmitter 2 and the display device 45 (receiver 3, light-receiving unit 3p). In general, the distance measuring means is provided at the receiver 3 side, but it can also be provided at the transmitter 2 side. For example, it is possible to detect (measure, estimate) a communication distance CL by making the transmitter 2 and the receiver 3 directly facing each other and comparing a detected amplitude value VL with a reference value that was measured and set in advance.

For example, when the communication distance CL is short (when the transmitter 2 is disposed on the Aa side of the arrows AA), the amplitude VL assumes, on the whole, large amplitude values of VL1a, VL2a, VL3a and VL4a (FIG. 34(A)). On the other hand, when the communication distance CL is long (when the transmitter 2 is disposed on the Ab side of the arrows AA), the amplitude VL assumes, on the whole, small amplitude values of VL1b, VL2b, VL3b and VL4b (FIG. 34(B)).

Accordingly, it is possible to recognize the communication distance CL by adopting a configuration in which the value (relative light-reception amount) of the amplitude VL is detected in correspondence with the communication distance CL. Additionally, it is possible to make an accurate measurement by carrying out a measurement after setting a distance detection mode.

With this embodiment (FIG. 33), it is possible to control the position of the cursor 45p three-dimensionally based on the communication distance CL and the swing angle θ.

Furthermore, it is also possible to adjust (change) the range of the effective swing angle θ based on the communication distance CL, and adjust (change) the position information corresponding to the swing angle θ.

It should be noted that the above-described various remote control systems can be applied to display devices that control a cursor that is displayed on a display screen by the above-described remote control systems, and electronic devices provided with a remote operation device (remote control transmitter), such as a television receiver, a program recorder, a game console, a video telephone system and a security camera, and these also fall within the technical scope of the present invention.

Next, embodiments of electronic devices according to the present invention are described with reference to the drawings.

Recently, television receivers are becoming more akin to personal computers, and can connect to and recognize peripheral devices. Conversely, it can be anticipated that personal computers become more akin to televisions and will be used as the current television receivers in living rooms. In such a case, it is possible to display the icon of a connected device on the screen. Moreover, in the case of performing an operation by selecting a device on the screen, it is possible to directly select the icon of an operation that is to be performed and drag and drop it onto the icon of a device that performs the operation.

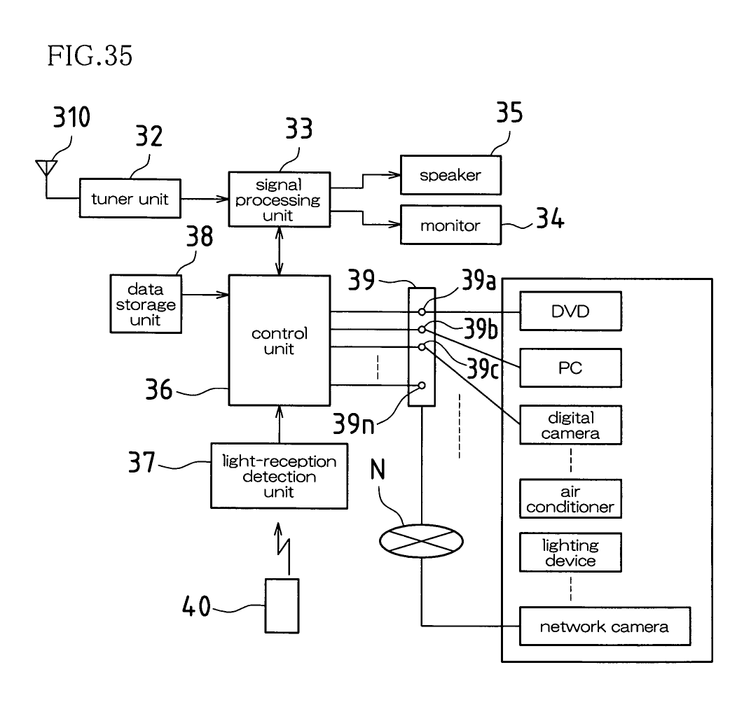

FIG. 35 is a block diagram showing the basic configuration of a television receiver that is provided with such a drag and drop function. While there is no particular limitation with respect to the configuration of a television receiver according to this embodiment, the configuration may for example include: a tuner unit 32 provided with an antenna 310 that receives signals for various types of broadcasting such as analog terrestrial broadcasting, digital terrestrial broadcasting and satellite broadcasting; a signal processing unit 33 that processes the received broadcast signals, outputs video signals to a monitor 34 and outputs audio signals to a speaker 35; a control unit 36 that control the entire television receiver; a light-reception detection unit 37 that receives remote control light signals from a remote control transmitter 40; a data storage unit 38 that stores various display data including various icons (e.g., content icons, device icons and operation icons); and an external connection terminal group 39 that can connect to one or plural external devices (e.g., household appliances such as a DVD recorder, a PC, a digital camera and an air conditioner). In addition, one terminal 39n of the external connection terminal group 39 is configured to be able to control a network camera of another user via a communications network N such as a video telephone line.

Although not shown in the drawing, the control unit 36 is made up of a CPU, a ROM, a RAM and an OSD circuit, for example. Further, the control unit 36 is provided with a drag and drop function of dragging and dropping an icon that is displayed on the monitor screen while the icon is selected by a pointer, using the remote control transmitter 40, thereby executing the application corresponding to the dropped icon in a predetermined mode. The control program for implementing this functionality is stored in the ROM.

As described above, the television receiver according to this embodiment is provided with functionality of dragging and dropping an icon that is displayed on the screen monitor 34 while the icon is selected by the pointer using the remote control transmitter 40. In this case, the drag and drop operation is carried out by moving the pointer on the monitor screen vertically and laterally by moving the remote control transmitter 40 itself vertically and laterally.

Here, the principles of the method for operating the pointer on the monitor screen by moving the remote control transmitter 40 are described first. In this embodiment, the pointer on the monitor screen is moved by detecting the orientation of the remote control transmitter 40 based on the amount of light received from the remote control transmitter 40. Examples of the method for detecting the orientation of the remote control transmitter 40 based on the amount of light received from the remote control transmitter 40 include: (1) a method that uses two elliptical LEDs having different wavelengths; (2) a method that uses a PSD (Position Sensitive Detector); and (3) a method that lights an LED in varied directions, and performs detection based on the ratio of the amounts of light received. In the following each of the methods is specifically described.

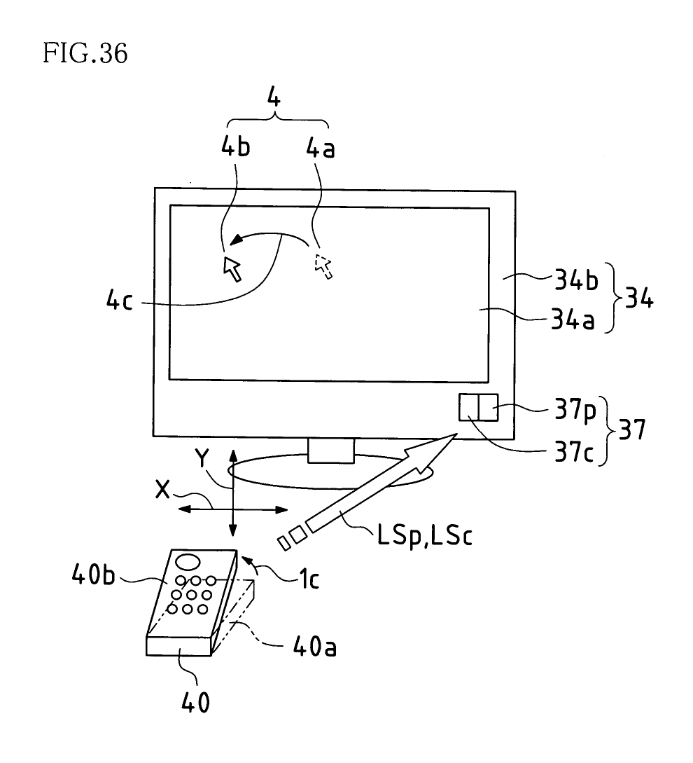

(1) Method that uses Two Elliptical LEDs having Different Wavelengths FIG. 36 is an explanatory diagram for describing the present method, wherein the monitor 34 has a display unit 34a at a central area of its front surface, and a frame portion 34b that supports the display unit 34a is provided at the perimeter thereof. The light-reception detection unit 37 is disposed (contained) at the front surface of the frame portion 34b. It should be noted that the light-reception detection unit 37 may also be provided in the display unit 34a.

A pointer 4 is displayed on the display screen of the display unit 34a as a cursor. A pointer 4a before the movement, a pointer 4b after the movement, and a movement trajectory 4c of the pointer 4 are shown conceptually in FIG. 36.

The remote control transmitter 40 emits as output a position detection light signal LSp and a function control light signal LSc, which are transmitted to the light-reception detection unit 37. The light-reception detection unit 37 is provided with a position detection light-receiving element 37p that receives as input (detects) the position detection light signal LSp, and a function control light-receiving element 37c that receives as input (detects) the function control light signal LSc. It should be noted that it is also possible to combine the position detection light-receiving element 37p and the function control light-receiving element 37c by devising the control mode and transmission mode.

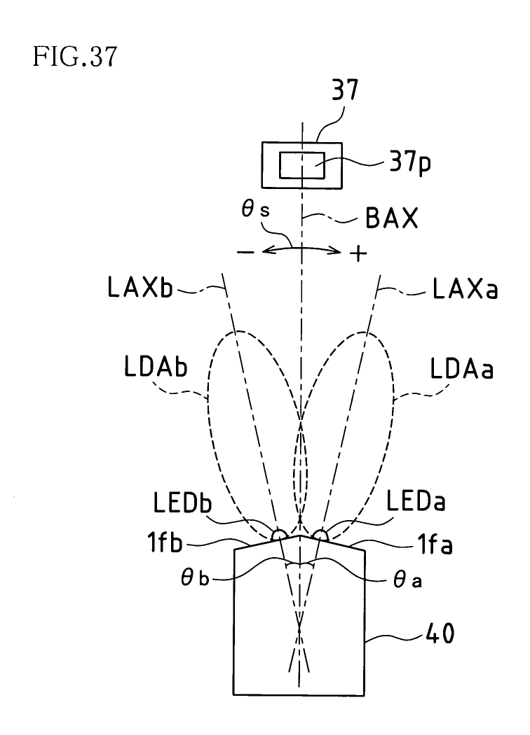

When the reference axis BAX (see FIG. 37) of the remote control transmitter 40 is moved from a remote control transmitter 40a indicated by the chain double-dashed line to a remote control transmitter 40b indicated by the solid line as shown by the movement trajectory 1c, the position detection light signal LSp that is received as input by the position detection light-receiving element 37p tracks the movement and changes accordingly. By detecting the position detection light signal LSp as a light-reception signal, the light-reception detection unit 37 is capable of conducting arithmetic processing to detect (output) change in the light-reception signal as a position signal.

Accordingly, the display position of the pointer 4 can be controlled to move in response to the detected position signal. It should be noted that an X-axis (horizontal direction movement) and a Y-axis (vertical direction movement) intersecting the X-axis are shown detection references for detecting movement of the reference axis BAX of the remote control transmitter 40.

The function control light signal LSc is emitted as output (transmitted) in response to a function control signal for controlling the display function of the monitor 34. The function control signal includes signals such as a channel selection signal, a volume adjustment signal, a brightness adjustment signal, and an on/off control signal for turning on and off buttons on the monitor screen using the pointer 4. The light-reception detection unit 37 detects (outputs) the function control light signal LSc received by the function control light-receiving element 3c as a function control signal and controls the function of the monitor 34 in response to the detected function control signal.

In the present method, by performing arithmetic processing on the light-reception signal that corresponds to the position detection light signal LSp that controls the position of the pointer 4 to detect the movement direction of the reference axis BAX of the remote control transmitter 40 in addition to the function control light signal LSc that is ordinarily used, it is possible to achieve synchronization to the movement direction of the reference axis BAX and to move with ease the pointer 4 on the monitor screen to a desired position. Accordingly, it is possible to achieve high-speed and smooth movement control of the position of the pointer 4 compared to conventional remote control device that uses button operations.

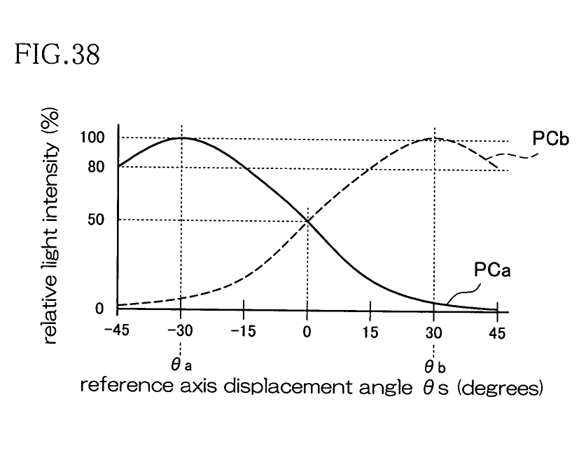

FIGS. 37 and 38 are principle explanatory diagrams for describing the operational principles of the present method. FIG. 37 is a diagram conceptually illustrating the remote control transmitter 40 and the light-reception detection unit (position detection light-receiving element) 37, and FIG. 38 is a graph showing correlation between the relative light intensity of the position detection light signal (light-reception signal) detected by the position detection light-receiving element and the reference axis displacement angle as a relative light intensity to reference axis displacement angle characteristic. In FIG. 38, the horizontal axis denotes the reference axis displacement angle θs (degrees) and the vertical axis denotes relative light intensity (%). Identical symbols are attached to portions identical to FIG. 36 and description thereof is omitted as appropriate.

A first light-emitting element LEDa and a second light-emitting element LEDb that emit as output the position detection light signal LSp are mounted on a surface opposing the light-reception detection unit 37 of the remote control transmitter 40.

The first light-emitting element LEDa is arranged on a first surface 1fa that is formed corresponding to the first direction (rightward in FIG. 38) intersecting with the reference axis BAX of the remote control transmitter 40. A light axis LAXa of the first light-emitting element LEDa is mounted so as to have an inclination angle θa not greater than a half value angle of the first light-emitting element LEDa to the reference axis BAX in the first direction. It should be noted that a half value angle indicates the directivity of the light-emitting intensity of the light-emitting element and is an angle at which the light intensity becomes half the maximum value in the light intensity distribution characteristics. The directivity of the first light-emitting element LEDa is indicated by the light intensity distribution characteristic LDAa.

The second light-emitting element LEDb is arranged on a second surface 1fb that is formed corresponding to the second direction (leftward in drawing) intersecting with the reference axis BAX of the remote control transmitter 40. A light axis LAXb of the second light-emitting element LEDb is mounted so as to have an inclination angle θb not greater than a half value angle of the second light-emitting element LEDb to the reference axis BAX in the second direction. The directivity of the second light-emitting element LEDb is indicated by the light intensity distribution characteristic LDAb.

In this way, by configuring the first direction and the second direction to intersect suitably and using a structure in which the light axis LAXa and the light axis LAXb are shifted, it is possible to separate and detect the position detection light signal LSp from the first light-emitting element LEDa and the position detection light signal LSp from the second light-emitting element LEDb. It should be noted that the half value angle (that is, the inclination angle) of the first light-emitting element LEDa and the second light-emitting element LEDb may be different.

By configuring the first light-emitting element LEDa and the second light-emitting element LEDb with light-emitting elements (for example, semiconductor light-emitting diodes: LED) that have different light emission wavelengths, it is easier to detect the light-reception signal corresponding to the position detection light signal LSp of the light-reception detection unit 37 (position detection light-receiving element 37p). Accordingly, it is possible to further improve detection accuracy and enable the position signals to be obtained with excellent precision. For example, one light-emitting element can be set having a light emission wavelength in the infrared light region and the other light-emitting element can be set having a light emission wavelength in the visible light region.

It should be noted that when the light emission wavelengths of the first light-emitting element LEDa and the second light-emitting element LEDb are set the same, detection can be achieved without loss of precision in detecting the position detection light signal LSp by devising the light-emitting elements to have shifted light emission cycles for example.

If the reference axis displacement angle θs is displaced to the plus direction in FIG. 37, then the position detection light signal LSp from the second light-emitting element LEDb becomes larger, and if the reference axis displacement angle θs is displaced to the minus direction in FIG. 37, then the position detection light signal LSp from the first light-emitting element LEDa becomes larger.

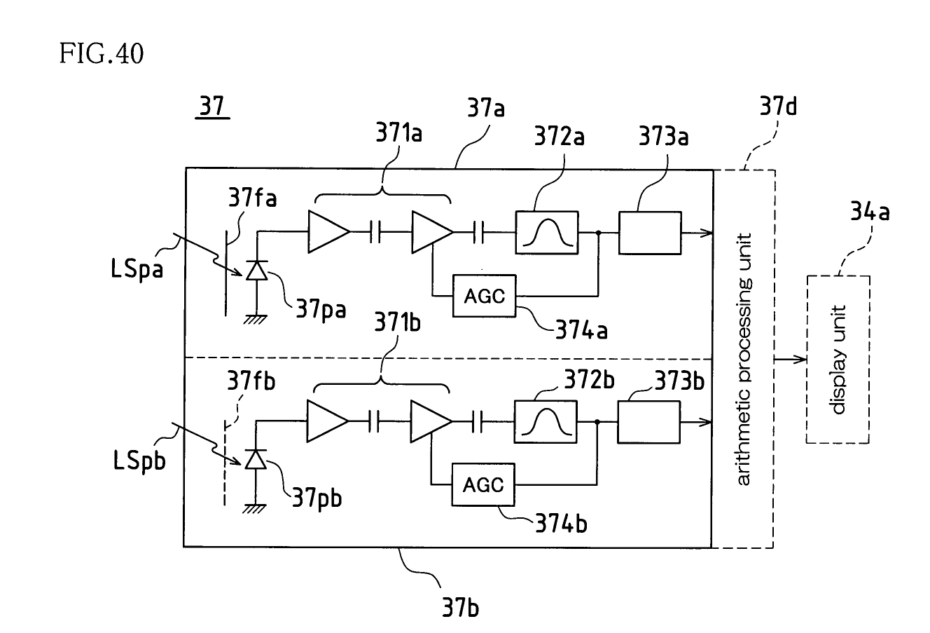

That is to say, by obtaining a relative light intensity PCa from the light-reception signal of a position detection light-receiving element 37pa (see FIG. 40) that receives as input a position detection light signal LSp (LSpa: see FIG. 40) from the first light-emitting element LEDa, obtaining relative light intensity PCb from the light-reception signal of a position detection light-receiving element 37pb (see FIG. 40) that receives as input a position detection light signal LSp (LSpb: see FIG. 40) from the second light-emitting element LEDb, and comparing a magnitude relationship between the relative light intensity PCa and the relative light intensity PCb, it is possible to find the displacement of the reference axis BAX (reference axis displacement angle θs) and therefore remote control can be achieved by outputting that displacement as a position signal (indication signal).

It should be noted that the light-reception signal is obtainable as an electric signal and therefore the relative light intensity PCa and the relative light intensity PCb can be detected in fact as the magnitude of the electric signal. That is, the position signals are obtained by comparing the sizes of the light-reception signals (output levels).

In FIG. 38, when the reference axis displacement angle θs is “0,” that is, when there is a condition as shown in FIG. 37, the relative light intensity PCa from the first light-emitting element LEDa and the relative light intensity PCb from the second light-emitting element LEDb, which are detected by the position detection light-receiving element 37p, are substantially equivalent. It should be noted that the numerical values in FIG. 38 are shown as examples.

When the reference axis displacement angle θs is set to the plus direction, that is, when the remote control transmitter 40 is shifted rightward in FIG. 37, the relative light intensity PCa detected by the position detection light-receiving element 37pa gradually decreases and the relative light intensity PCb detected by the position detection light-receiving element 37pb gradually increases. Moreover, when the reference axis displacement angle θs becomes equivalent to the inclination angle θb of the second light-emitting element LEDb, the second light-emitting element LEDb comes in front of the position detection light-receiving element 37p (37pb), and therefore the relative light intensity PCb becomes the maximum in accordance with the light intensity distribution characteristic LDAb.

When the reference axis displacement angle θs is set to the minus direction, that is, when the remote control transmitter 40 is shifted leftward in FIG. 37, the relative light intensity PCa detected by the position detection light-receiving element 37pa gradually increases and the relative light intensity PCb detected by the position detection light-receiving element 37pb gradually decreases. Moreover, when the reference axis displacement angle θs becomes equivalent to the inclination angle θa of the first light-emitting element LEDa, the first light-emitting element LEDa comes in front of the position detection light-receiving element 37p (37pa), and therefore the relative light intensity PCa becomes the maximum in accordance with the light intensity distribution characteristic LDAa.

By performing comparison calculations on the magnitude relationship between the relative light intensities PCa and PCb, the indication direction (movement direction and position signal) of the reference axis BAX can be found, and therefore it is possible to control the movement of the pointer 4 being displayed on the display unit 34a using this indication direction (change in the indication direction). It should be noted that the disparity between the relative light intensities PCa and PCb can be such that the disparity is detectable. If the disparity is in a predetermined range, then appropriate correction can be performed by arithmetic processing. That is, it is preferable that the light intensity distribution characteristic LDAa and the light intensity distribution characteristic LDAb are equivalent, but there is no limitation to this. Furthermore, it is preferable that the half value angle θa and the half value angle θb are equivalent, but there is no limitation to this.

It should be noted that only one position detection light-receiving element 37p is shown in FIG. 37, but as described above, by providing the position detection light-receiving element 37pa made to correspond to the first light-emitting element LEDa and the position detection light-receiving element 37pb made to correspond to the second light-emitting element LEDb, it becomes easy to separate and detect separately the relative light intensity PCa and the relative light intensity PCb.

In the principle explanatory diagrams of FIGS. 37 and 38, examples were shown in which position detection was possible in the leftward and rightward directions for example. By combining detection and control of upward and downward directions in addition to the leftward and rightward directions, it is possible to control the position of the pointer 4 on an X-axis and a Y-axis plane (a two-dimensional display screen).

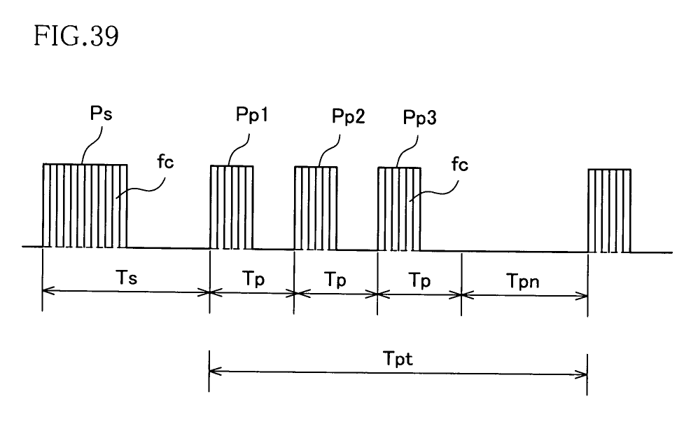

FIG. 39 is a waveform chart showing an example waveform of light emission pulse signals at the remote control transmitter 40 according to this embodiment.

The drive unit (not shown) of the remote control transmitter 40 respectively applies light emission pulse signals to the first light-emitting element LEDa and the second light-emitting element LEDb. In response to the light emission pulse signals, the first light-emitting element LEDa and the second light-emitting element LEDb emit as output position detection light signals LSp of different light emission wavelengths for transmission to the light-reception detection unit 37 (position detection light-receiving element 37p).

The light emission pulse signals are constituted by position detection pulses Pp1, Pp2, and Pp3, and a detection start pulse Ps that is produced before the position detection pulse Pp1. By repetitively producing a plurality of position detection pulses Pp1, Pp2, and Pp3 having the same pulse width and cycle, a consistent position detection light signal LSp can be emitted as output, and therefore it is possible to achieve exact position detection.

Furthermore, ordinarily used modulation carrier waves fc of approximately 10 kHz to 40 kHz are superimposed on the position detection pulses Pp1, Pp2, and Pp3, and the detection start pulse Ps. By superimposing the modulation carrier waves fc, detection errors due to scattering light (noise) can be prevented.

The position detection pulses Pp1, Pp2, and Pp3 have position detection pulse single cycles Tp, which are of respectively equivalent cycles. Furthermore, the position detection pulses Pp1, Pp2, and Pp3 have a position detection pulse group cycle (sensing cycle) Tpt that includes these three pulses in entirety. The position detection pulse single cycles Tp are approximately 1 ms (millisecond) for example, and the periods in which the position detection pulses Pp1, Pp2, and Pp3 are produced (a period in which the position detection pulse single cycles Tp are on) are set to half (approximately 0.5 ms) of the position detection pulse single cycles Tp. A signal-less period Tpn is provided corresponding to two pulses after the three pulses (Pp1, Pp2, and Pp3) are produced, and therefore the position detection pulse group cycle (sensing cycle) Tpt is approximately 5 ms.

The detection start pulse Ps of the detection start pulse cycle Ts is produced before the position detection pulse group cycle (sensing cycle) Tpt. The detection start pulse cycle Ts is set to 2 ms for example. The period in which the detection start pulse Ps is produced (a period in which the detection start pulse cycle Ts is on) is set to half of the detection start pulse cycle Ts (approximately 1 ms). A detection operation of the position detection light signal LSp at the light-reception detection unit 37 can be started by the detection start pulse Ps, so that controllability of the detection function can be increased.

Pulses of the above-mentioned cycles are also used in ordinary remote controllers (remote control devices that produce a function control signal) and therefore no special item is required in terms of circuitry or components, such that construction can be achieved easily. Furthermore, position signals are sent and received optically using electric circuitry, and therefore the pointer 4 can be moved smoothly and speedily compared to position control based on mechanical remote control.

FIG. 40 is a block diagram showing a circuit configuration of the light-reception detection unit 37.

The light-reception detection unit 37 detects the light intensity (amplitude value) of the position detection light signal LSp, which is received as input, using a first light-receiving circuit 37a and a second light-receiving circuit 37b, and a position signal is obtained by performing arithmetic processing on the detected light intensities by an arithmetic processing unit 37d, with this position signal being outputted to perform movement control of the position of the pointer 4 displayed on the display unit 34a.

It should be noted that the light emission wavelengths of the first light-emitting element LEDa and the second light-emitting element LEDb are different, and therefore differentiation is made appropriately by referring to the light emission output from the first light-emitting element LEDa as a position detection light signal LSpa and the second light-emitting element LEDb as a position detection light signal LSpb.

The first light-receiving circuit 37a is constituted by an optical filter 37fa having a wavelength selection characteristic by which the position detection light signal LSpa that is emitted as output from the first light-emitting element LEDa is selected, a position detection light-receiving element 37pa that receives the position detection light signal LSpa that has passed through the optical filter 37fa and detects a light-reception signal (a light-reception pulse signal corresponding to the light emission pulse signal; hereinafter simply referred to as “light-reception signal” when it is not necessary to specify “light-reception ‘pulse’ signal”), an amplifier circuit 371a for amplifying the light-reception signal detected by the position detection light-receiving element 37pa, a band-pass filter 372a that reduces noise by allowing only a predetermined frequency to pass from the light-reception signal amplified by the amplifier circuit 371a, an amplitude value detection circuit 373a for detecting an amplitude value (light intensity, relative light intensity, output level) of the light-reception signal that has been outputted from the band-pass filter 372a, and an automatic gain control circuit (AGC) 374a that regulates the amplification factor of the amplifier circuit 371a.

The second light-receiving circuit 37b is constituted by an optical filter 37fb having a wavelength selection characteristic by which the position detection light signal LSpb that is emitted as output from the second light-emitting element LEDb is selected, a position detection light-receiving element 37pb that receives the position detection light signal LSpb that has passed through the optical filter 37fb and detects a light-reception signal (a light-reception pulse signal), an amplifier circuit 371b for amplifying the light-reception signal detected by the position detection light-receiving element 37pb, a band-pass filter 372b that reduces noise by allowing only a predetermined frequency to pass from the light-reception signal amplified by the amplifier circuit 371b, an amplitude value detection circuit 373b for detecting an amplitude value (light intensity, relative light intensity, output level) of the light-reception signal that has been outputted from the band-pass filter 372b, and an automatic gain control circuit (AGC) 374b that regulates the amplification factor of the amplifier circuit 371b.

The position detection light-receiving element 37pa and the position detection light-receiving element 37pb can be configured as photodiodes or phototransistors for example. Since the optical filter 37fa and the optical filter 37fb are used, elements of the same specification can be used. It should be noted that it is also possible to provide a wavelength selection characteristic to the position detection light-receiving element 37pa and the position detection light-receiving element 37pb themselves without using the optical filter 37fa and the optical filter 37fb.

Since the optical filter 37fa and the optical filter 37fb have wavelength selection characteristics, a position detection light signal LSp of the infrared light region and a position detection light signal LSp of the visible light region can be reliably separated and detected as separate data (light-reception signals and light-reception pulse signals). For example, a configuration is possible in which if the light emission wavelength region of the first light-emitting element LEDa is the infrared light region, then the optical filter 37fa is set to have a wavelength selection characteristic that allows wavelengths in the infrared light region to pass, thereby detecting the position detection light signal LSpa of the infrared light region, and if the light emission wavelength region of the second light-emitting element LEDb is the visible light region, then the optical filter 37fb is set to have a wavelength selection characteristic that allows wavelengths in the visible light region to pass, thereby detecting the position detection light signal LSpb of the visible light region.

The automatic gain control circuits 374a and 374b detect the maximum value of the amplitude values of light-reception signals outputted from the band-pass filters 372a and 372b, and regulate the amplification factor so that (the maximum values of) the amplitude values of the light-reception signals do not saturate in the amplifier circuits 371a and 371b. Since (the maximum values of) the amplitude values do not saturate, it is possible to obtain a light-reception signal (light-reception signal level) that has high detection accuracy, and high stability and reliability.

In particular, regulation of the amplification factor can be performed speedily by detecting (the maximum value of) the amplitude values of the light-reception pulse signals detected in response to the detection start pulse Ps of the detection start pulse cycle Ts to carry out regulation of the amplification factor. Furthermore, regulation can be achieved by producing a separate amplification factor regulation pulse signal (not shown), emitting as output a corresponding light emission pulse signal, and detecting the amplitude values of the corresponding light-reception pulse signals.

The position signals are obtained by the arithmetic processing unit 37d appropriately performing arithmetic processing on the amplitude values (light intensities) of the light-reception signals detected respectively by the amplitude value detection circuits 373a and 373b, and the position of the pointer 4 can be controlled by outputting these as position signals (position control signals) from the arithmetic processing unit 37d to the display unit 34a. The arithmetic processing unit 37d can be configured using a CPU or the like that is ordinarily used.

The arithmetic processing in the arithmetic processing unit 37d can be arithmetic in which a difference between the amplitude value of the light-reception signal obtained by the first light-receiving circuit 37a and the amplitude value of the light-reception signal obtained by the second light-receiving circuit 37b is obtained, arithmetic in which a ratio of these amplitude values is obtained, or arithmetic of a combination of obtaining the difference between and the ratio of these amplitude values.

The light-reception detection unit 37 is further provided with a third light-receiving circuit (not shown) for receiving as input the function control light signal that is emitted as output from the third light-emitting element LEDc corresponding to the function control signal that controls the functions of the monitor 34 (display unit 34a). The third light-receiving circuit outputs the function control light signal, which is received as input, as a function control signal using commonly known signal transformation, and the functions of the monitor 34 (display unit 34a) are controlled using the arithmetic processing unit 37d or the like. The third light-receiving circuit can receive the function control light signal using the function control light-receiving element 37c (see FIG. 36).

(2) Method that uses PSD (Position Sensitive Detector)

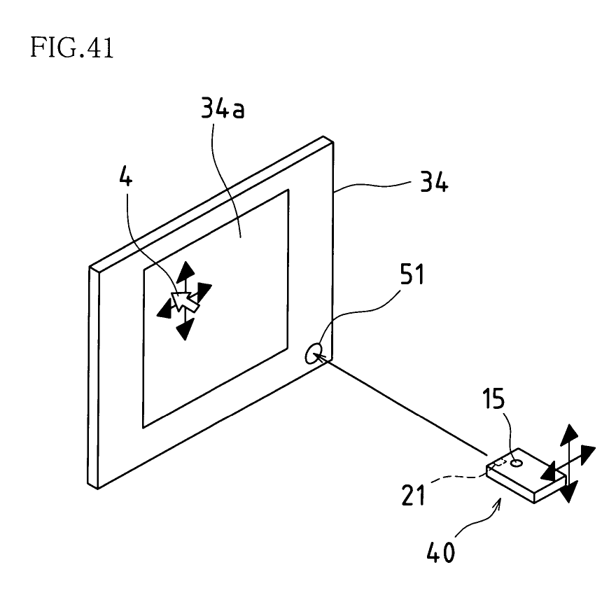

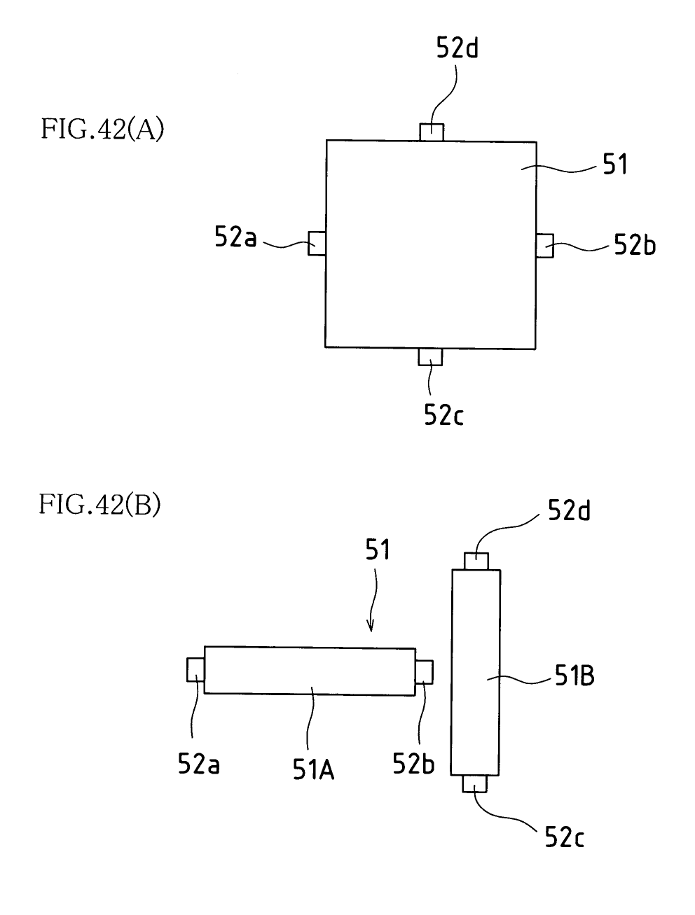

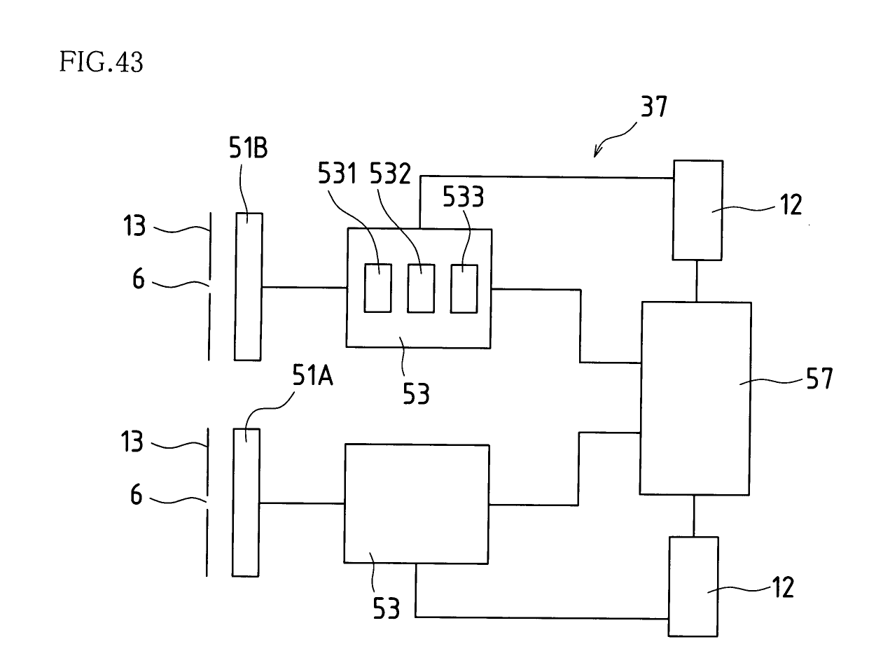

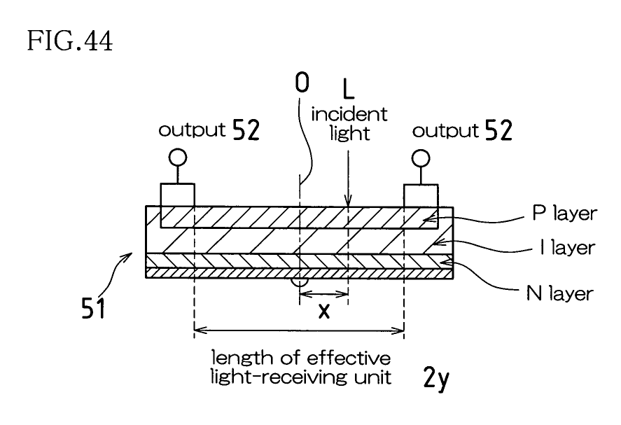

FIG. 41 is an explanatory diagram showing the remote control transmitter 40 and the monitor 34 for describing the present method. FIG. 42(A) is a front view of a PSD, and FIG. 42(B) is a front view of the PSD as viewed from a different direction. FIG. 43 is a block diagram showing a light-receiving unit side, and FIG. 44 is a cross-sectional view illustrating the detection principles of the PSD.

The remote control transmitter 40 shown in FIG. 41 is a pointing device 1 serving as an optical operation device provided with a light-emitting element 21 that emits infrared light for example, and the monitor 34 is provided with a PSD 51 as a light-receiving element.

As shown in FIG. 44, the PSD 51 is a component in which a P layer is formed on the surface of a flat plate of silicon, with an N layer on the back surface, and an I layer in between. When a spot of light L is incident, an electric charge is produced proportional to the light energy at the position of incidence, such that the produced electric charge passes as a photocurrent through a resistive layer (the P layer) and is divided and outputted from electrodes 52a and 52b provided at ends of the PSD 51 as electric currents Ia and Ib.

Since the P layer is configured such that it has an equal resistance value throughout the layer, the electric currents Ia and Ib are divided and outputted as proportions inversely proportional to the distances from the position of incidence to the electrodes 52a and 52b, that is, to the resistance values. Here, when the distance (length of effective light-receiving unit) between the electrodes 52a and 52b is given as 2y and a distance from a center O of the PSD 51 to the position in which the light L is incident is given as x, the following relational expression is established.
(Ib−Ia)/(Ia+Ib)=x/y (1)

Accordingly, by obtaining the difference and sum of the electric currents Ia and Ib, the incidence position x of incident light L can be obtained from expression (1).

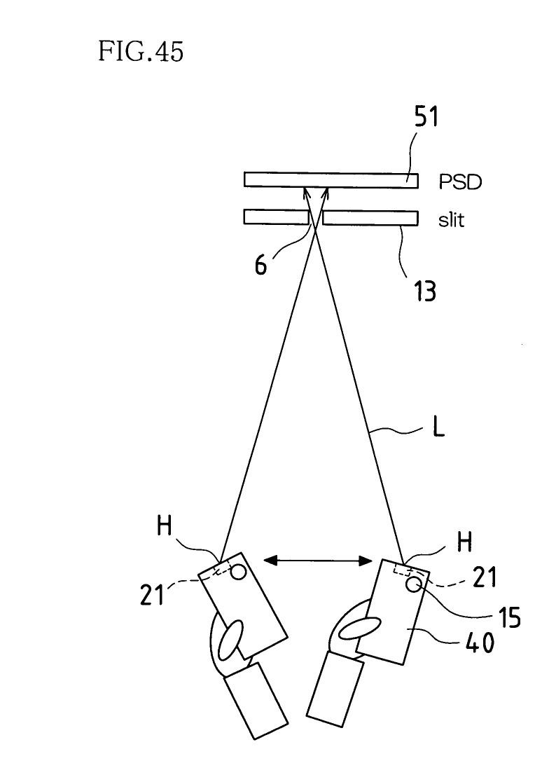

As shown in FIG. 45, a screening wall 13 having a slit 6 is provided in front of the PSD 51. By providing the screening wall 13 in front of the PSD 51, the light L that passes through the slit 6 becomes a spot whose direction is defined. When a light emission point H of a light-emitting element moves, the light-reception position on the PSD 51 of the light L that has passed through the slit 6 also changes. Accordingly, if the change in the light-reception position on the PSD 51 is detected, then the change in the position of the light emission point H can also be detected. It should be noted that it is also possible to use a lens instead of the screening wall 13 that is provided with the slit 6.

Two-dimensional movement of the light emission point H can be detected by preparing a PSD 51 with two axes of a horizontal direction and a vertical direction of a plane parallel to the display portion 34a of the monitor 34. If the light emission point H is caused to move such that movements of the light-reception position are reflected on the movements of the pointer 4 as a mark displayed on the display portion 34a of the monitor 34, then the pointer 4 on the display portion 34a can be moved in a desired direction. As shown in FIG. 42(A) for example, the PSD 51 is a component in which horizontal direction electrodes 52a and 52b and vertical direction electrodes 52c and 52d are arranged on the rectangular two-dimensional PSD 51. Moreover, as shown in FIG. 42(B), the PSD 51 is configured such that a band-shaped PSD 51A disposed in a horizontal direction and a band-shaped PSD 51B disposed in a vertical direction are arranged at a right angle.

Next, an example of a light-reception detection unit 37 disposed on the monitor 34 side is described with reference to the block diagram shown in FIG. 43. For convenience, the PSD 51 in FIG. 43 is shown divided into a PSD 51A and a PSD 51B, but this is inclusive of the single PSD shown in FIG. 42(A).

The light-reception detection unit 37 is provided with the PSDs 51A and 51B, processing circuits 53, and a control device 57. The processing circuits 53 are constituted by electronic devices in which an amplifier 531, a limiter 532 and a band-pass filter 533 are integrated on a semiconductor chip. The light L that passes through the slits 6 of the screening walls 13 to become incident on the respective PSDs 51A and 51B undergoes photoelectric conversion and is divided and output as electric currents Ia, Ib, Ic, and Id from the electrodes 52a, 52b, 52c and 52d arranged at the ends of the PSDs 51A and 51B. The output electric currents are respectively amplified by the amplifiers 531, undergo waveform shaping at the limiters 532, are outputted by the band-pass filters 533 as control signals of only a predetermined frequency, and the control signals are transmitted to the control device 57.

By performing signal processing at the processing circuits 53 in this way, it is possible to process at the PSDs 51 installed on the monitor 34 side both signals, namely the pointer movement signal as well as the ordinary remote controller code signals (for example, in the case of controlling a television receiver, this includes control signals such as power on/off, volume up/down, and channel change signals).

A movement button 15 is provided as a mode changing means at the remote control transmitter 40. Although even existing remote controllers are sufficient in terms of speed of response for ordinary remote controller operations such as selecting channels and adjusting the audio volume, remote controller codes cannot achieve an intuitive sense of operation for the movement of the pointer 4. For this reason, when moving the pointer 4, the movement button 15 is pressed and simultaneous to this a pointer movement signal having a faster modulation than the code signals of the remote controller is sent from the light-emitting element 21. By doing this, transmission times such as that for the remote controller codes can be made unnecessary, and movements of the remote control transmitter 40 can be reflected directly on the movement of the pointer 4.

Furthermore, the light-reception detection unit 37 is provided with a distance detection means 12 (see FIG. 43) that detects a distance between the monitor 34 side and the remote control transmitter 40 side (between the light-emitting element and the light-receiving element). Specifically, since the slit 6 of the screening wall 13 disposed in front of the PSD 51 defines the direction of the incident light L, when the light emission point H moves, the light-reception position on the PSD 51 of light that has passed through the slit also moves (see FIG. 45). Accordingly, if the change in the light-reception position on the PSD 51 is detected, then the change in the position of the light emission point H can also be detected. Movement of the light emission point H is detected by the PSD 51, and there is a similarity relationship between a triangle formed by the movement range of the light emission point H and the position of the slit and a triangle formed by the light-reception range on the PSD 51 and the position of the slit.

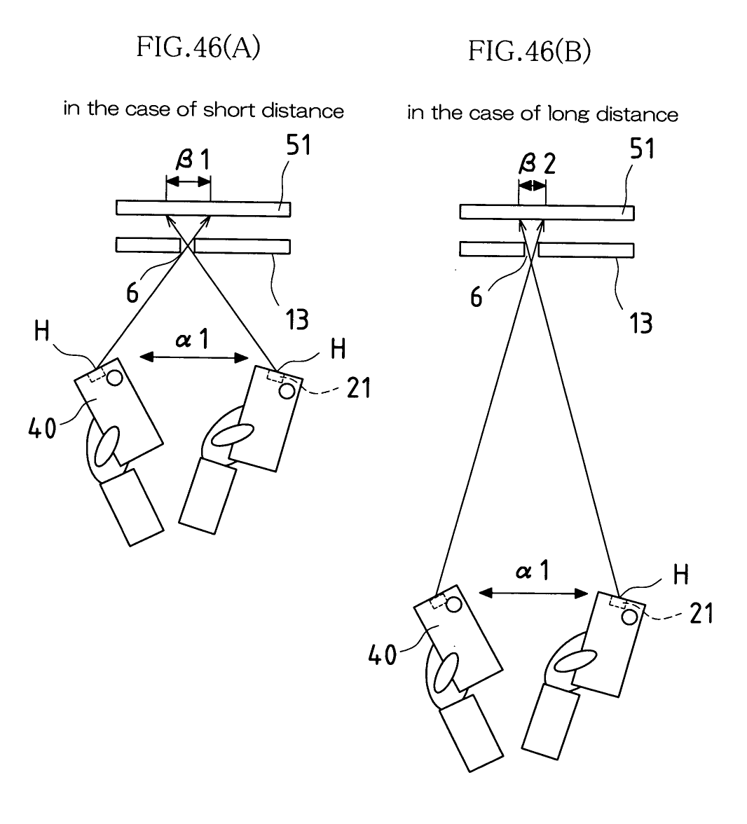

Accordingly, given equivalent movement amounts a of the light emission point H, when the light emission point H and the position of the slit 6 (=screen position) are close, then a movement range P1 of the light-reception position on the PSD 51 becomes larger (see FIG. 46(A)), and conversely, when the light emission point H and the position of the slit 6 are distant, a movement range 02 of the light-reception position on the PSD 51 becomes smaller (see FIG. 46(B)). Ordinarily, the pointer 4 on the screen would be moved by an amount proportional to the movement amount of the light-reception position on the PSD 51, and therefore if this circumstance remains unchanged, the movement amounts of the light emission point H required for moving the pointer 4 on the display unit 34a by the same distance would end up varying for different distances between the display unit 34a and the light emission point H. Moreover, even when the movement amounts of the light emission point H were the same, the movement amount of the pointer 4 would end up being different due to the distances to the display unit 34a.

Such a behavior can in no way be said to be providing good usability. To solve this issue, it is necessary to detect the distance between the PSD 51 (display unit 34a) and the light emission point H, then correct and adjust the pointer movement amount based on that distance. For example, when the moveable distance of the light emission point H with respect to the PSD 51 is 0.5 m to 5 m, the resolution of the PSD 51 when the distance is 5 m is the minimum resolution, which is 1/10th of the resolution of the PSD when the distance is 0.5 m. Accordingly, when the distance is 0.5 m, the pointer 4 can move by a single unit when the light-reception position moves ten times the minimum resolution on the PSD.

As described above, the output of the PSD 51 is electric currents flowing into two electrodes, and in general, in order to detect the movement amount of the light emission point H at the PSD 51, the difference between the output electric currents is subtracted from the sum of the output electric currents such that there is no dependence on the total amount of received light. In the present method, the distance detection means 12 is provided to detect the distance between the light emission point H and the PSD 51 using the fact that the sum of the output electric current becomes small when the distance between the PSD 51 and the light emission point H is far and the sum of the output electric current becomes large when the distance is close. The distance detection means 12 detects the distance based on a sum value of the output electric current. The distance information thereof is transmitted to the control device 57 and based on the distance information that has been transmitted, the control device 57 corrects and adjusts the movement amount so that the pointer 4 moves by a predetermined amount corresponding to the movement amount of the light emission point H regardless of the distance between the light emission point H and the display unit 34a (even when the remote control transmitter 40 is arbitrarily distant from the monitor 34).

(3) Method that Lights an LED in Varied Directions, and Performs Detection Based on the Ratio of the Amounts of Light Received

Since the explanatory diagram for describing the present method is the same as the explanatory diagram shown in FIG. 36, which was used for the above-described method (1), the description of the contents of the explanatory diagram shown in FIG. 36 is omitted here.

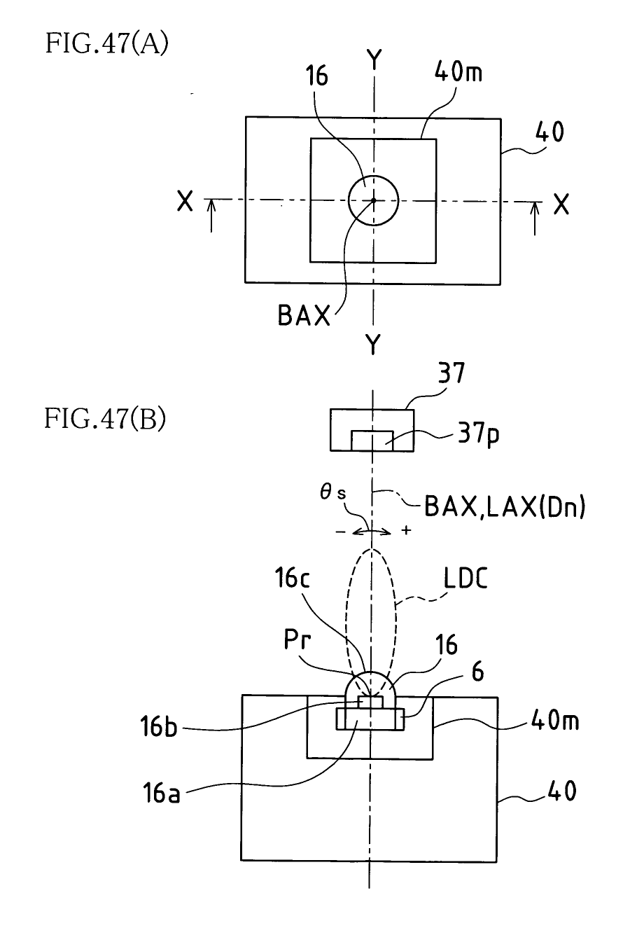

FIGS. 47(A) to 51(B) are explanatory diagrams for describing displacement positions of a remote control transmitter 40 (position detection light-emitting element) according to the present method.

FIGS. 47(A) and 47(B) are explanatory diagrams for describing a case where the reference axis BAX of the remote control transmitter 40 and the light axis LAX of the position detection light-emitting element 16 coincide (the light axis of the light-emitting element 16 is located at a neutral point position Dn). FIG. 47(A) is a front view showing a relevant part of the remote control transmitter 40 as viewed from the light-reception detection unit 37 (light-receiving element 37p) side (that is, as viewed from the front), and FIG. 47(B) is a side perspective view showing the relevant part taken along the arrows X-X in FIG. 47(A). It should be noted that in FIG. 47(B) the light-reception detection unit 37 (position detection light-receiving element 37p) is depicted for reference.

Ordinarily, the reference axis BAX of the remote control transmitter 40 is directed from the remote control transmitter 40 (the center of the light-emitting element 16) to the light-reception detection unit 37 (position detection light-receiving element 37p). When controlling the position of the pointer 4, a position detection light signal LSp is emitted as output from the light-emitting element 16, with the reference axis BAX being appropriately displaced by a reference axis displacement angle θs laterally and vertically with respect to the center of the position detection light-receiving element 37p in accordance with the control (movement direction, amount of movement) of the pointer 4 that is to be moved. It should be noted that the reference axis BAX is a virtual line (indication direction) constituted by the remote control transmitter 40 (light-emitting element 16) when the remote control transmitter 40 is placed directly facing+ the light-reception detection unit 37.

Since the position detection light signal LSp (that is, the light-reception signal) received as input by the position detection light-receiving element 37p changes according to the displacement (reference axis displacement angle θs) of the reference axis BAX, movement control of the pointer 4 is performed by detecting the light-reception signal received as input by the position detection light-receiving element 37p, and performing appropriate arithmetic processing to obtain a position signal (position control signal).

The light-emitting element 16 is disposed at a central mechanical unit 40m on the front surface (the surface opposing the light-reception detection unit 37) of the remote control transmitter 40. The light-emitting element 16 is made up of, for example, a light-emitting diode (LED) chip 16b placed on a substrate portion 16a and a resin lens portion 16c in the shape of a convex lens covering its surface. A light axis control unit 6 that controls the light axis direction of the light-emitting element 16 is provided connected to the substrate portion 16a of the light-emitting element 16.

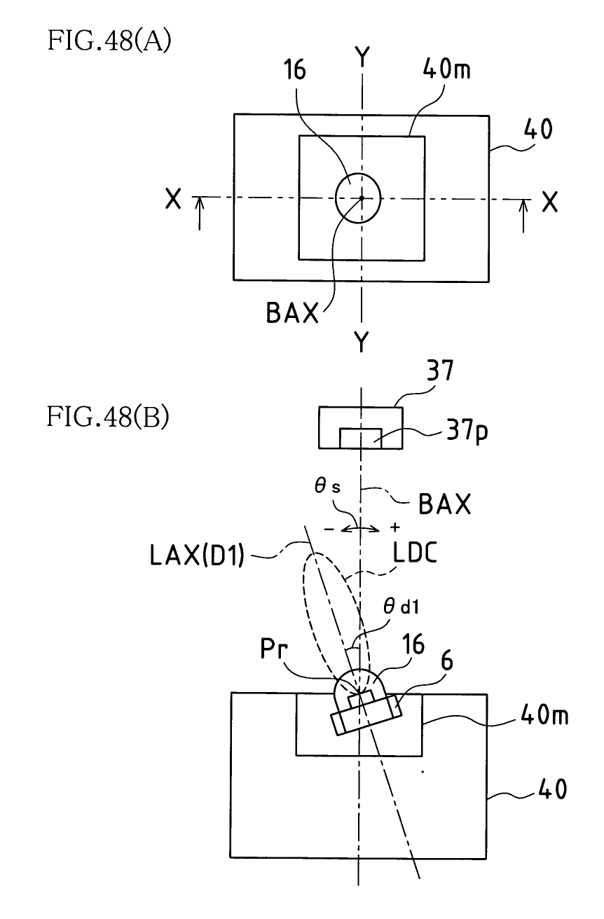

The light axis control unit 6 is formed, for example, by combining a gear, an annular rail or other suitable mechanical components such that it can mechanically control the displacement direction (displacement position) of the light axis LAX of the light-emitting element 16 with a displacement center Pr as center (examples of control are shown in FIGS. 48(A) to 51(B)). When a rotating member such as an annular rail is used, the light axis LAX can be displaced into the shape of a reversed cone having the reference axis BAX as its center. When a mechanical component like a rotating member is used, the displacement position of the light axis LAX can be controlled relatively easily. It is also possible to use a reflector (omitted in the drawing) that rotates (inclines) around the reference axis BAX (displacement center Pr) to displace the light axis LAX.

The light-emitting element 16 has a light emission intensity distribution characteristic LDC. The light intensity and the directivity of the light-emitting element 16 can be appropriately selected according to the state of the environment in which it is used (for example, the distance between the remote control transmitter 40 and the monitor 34).

Preferably, the light-emitting element 16 emits light as output with a light emission wavelength in the infrared light region. If the light-emitting element 16 has a light emission wavelength in the infrared light region, then it can eliminate the influence of scattering light (noise), thereby improving detection accuracy.

FIGS. 48(A) and 48(B) are explanatory diagrams showing a case where the light-emitting element 16 is displaced such that the light axis LAX of the light-emitting element 16 has an inclination angle θd1 with respect to the reference axis BAX of the remote control transmitter 40 in a leftward horizontal direction as viewed from the front (displacement position D1). FIG. 48(A) is a front view of the remote control transmitter 40 as viewed from the light-reception detection unit 37 (light-receiving element 37p) side (that is, as viewed from the front). FIG. 48(B) is a perspective view showing the relevant part taken along the arrows X-X (corresponding to a horizontal direction (first direction) of the remote control transmitter 40) in FIG. 48(A). It should be noted that the position detection light-receiving element 37p is depicted for reference. In addition, “displacement of the light-emitting element 16” is substantially synonymous with “displacement of the light axis LAX of the light-emitting element 16”.

The displacement position D1 (inclination angle θd1) can be realized by appropriately rotating the light-emitting element 16 around the displacement center Pr by the light axis control unit 6. In order to improve detection accuracy, the inclination angle θd1 is preferably not greater than a half value angle θh. It should be noted that a half value angle θh indicates the directivity of the light-emitting intensity of the light-emitting element and is an angle from the light axis at which the light intensity becomes half the maximum value in the light intensity distribution characteristics. That is, by setting the inclination angle θd1 to not greater than a half value angle θh, it is possible to obtain a position detection light signal LSp having good directivity. Accordingly, the light-reception detection unit 37 (position detection light-receiving element 37p) can reliably receive light as input and thus can detect the position detection light signal with high accuracy, thereby realizing highly accurate remote control.

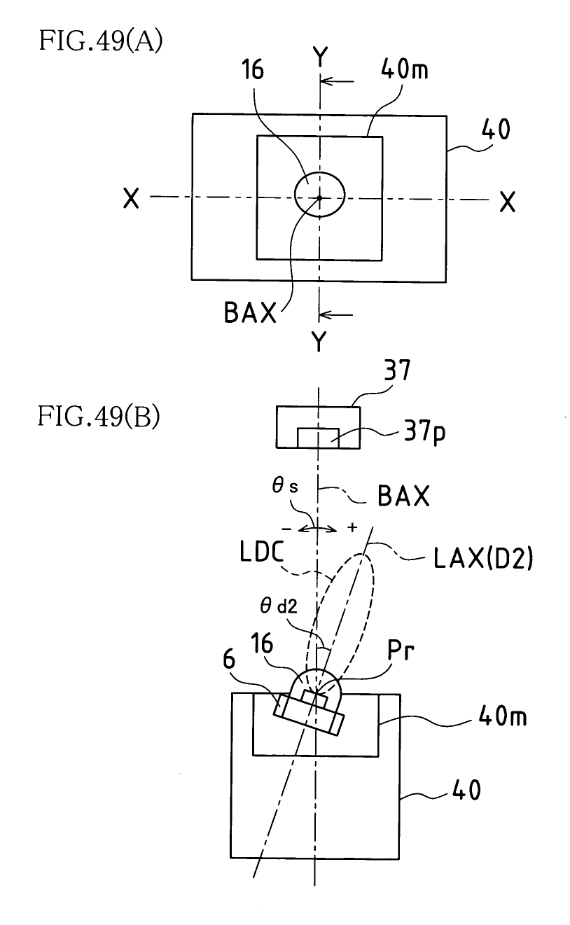

FIGS. 49(A) and 49(B) are explanatory diagrams showing a case where the light-emitting element 16 is displaced such that the light axis LAX of the light-emitting element 16 has an inclination angle θd2 with respect to the reference axis BAX of the remote control transmitter 40 in a upward vertical direction as viewed from the front (displacement position D2). FIG. 49(A) is a front view of the remote control transmitter 40 as viewed from the light-reception detection unit 37 (light-receiving element 37p) side (that is, as viewed from the front), and FIG. 49(B) is a perspective view showing the relevant part taken along the arrows Y-Y (corresponding to a vertical direction of the remote control transmitter 40 (a second direction vertically intersecting the first direction)) in FIG. 49(A). It should be noted that the position detection light-receiving element 37p is depicted for reference.

The displacement position D2 (inclination angle θd2) can be realized by appropriately rotating the light-emitting element 16 around the displacement center Pr by the light axis control unit 6. In order to improve detection accuracy, the inclination angle θd2 is preferably not greater than a half value angle θh.

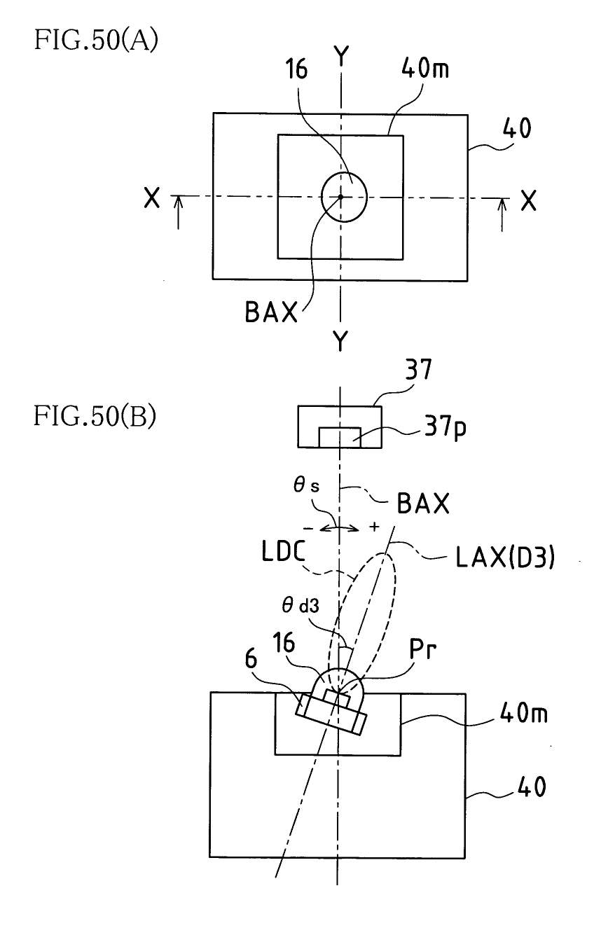

FIGS. 50(A) and 50(B) are explanatory diagrams showing a case where the light-emitting element 16 is displaced such that the light axis LAX of the light-emitting element 16 has an inclination angle θd3 with respect to the reference axis BAX of the remote control transmitter 40 in a rightward horizontal direction as viewed from the front (displacement position D3), FIG. 50(A) is a front view of the remote control transmitter 40 as viewed from the light-reception detection unit 37 (light-receiving element 37p) side (that is, as viewed from the front), and FIG. 50(B) is a perspective view showing the relevant part taken along the arrows X-X in FIG. 50(A). It should be noted that the position detection light-receiving element 37p is depicted for reference.

The displacement position D3 (inclination angle θd3) can be realized by appropriately rotating the light-emitting element 16 around the displacement center Pr by the light axis control unit 6. In order to improve detection accuracy, the inclination angle θd3 is preferably not greater than a half value angle θh. Additionally, in order to facilitate control of the light axis LAX and improve detection accuracy, the displacement position D3 is preferably disposed symmetrically to the displacement position D1 about the reference axis BAX.

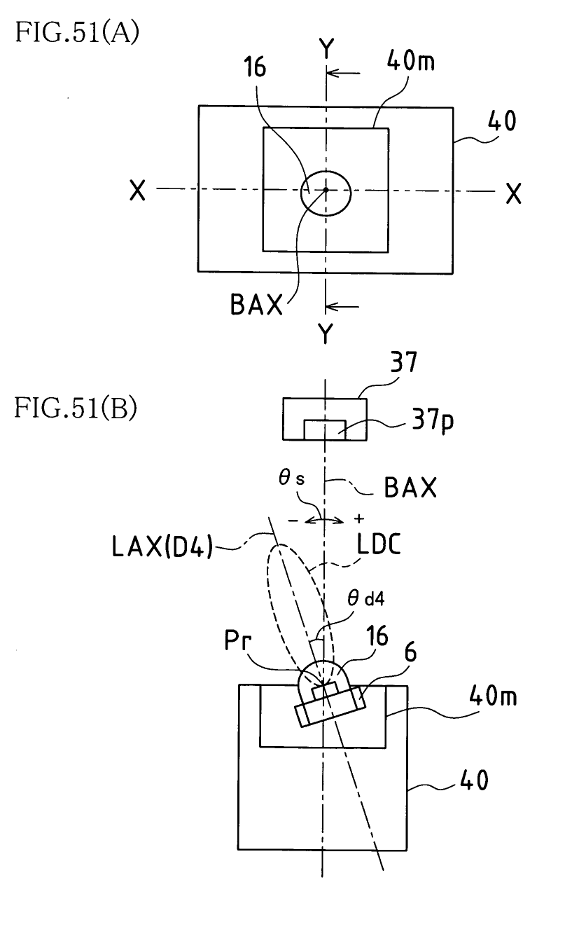

FIGS. 51(A) and 51(B) are explanatory diagrams showing a case where the light-emitting element is displaced such that the light axis LAX of the light-emitting element 16 has an inclination angle θd4 with respect to the reference axis BAX of the remote control transmitter 40 in a downward vertical direction as viewed from the front (displacement position D4), FIG. 51(A) is a front view of the remote control transmitter 40 as viewed from the light-reception detection unit 37 (light-receiving element 37p) side (that is, as viewed from the front), and FIG. 51(B) is a perspective view showing the relevant part taken along the arrows Y-Y in FIG. 51(A). It should be noted that the position detection light-receiving element 37p is depicted for reference.

The displacement position D4 (inclination angle θd4) can be realized by appropriately rotating the light-emitting element 16 around the displacement center Pr by the light axis control unit 6. In order to improve detection accuracy, the inclination angle θd4 is preferably not greater than a half value angle θh. Additionally, in order to facilitate control of the light axis LAX and improve detection accuracy, the displacement position D4 is preferably disposed symmetrically to the displacement position D2 about the reference axis BAX.

As shown in FIGS. 48(A) to 51(B), it is possible to perform two-dimensional position detection by providing four displacement positions, so that it is possible to perform position control reliably. Furthermore, in order to improve detection accuracy and simplify arithmetic processing, it is preferable to arrange the displacement positions D1 to D4 (inclination angles θd1 to θd4) such that they are symmetrical to each other with respect to the reference axis BAX. It should be noted that although four displacement positions were provided, there is no limitation to this. It is possible to further improve detection accuracy by increasing the number of displacement positions.

The control mechanism can be simplified by rotating the light axis LAX of the light-emitting element 16 to the displacement position D1, the displacement position D2, the displacement position D3 and the displacement position D4 in this order by the mechanical operation of the light axis control unit 6.

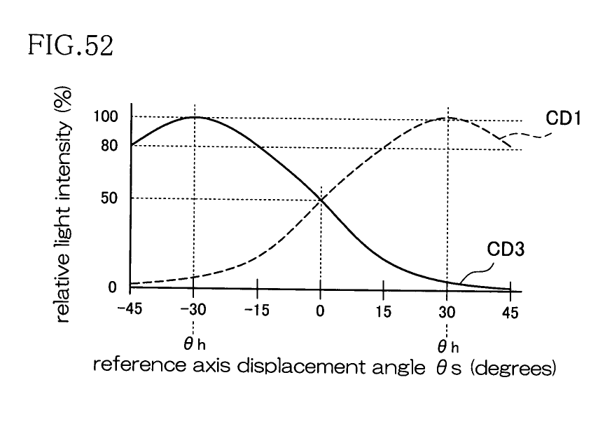

FIG. 52 is an explanatory diagram for describing the principles of detecting the reference axis displacement angle according to the present method and is a graph showing the correlation between the relative light intensity of the position detection light signal (light-reception signal) detected by the position detection light-receiving element and the reference axis displacement angle as a relative light intensity to reference axis displacement angle characteristic. In FIG. 52, the lateral axis denotes the reference axis displacement angle θs (degrees), and the longitudinal axis denotes the relative light intensity (%). For simplicity, the inclination angles θd1, θd2, θd3 and θd4 are set to be equal to the half value angle θh of the light-emitting element 5, and the half value angle θh is set to 30 degrees.

In a state in which the light axis LAX of the light-emitting element 16 is controlled (displaced) to the displacement position D1 by the light axis control unit 6 (see FIGS. 48(A) and 48(B)), the relative light intensity to reference axis displacement angle characteristic is a graph as indicated by the curve CD1.

That is, when the reference axis displacement angle θs is “0 degree”, the relative light intensity of the light-reception signal detected by the position detection light-receiving element 37p (the light reception amount for the position detection light signal LSp from the light-emitting element 16) is 50%. Further, when the reference axis displacement angle θs is displaced from “0 degree” in the “plus” direction, that is, when the remote control transmitter 40 is displaced in the plus direction, the light axis LAX approaches the frontal direction of the position detection light-receiving element 37p, so that the relative light intensity gradually increases. When the reference axis displacement angle θs is displaced towards “30 degrees” (half value angle θh), the light axis LAX coincides with the frontal direction of the position detection light-receiving element 37p, so that the relative light intensity assumes the maximum value (100%). Furthermore, when the reference axis displacement angle θs is displaced from “0 degree” in the “minus” direction, that is, when the remote control transmitter 40 is displaced in the minus direction, the light axis LAX is moved away from the frontal direction of the position detection light-receiving element 37p even further, so that the relative light intensity gradually decreases and attenuates.

Furthermore, in a state in which the light axis LAX of the light-emitting element 16 is controlled (displaced) to the displacement position D3 by the light axis control unit 6 (see FIGS. 50(A) and 50(B)), the relative light intensity to reference axis displacement angle characteristic is a graph as indicated by the curve CD3.

That is, when the reference axis displacement angle θs is “0 degree”, the relative light intensity of the light-reception signal detected by the position detection light-receiving element 37p (the light reception amount for the position detection light signal LSp from the light-emitting element 16) is 50%. Further, when the reference axis displacement angle θs is displaced from “0 degree” in the “minus” direction, that is, when the remote control transmitter 40 is displaced in the minus direction, the light axis LAX approaches the frontal direction of the position detection light-receiving element 37p, so that the relative light intensity gradually increases. When the reference axis displacement angle θs is displaced towards minus “30 degrees” (half value angle θh), the light axis LAX coincides with the frontal direction of the position detection light-receiving element 37p, so that the relative light intensity assumes a maximum value (100%). Furthermore, when the reference axis displacement angle θs is displaced from “0 degree” in the “plus” direction, that is, when the remote control transmitter 40 is displaced in the plus direction, the light axis LAX is moved away from the frontal direction of the position detection light-receiving element 37p even further, so that the relative light intensity gradually decreases and attenuates.

As can be seen from the above-described relative light intensity to reference axis displacement angle characteristic, the detected relative light intensity varies depending on the displacement position (D1 to D4) of the light axis LAX and the state of displacement of the reference axis displacement angle θs. When at least two displacement positions of the light axis LAX are symmetrical, it is possible to perform one-dimensional detection. When at least four displacement positions are symmetrical, it is possible to perform two-dimensional detection.

Accordingly, it is possible to determine the state of displacement (the displacement direction and the reference axis displacement angle θs) of the remote control transmitter 40 (reference axis displacement angle θs) by obtaining in advance a relative light intensity to reference axis displacement angle characteristic, emitting as output the position detection light signal LSp in correspondence (synchronization) with the displacement positions of the light-emitting element 16 (for example, the displacement positions D1, D2, D3 and D4), measuring the relative light intensity that is received as input by the position detection light-receiving element 37p in synchronization therewith, and performing arithmetic processing using the difference or the ratio, or the difference and the ratio of the measured relative light intensity.

For example, when the reference axis displacement angle θs is displaced by 30 degrees in a rightward horizontal direction, the relative light intensity is detected as 100% in a state in which the light-emitting element 16 is set to the displacement position D1, and the relative light intensity is detected as 6% in a state in which the light-emitting element 16 is set to the displacement position D3. By determining the difference of the relative light intensity (relative light intensity 100 at displacement position D1—relative light intensity 6 at displacement position D3=94 (%)), the ratio (relative light intensity 100 at displacement position D1/relative light intensity 6 at displacement position D3=about 16.7), or the difference and the ratio, it is possible to determine the state of displacement of the previously associated reference axis displacement angle θs. That is, here, it is possible to detect that “the reference axis BAX is displaced by 30 degrees in a rightward horizontal direction”.

In the above-described example, description was given for a horizontal direction, but it should be appreciated that the reference axis displacement angle θs can also be similarly determined for a vertical direction. Furthermore, the state of displacement of the reference axis displacement angle θs can also be similarly determined in a case where displacement is made in both horizontal and vertical directions (displacement in all the four directions).

That is, the remote control device detects the state of displacement (the displacement direction and the reference axis displacement angle θs) of the reference axis displacement angle θs by causing the light-emitting element 16 to be successively displaced to predetermined displacement positions (for example, the displacement positions D1, D2, D3 and D4) of the remote control transmitter 40, supplying the light-emission signal (for example, a current signal in the case of an LED) to the light-emitting element 16 at the displacement positions to cause the light-emitting element 16 to emit as output the position detection light signals LSp, successively detecting the light-reception signals (relative light intensity output levels) received as input by the position detection light-receiving element 37p of the light-reception detection unit 37, and performing appropriate arithmetic processing on the detected light-reception signals.

It should be noted that it is possible to readily detect the light-reception signals corresponding to the displacement positions by specifying in advance the order of displacement of the predetermined displacement positions D1, D2, D3 and D4. Furthermore, it is possible to specify the displacement position at which the reference axis displacement angle θs becomes maximal (the main displacement direction) based on the graph showing the maximum relative light intensity among the light-reception signals corresponding to the displacement positions.

Accordingly, the electronic device according to the present invention can determine the reference axis displacement angle θs for both directions (both the X and Y directions in plane coordinates), that is, the horizontal direction (first direction) and the vertical direction (second direction vertically intersecting the first direction). The state of displacement of the reference axis displacement angle θs (the displacement direction and the reference axis displacement angle θs) directly represents the position signal (the movement direction and the movement amount) of the remote control transmitter 40, and thus can be caused to correspond to the position signal of the pointer 4, so that it is possible to control movement (the movement direction and the movement amount) of the pointer 4 on the display screen (on the plane) by processing the reference axis displacement angle θs (change of the reference axis displacement angle θs) by a microcomputer (CPU: central processing unit) as the indication signal (the movement direction and the movement amount) corresponding to the pointer 4.

In the foregoing, description was given for the principles of the method for operating the pointer on the monitor screen by moving the remote control transmitter 40. The following is a description of specific examples of the processing action of actually moving the pointer on the monitor screen by the remote control transmitter 40 using the principles.

### SPECIFIC EXAMPLE 1

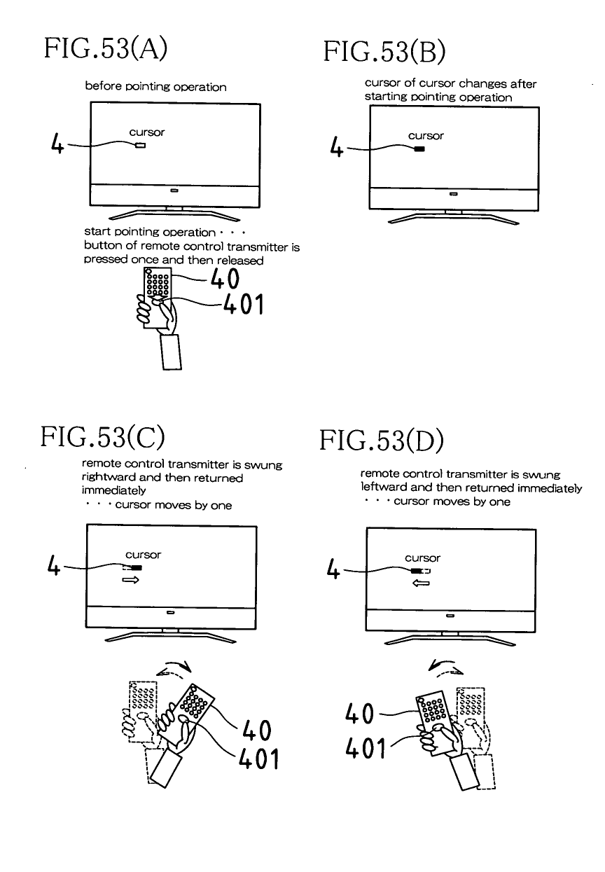

The relationship between the manner of moving the remote control transmitter 40 and the movement of the pointer can be set such that when the remote control transmitter 40 is swung back and forth once, the pointer is moved in the swung direction by a preset minimum movement amount. FIGS. 53(A) to 53(D) are diagrams illustrating a relationship between the swing operation of the remote control transmitter 40 and the movement of the pointer in a simplified manner. It should be noted that the remote control transmitter 40 is provided with a start button 401.

More specifically, as shown in FIG. 53(A), the start button 401 is pressed once (or pressed once and then released), with the remote control transmitter 40 pointed to the monitor. This changes the color of the pointer 4 on the monitor screen, as shown in FIG. 53(B). Thereafter, when the remote control transmitter 40 is swung, for example, rightward, and then returned once such that it is swung leftward again by the user, the control unit 36 judges that the initial swinging direction (rightward) is the movement direction of the pointer 4, and causes the pointer 4 to move rightward by a minimum movement amount when it detects a changing point from rightward to leftward, as shown in FIG. 53(C). Conversely to this, when the remote control transmitter 40 is swung leftward and then returned once such that it is swung rightward again by the user, the control unit 36 judges that the initial swinging direction (leftward) is the movement direction of the pointer 4, and causes the pointer 4 to move leftward by a minimum movement amount when it detects a changing point from leftward to rightward, as shown in FIG. 53(D).

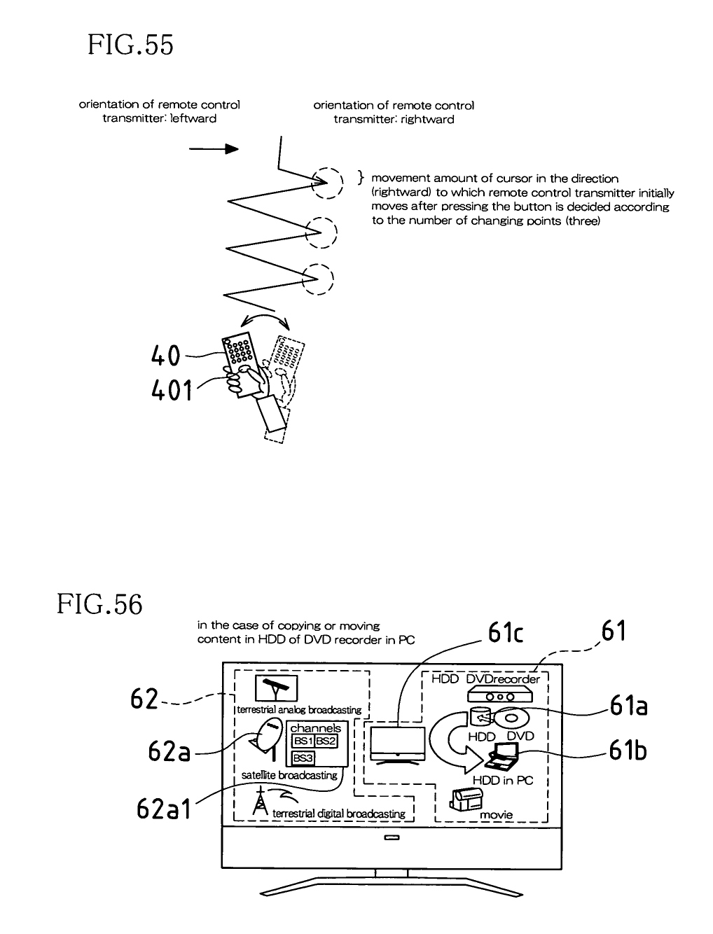

Accordingly, the user can freely decide the movement amount of the pointer 4 by performing such a swing and return operation of the remote control transmitter 40 for a predetermined number of times. That is, it is possible to decide the movement amount of the pointer 4 according to the number of times the remote control transmitter 40 swings and returns. FIG. 55 is an explanatory diagram conceptually illustrating a method for deciding the movement direction and the movement amount of the pointer according to the swing and return operation of the remote control transmitter 40 in this case.

Accordingly, the swinging direction and the number of times of swinging of the remote control transmitter 40 agree with the movement direction and the number of times of movement (moving distance) of the pointer 4 on the monitor screen, so that the user can intuitively operate the pointer while looking at the monitor screen.

### SPECIFIC EXAMPLE 2

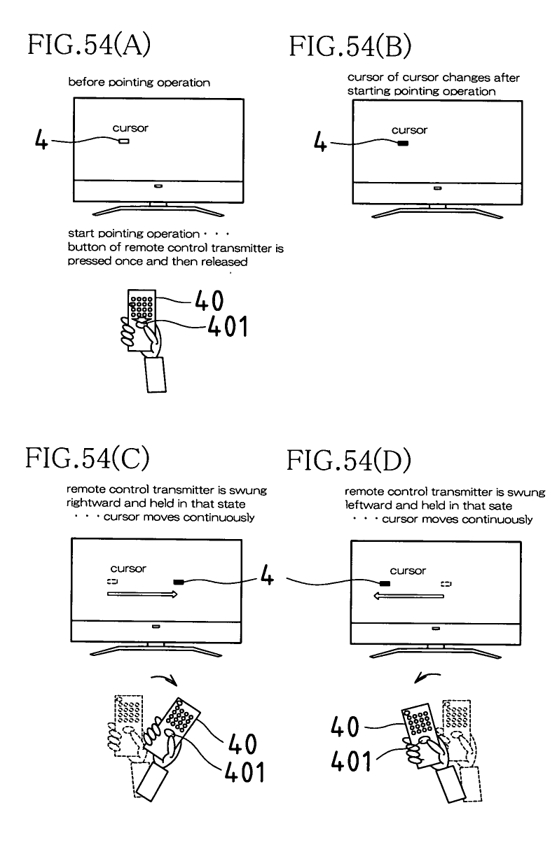

In addition to Specific Example 1 described above, the relationship between the manner of moving the remote control transmitter 40 and the movement of the pointer can also be set such that by holding the remote control transmitter 40 inclined to a swung direction for a fixed time period, the pointer on the monitor screen is successively moved in the inclined direction. FIGS. 54(A) to 54(D) are diagrams illustrating the relationship between the swing operation of the remote control transmitter 40 and the movement of the pointer in a simplified manner. It should be noted that the remote control transmitter 40 is provided with a start button 401.

More specifically, as shown in FIG. 54(A), the start button 401 is pressed once (or pressed once and then released), with the remote control transmitter 40 pointed to (directly facing) the monitor screen. This changes the color of the pointer 4 on the monitor screen, as shown in FIG. 54(B). Thereafter, the remote control transmitter 40 is held inclined, for example, rightward from the directly facing position for a fixed time period (e.g., 0.5 second) by the user. Consequently, the control unit 36 judges that the inclined direction (rightward) is the movement direction, and successively moves the pointer 4 rightward when it confirms that this inclined state has continued for a fixed time period, as shown in FIG. 54(C). To stop this movement, the inclination of the remote control transmitter 40 is canceled such that the remote control transmitter 40 directly faces the monitor screen. Conversely to this, the remote control transmitter 40 is held inclined leftward from the directly facing position for a fixed time period (e.g., 0.5 second) by a user. Consequently, the control unit 36 judges that the inclined direction (leftward) is the movement direction, and successively moves the pointer 4 leftward when it confirms that this inclined state has continued for a fixed time period, as shown in FIG. 54(D). Tb stop this movement, the inclination of the remote control transmitter 40 is canceled such that the remote control transmitter 40 directly faces the monitor screen. In addition, to move the pointer 4 upward or downward, the remote control transmitter 40 may be inclined upward or downward similarly. This makes it possible to improve the operability in a case where the pointer has a long moving distance. Furthermore, the user can intuitively operate the pointer while looking at the monitor screen.

In this embodiment, using such a pointer operating method, various operations described below are readily realized by speedily and intuitively moving a pointer on a monitor screen located at a distant position by an arbitrary movement of the remote control transmitter 40 in the space. In the following, this is described by way of working examples.

### WORKING EXAMPLE 1

In Working Example 1, the pointer on the monitor screen is moved by pointing the remote control transmitter 40 to the monitor screen and swinging it in a desired direction, and the processing action of devices is performed by dragging and dropping. In the following, this is described with reference to FIG. 56.

As shown in FIG. 56, on the monitor screen, device icons 61 of a television, a HDD-containing DVD recorder, a PC and a video camera and the like, and content icons 62 of analog terrestrial broadcasting, digital terrestrial broadcasting, satellite broadcasting and the like are provided.

Then, an arbitrary content icon 62 is dragged and dropped onto an arbitrary device icon 61, thereby executing the application corresponding to the dropped icon in a predetermined mode. The drag and drop may be carried out, for example, by providing a drag button (not shown) at the remote control transmitter 40, and pressing the drag button after moving the pointer onto a desired icon. Then, the dragging operation is achieved by swinging and moving the remote control transmitter 40 itself in a desired direction while pressing the drag button, and the drag and drop may be completed when the drag button is released over a predetermined icon.

For example, in the case of copying the content in the HDD of the DVD recorder onto the PC, an icon 61a of the HDD of the DVD recorder may be dragged and dropped onto an icon 61b of the PC by the above-described operation. Consequently, the information in the HDD is copied into a memory in the PC. That is, when an operation can be uniquely defined by the relationship between a dragged icon and an icon onto which the dragged ion is dropped, the operation is started immediately after completion of the dropping.

On the other hand, when there are multiple operations possible for the relationship between a dragged icon and an icon to which the dragged icon is dropped, the following may be performed. For example, when the icon 62a of satellite broadcasting is dragged and dropped onto an icon 61c of the television, a listing 62al of satellite broadcasting channels is displayed on the monitor screen. When the user selects a desired channel from the listing, the broadcasting of that channel is received. That is, a menu for selecting the operations (in the above-described case, the channel listing) may be displayed only when there are multiple possible operations, and the user may select an operation from the menu.

### WORKING EXAMPLE 2

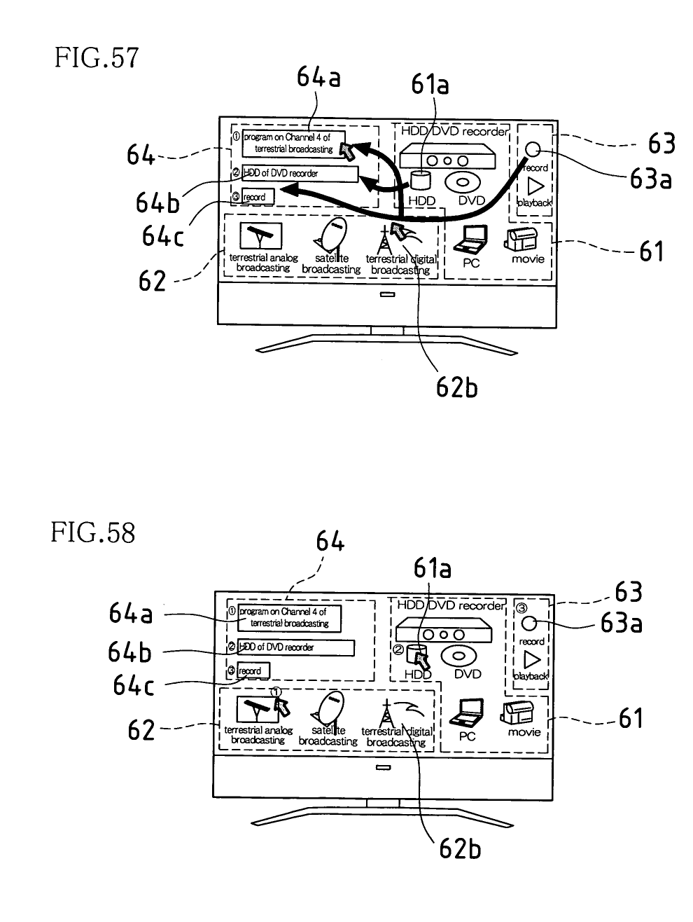

In Working Example 2, the pointer on the monitor screen is moved to a setting field by pointing the remote control transmitter 40 to the monitor screen and swinging it in a desired direction, and the processing action of devices is performed by dragging and dropping. It should be noted that the drag and drop can be carried out by pressing the drag button as in Example 1. In the following, this is described with reference to FIG. 57.

As shown in FIG. 57, on the monitor screen, device icons 61 of a television, a HDD-containing DVD recorder, a PC and a video camera and the like, content icons 62 of analog terrestrial broadcasting, digital terrestrial broadcasting, satellite broadcasting and the like, and operation icons 63 of playback, recording, preprogrammed recording and the like are provided. Furthermore, setting fields 64 including a content field 64a, a device field 64b and an operation field 64c are provided on the monitor screen. Then, an arbitrary content icon 62 is dragged and dropped onto the content field 64a, and an arbitrary device icon 61 is then dragged and dropped onto the device field 64b, and, finally, an arbitrary operation icon 63 is dragged and dropped onto the operation field 64c, thereby executing a predetermined application in accordance with the contents of the icons dropped onto the fields 64a to 64c.

For example, the icon 62b of digital terrestrial broadcasting is dragged and dropped onto the content field 64a, then the icon 61a of the HDD of the HDD-containing DVD recorder is dragged and dropped onto the device field 64b, and the icon 63a of recording is dragged and dropped onto the operation field 64c, thereby performing processing for automatically recording, for example, the program on Channel 4 of digital terrestrial broadcasting, which is currently received, onto the HDD of the HDD-containing DVD recorder. It should be noted that the content in the content field may be, for example, the current and the future television channels, programs that have already been recorded, video that is recorded in video tapes, and shortcut icons to websites. Furthermore, the operations in the operation field may include an operation that is automatically decided upon selecting the content and the device, based on their relationship.

### WORKING EXAMPLE 3

FIG. 58 shows a working example in which a desired icon is selected by moving the pointer on the monitor screen on the desired icon by pointing the remote control transmitter 40 to the monitor screen and swinging it in a desired direction, and a processing action is performed in accordance with the selection operation.

As shown in FIG. 58, on the monitor screen, device icons 61 of a television, a HDD-containing DVD recorder, a PC and a video camera and the like, content icons 62 of analog terrestrial broadcasting, digital terrestrial broadcasting, satellite broadcasting and the like, and operation icons 63 of playback, recording, preprogrammed recording and the like are provided. Furthermore, setting fields including a content field 64a, a device field 64b and an operation field 64c are provided on the monitor screen. Then, an arbitrary content icon 62 is selected by moving the pointer thereon, then an arbitrary device icon 61 is selected by moving the pointer thereon, and an arbitrary operation icon 63 is selected by moving the pointer thereon, thereby setting the icons in the above-described fields 64a to 64c and executing a predetermined application in accordance with the contents of the set icons.

For example, a select button (not shown) is provided at the remote control transmitter 40, and “the program on Channel 4 of digital terrestrial broadcasting”, which is currently received, is set in the content field 64a by pressing the select button after moving the pointer onto the icon 62b of digital terrestrial broadcasting, then “the HDD of the DVD recorder” is set in the device field 64b by pressing the select button after moving the pointer onto the icon 61a of the HDD of the HDD-containing DVD recorder, and then “recording” is set in the operation field 64c by pressing the select button after moving the pointer onto the icon 63a of recording. Consequently, processing for automatically recording the program on Channel 4 of digital terrestrial broadcasting onto the HDD of the HDD-containing DVD recorder is performed in accordance with the contents of the icons set in the fields 64a to 64c.

### WORKING EXAMPLE 4

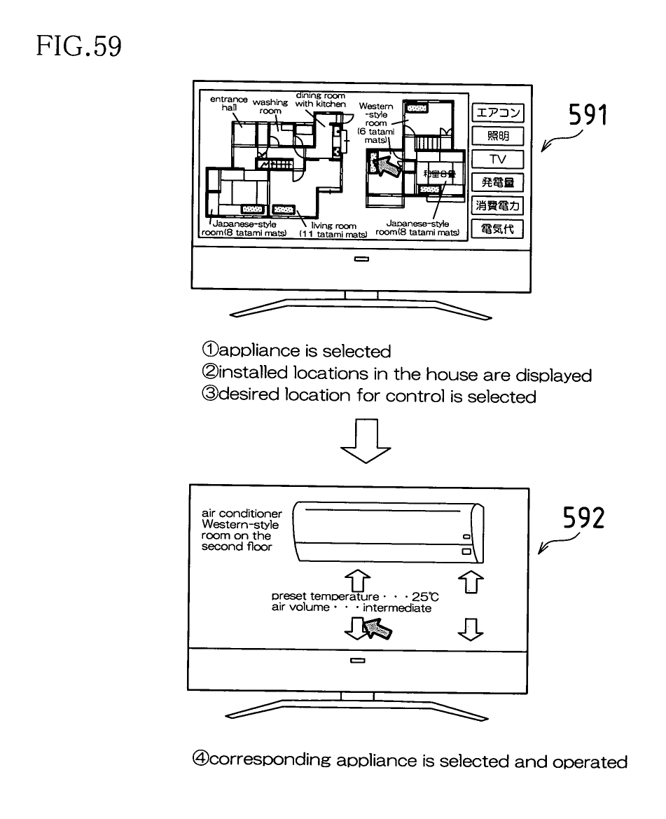

In Working Example 4, one or a plurality of household appliance icons are displayed on the monitor screen, and, when an arbitrary household appliance icon is selected from them, the locations in which that household appliance is installed are displayed in a floor plan on the monitor screen, and a desired location of the household appliance is selected from the above-described locations. This is described with reference to FIG. 59.

Regarding communications, it is anticipated in the future that devices that are present in multiple numbers in a residence, including for example, lighting devices, air conditioners, televisions, as well as windows and doors are connected by DLAN (Digital Living Network Alliance) or power line communication such that they can be remotely operated using a television as a monitor. In this case, to select a single particular household appliance that is to be operated, the position of the appliance is most conveniently confirmed on the actual floor plan. If the position is specified by a method other than this, then the device to be operated cannot be specified without description of the installed location and the device, including for example, “the window on the east side of the children's room on the south side of the second floor” or “the stand beside the bed in the bed room on the south side of the second floor”, which makes the operation unintuitive and difficult to understand. Working Example 4 allows such an operation to be performed intuitively. In this case, the floor plan may be provided, for example, by a housing manufacturer, or may be created by the user. In addition, the configuration setting and the address setting for the device connection ports may be carried out by a contractor who constructs the home network.

As shown in a monitor screen 591, when a desired household appliance is selected from a plurality of household appliances displayed, for example, at the right side corner of the monitor screen 591, a floor plan is displayed at the left side of the same monitor screen 591, and the installed locations (the portions filled in with black in the drawing) of the household appliance is displayed on the floor plan. Accordingly, when the user selects a position of the desired household appliance from among the household appliances displayed on this floor plan by moving the pointer 4 onto the installed location, the operation screen for the selected household appliance is displayed as shown in monitor screen 592, so that the user may set in sequence the details of the operation in accordance with the instructions on the operation screen.

### WORKING EXAMPLE 5

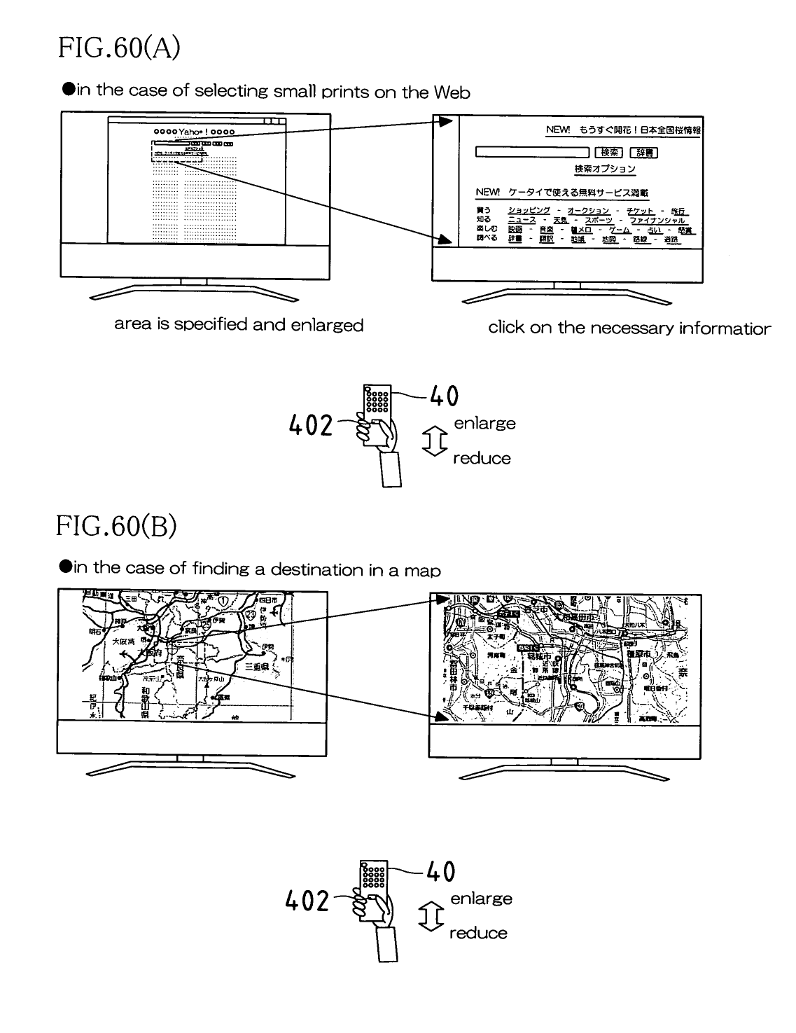

FIGS. 60(A) and 60(B) are explanatory diagrams illustrating a processing action according to Working Example 5. In Working Example 5, the remote control transmitter 40 is provided with a lever 402 that can be tilted backward and forward and can be pressed down at a right angle. A center of enlargement is specified by pressing the lever 402 down at a right angle, and then the display on the screen is enlarged or reduced by tilting the lever 402 forward or backward. With this configuration, for example, in the case of viewing small prints or when the characters are too small to recognize as shown in FIG. 60(A), the center of enlargement is specified by pressing the lever 402 of the remote control transmitter 40 down at a right angle, and the characters can be made easy to recognize by enlarging the necessary region by tilting the lever 402, for example, forward (upward in the drawing) in this state, as shown in the right side in FIG. 60(A). Additionally, in the case of watching a Web screen of a PC on a television, text written in small characters may be contained. It is also possible to enlarge the necessary region in such a case.

Similarly, in the case of enlarging or reducing a map viewed on the Web as shown in FIG. 60(B), the center of enlargement can be specified by pressing the lever 402 of the remote control transmitter 40 down at a right angle, and the map can be made easy to view by enlarging the necessary region by tilting the lever 402 in this state, for example, forward, as shown on the right side of FIG. 60(B).

### WORKING EXAMPLE 6

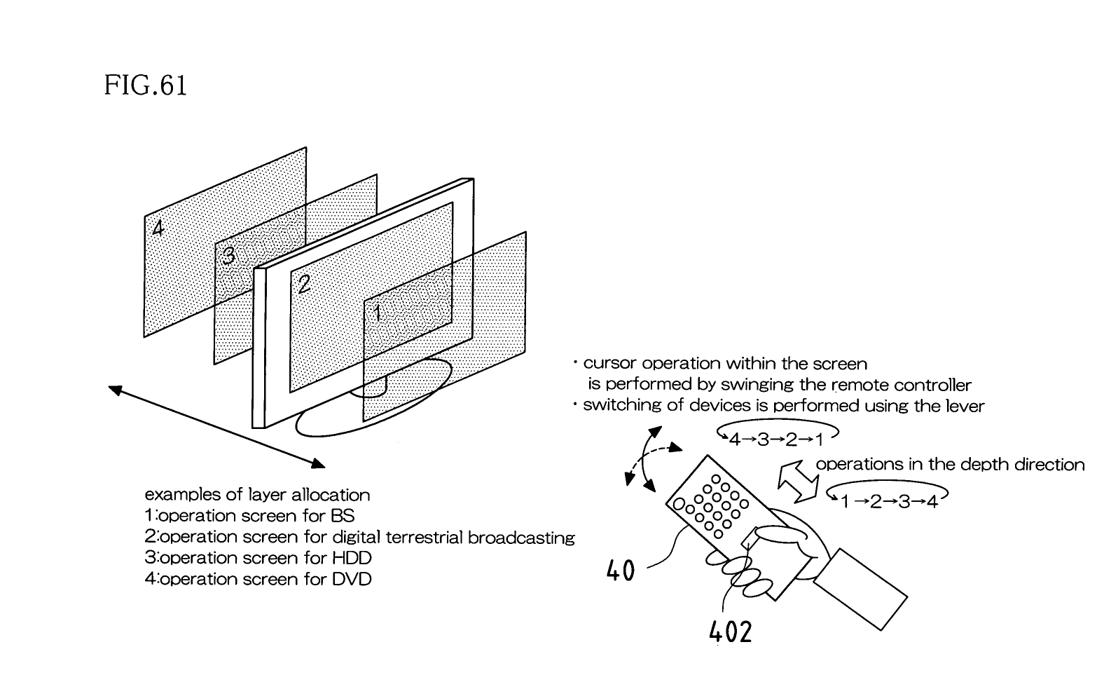

In Working Example 6, the device to be operated on the monitor screen is switched using the above-described lever 402 of the remote control transmitter 40. That is, the lever 402 is used to switch the operation screens for devices connected to a television, including for example, a DVD recorder, a digital camera, a game console, terrestrial broadcasting, satellite broadcasting and a PC. In this case, as shown in FIG. 61, the movement of the pointer within the monitor screen is performed by swinging the remote control transmitter 40 upward, downward, leftward and rightward, and switching of the operation screens is carried out using the lever 402. Specifically, in a case where the operation screen for BS, for example, is displayed on the monitor screen, tilting the lever 402 forward once switches the operation screen to the operation screen for digital terrestrial broadcasting, further tilting the lever 402 forward once switches the operation screen for digital terrestrial broadcasting to the operation screen for the HDD, and further tilting the lever 402 forward once switches the operation screen for the HDD to the operation screen for the DVD. Then, further tilting the lever 402 forward once switches the operation screen for the DVD to the operation screen for BS again. On the other hand, tilting the lever 402 backward switches the operation screens in the order that is reverse to the above-described order. It should be noted that such an order of switching the operation screens is set in advance.

By switching the device-specific content for each screen by operating the lever 402 in this way, it is possible to display a listing of an enormous number of titles, and allow the necessary title to be selected from the listing. This makes it possible to reduce the number of operations necessary for the selection.

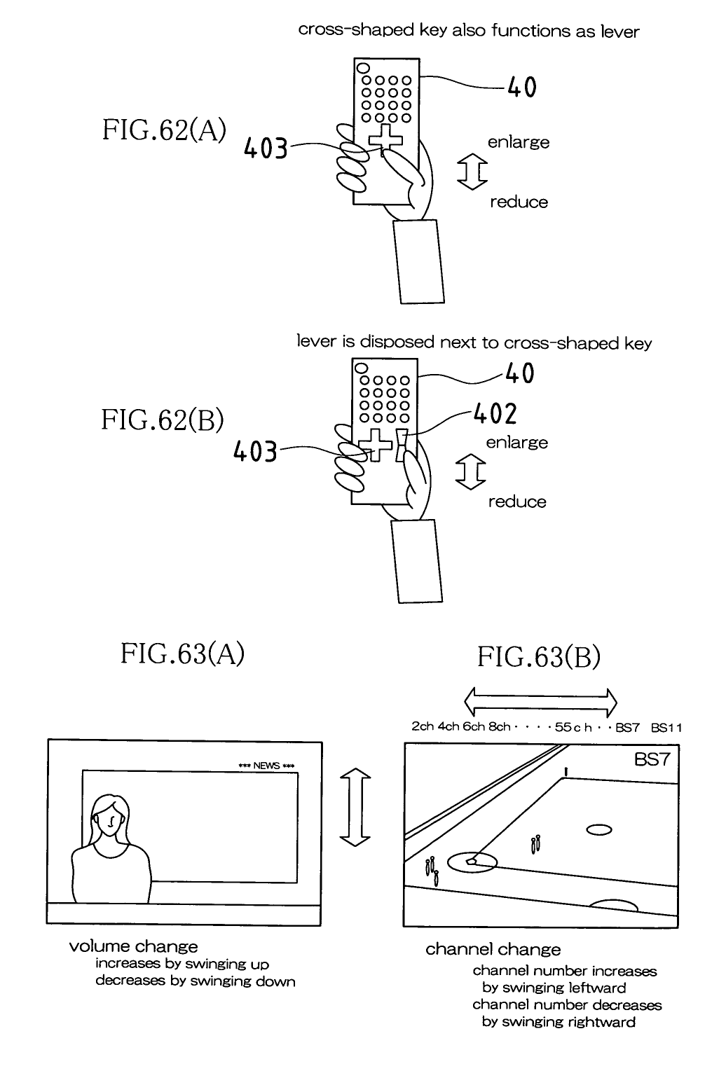

FIG. 62(A) shows a modified working example in which the cross-shaped key 403 included in the remote control transmitter 40 is used in place of the lever 402. That is, the above-described switching of the operation screens can be similarly performed without the lever 402, by assigning the forward and backward operations of the lever 402 to the up key and the down key of the cross-shaped key 403. In this case, there is no need to provide the lever 402, so that it is possible to reduce the number of keys on the remote control transmitter 40.

However, although the configuration shown in FIG. 62(A) can reduce the number of keys, there is the possibility that the operation of moving the pointer on the monitor screen upward and downward using the cross-shaped key 403 and the operation of the above-described switching of the operation screens are the same, rendering these operations undistinguishable in their sense of operation. In that case, the remote control transmitter 40 may be provided with both the cross-shaped key 403 and the lever 402, as shown in FIG. 62(B). That is, the movement of the pointer on the monitor screen may be performed using the cross-shaped key 403, and the switching of the operation screens may be performed using the lever 402.

### WORKING EXAMPLE 7

In Working Example 7, the operation menu screen for the device to be operated is switched using the lever 402 of the remote control transmitter 40 shown in FIGS. 60(A) and 60(B) above. For example, in the case of switching the search condition for recorded programs, it is possible to sort the programs “by date”, “by title”, “by genre” and so on, or perform scroll in ascending order or descending order by tilting the lever 402 forward or backward. This is very convenient for a user to locate a desired program in a currently available hard disk recorder having a very large capacity and capable of recording an enormous number of programs. For example, in the case of selecting a desired program from an enormous number of programs of CATV, for example, it is possible to sort the programs “by channel viewing frequency”, “by title”, “by genre” and so on, or to scroll in ascending order or descending order by tilting the lever 402.

### WORKING EXAMPLE 8

In Working Example 8, received channels are switched up and down by swinging the remote control transmitter 40 in either the lateral direction or the vertical direction, and the volume is turned up and down by swinging the remote control transmitter 40 in the direction different from that direction. Specifically, when the initial movement direction of the remote control transmitter 40 is upward, the volume is increased by one step at a changing point of the movement direction of the remote control transmitter 40. On the other hand, when the initial movement direction of the remote control transmitter 40 is downward, the volume is decreased by one step at a changing point of the movement direction of the remote control transmitter 40. This is shown in FIG. 63(A).

Meanwhile, when the initial movement direction of the remote control transmitter 40 is leftward, the received channel is switched in the down-direction (small CH direction) by one at a changing point of the movement direction of the remote control transmitter 40. On the other hand, when the initial movement direction of the remote control transmitter 40 is leftward, the received channel is switched in the up-direction (large CH direction) by one at a changing point of the movement direction of the remote control transmitter 40. This is shown in FIG. 63(B).

By doing so, it is possible to adjust the volume or change the channel up and down while looking at the remote control transmitter 40, without searching for the necessary button.

### WORKING EXAMPLE 9

In Working Example 9, the method for operating the screen on the monitor screen is switched by moving the remote control transmitter 40 forward and backward. It is possible to detect the forward and backward movement of the remote control transmitter 40, for example, by providing a light-emitting element having an isotropic directivity in the remote control transmitter 40, and making detection based on the amount of light received from the light-emitting element. In this case, the light reception amount does not change much even if the direction of the remote control transmitter 40 is changed, and changes only when the distance to the light-reception detection unit 37 is changed, so that it is possible to distinguish between a change in direction and a change in distance.

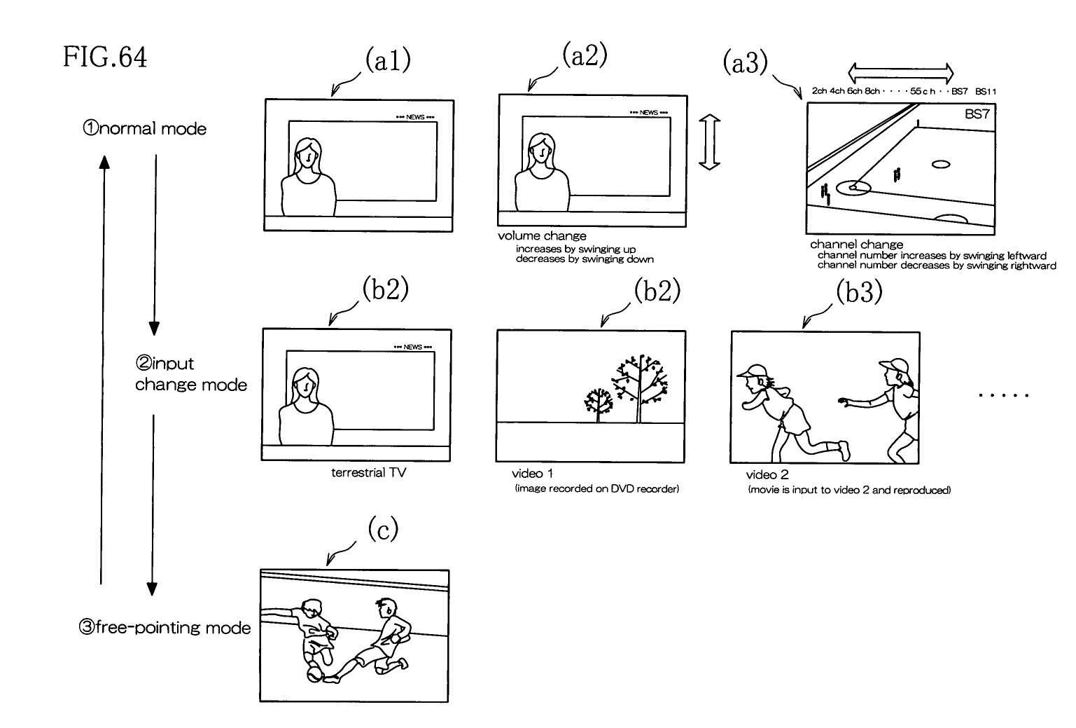

FIG. 64 shows a specific example of Working Example 9.

For example, the operation (see FIG. 63) of the remote control transmitter 40 shown in Working Example 8 described above in a normal mode shown in a monitor screen (a1), that is, a mode of changing the volume of the currently received channel or a channel changing mode, the volume is changed as shown in a monitor screen (a2) according to the operation, and the channel is switched as shown in the monitor screen (a3).

On the other hand, when the remote control transmitter 40 is swung back and forth once in the state shown in the monitor screen (a1), the mode is changed to an input modification mode shown in a monitor screen (b1). Then, when the operation (see FIG. 61) of the remote control transmitter 40 shown in Working Example 6 described above is performed in this input modification mode, the method for operating the screen is switched in accordance with a preset order. In Working Example 9, an example is shown in which the device to be operated is switched in the same manner as in Working Example 6 described above. That is, each time the operation of the remote control transmitter 40 shown in Working Example 6 described above is performed, the monitor screen is switched in accordance with the preset order, for example, from terrestrial TV shown in the monitor screen (b1) to video 1 shown in a monitor screen (b2), from video 1 shown in the monitor screen (b2) to video 2 shown in a monitor screen (b3), from video 2 shown in the monitor screen (b3) to satellite broadcasting (not shown), etc. Thereafter, when the remote control transmitter 40 is swung back and forth once, the mode is switched to a free-pointing mode in the state of the device to be operated that is displayed on the monitor screen at that time, as shown in the monitor screen (c). When the remote control transmitter 40 is further swung back and forth once in this state, the mode is changed to the normal mode again. “Free-pointing mode” as mentioned here refers to a mode in which the pointer can be freely moved like a mouse cursor throughout the screen.

### WORKING EXAMPLE 10

Working Example 10 is based on the assumption that a network camera (camera device) of another user is connected to one terminal 39n of the external connection terminal group 39 via the communications network N, such as a video telephone line, as shown in FIG. 35.

That is, the orientation of the network camera of the other user can be moved laterally or vertically by transmitting a detection signal for detecting the orientation of the remote control transmitter 40 to the other user from the externally connected terminal 39n via a video telephone line or the like by swinging the remote control transmitter 40 laterally or vertically toward the monitor screen.

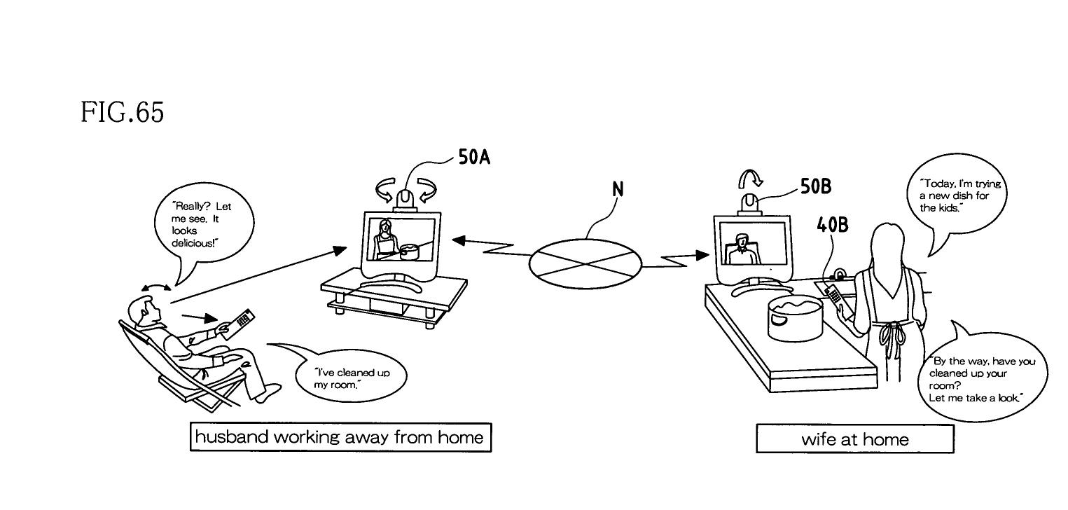

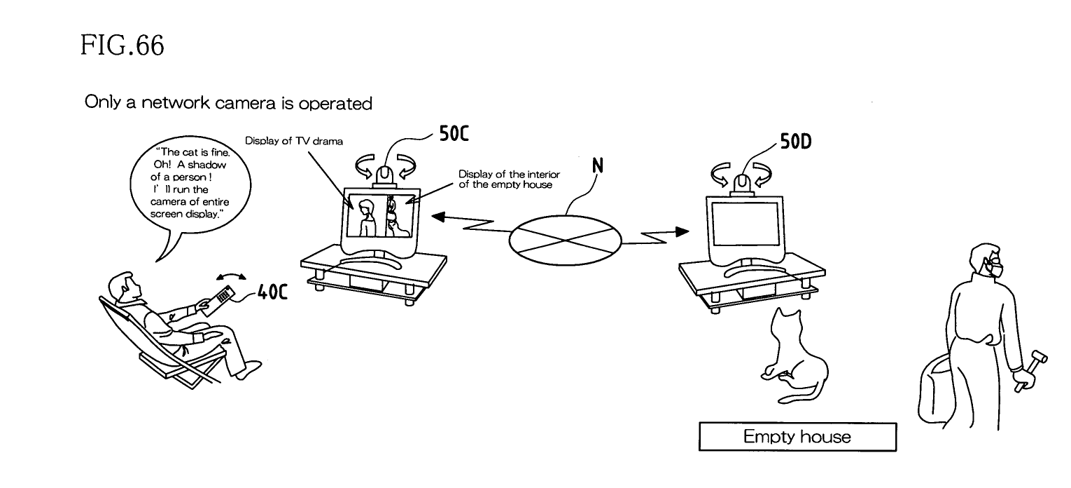

FIGS. 65 and 66 show an example of use of an electronic device according to Working Example 10. FIG. 65 shows how a husband who is working away from home has a conversation (communicates) with his wife who is at home, using a video telephone system that uses the electronic device according to Working Example 10. In order to see a dish prepared by his wife, the husband is swinging a remote control transmitter 40A such that a network camera 50B moves from the portion corresponding to the face of his wife to the portion corresponding to her hand. Meanwhile, in order to see the room of her husband, his wife at home is rotating a network camera 50A by swinging the remote control transmitter 40B.

FIG. 66 shows a case where a person has requested his friend living in a remote location to monitor his empty house while he is away, using a video telephone system that uses the electronic device according to Working Example 10. The friend is moving a network camera 50D, which is installed in the empty house, toward a moving object by swinging a remote control transmitter 40C after finding the moving object in an image captured by the network camera 50D, which is displayed at the corner of the screen of a television screen, while watching the television in his own house.

It should be noted that the forms of use shown in FIGS. 65 and 66 are merely examples, and the present working example is not limited to such forms of use. Furthermore, Working Example 10 can be applied not only to network cameras used in video telephone systems, but also to security cameras, monitoring cameras and the like as well.

It should be noted that without departure from the gist or principal characteristics thereof, the present invention can have many other embodiments. Accordingly, the above-described embodiments are no more than simple examples and should not be interpreted in a limited manner. The scope of the present invention is set forth by the scope of the claims, and the disclosure is in no way binding. Furthermore, all modifications and changes within a scope equivalent to that of the claims are within the scope of the present invention.

1. A remote control system comprising:
a remote control transmitter including a position detection light-emission unit that emits position detection light signals;
a remote control receiver including a light-reception signal processing unit that detects position detection reception signals from the position detection light signals that are received, and a displacement detection unit that detects a displacement of the remote control transmitter based on the position detection reception signals; and
a cursor control unit that controls a position of a cursor displayed on a display screen,
wherein the position detection light-emission unit comprises: a first light-emitting element and a second light-emitting element that are arranged symmetrically with respect to a central axis of the remote control transmitter in a first axis direction; a third light-emitting element and a fourth light-emitting element that are arranged symmetrically with respect to the central axis in a second axis direction that intersects the first axis direction; and a light-emitting element control unit that successively drives the first light-emitting element to the fourth light-emitting element through pulse position modulation by a time division driving system so as to successively emit a first light signal to a fourth light signal as the position detection light signals,
the light-reception signal processing unit detects a first reception signal to a fourth reception signal corresponding respectively to the first light signal to the fourth light signal as the position detection reception signals,
the displacement detection unit comprises: an output detection unit that performs waveform conversion on the position detection reception signals to obtain a first output signal to a fourth output signal as position detection output signals corresponding respectively to the first reception signal to the fourth reception signal; and an arithmetic processing unit that calculates a displacement of the remote control transmitter in the first axis direction based on an amplitude correlation between the first output signal and the second output signal, and calculates a displacement of the remote control transmitter in the second axis direction based on an amplitude correlation between the third output signal and the fourth output signal, and
the cursor control unit controls the position of the cursor based on the displacement of the remote control transmitter in the first axis direction and the displacement of the remote control transmitter in the second axis direction.

2. The remote control system according to claim 1,
wherein the position detection light-emission unit comprises a start signal light-emitting element that emits a detection start light signal indicating start of a light-emission cycle of the position detection light signals.

3. The remote control system according to claim 2,
wherein the arithmetic processing unit comprises a header detection unit that detects a detection start output signal corresponding to the detection start light signal and specifies the first output signals to the fourth output signal.

4. The remote control system according to claim 2,
wherein a light-emission pulse width of the first light signal to the fourth light signal and a light- emission pulse width of the detection start light signal are different from each other.

5. The remote control system according to claim 1,
wherein the first light-emitting element and the second light-emitting element have light axes that are inclined to opposite sides with respect to the central axis, and the third light-emitting element and the fourth light-emitting element have light axes that are inclined to opposite sides with respect to the central axis.

6. The remote control system according to claim 1,
wherein the displacement of the remote control transmitter is a swing angle of the remote control transmitter.

7. The remote control system according to claim 1,
wherein the output detection unit performs waveform conversion on the first reception signal to the fourth reception signal to obtain envelope waveforms of the first reception signal to the fourth reception signal as the first output signal to the fourth output signal.

8. The remote control system according to claim 7, comprising:
a noise filter that removes high-frequency noise contained in the envelope waveforms of the first output signal to the fourth output signal.

9. The remote control system according to claim 1,
wherein the light-reception signal processing unit comprises an amplifier whose gain is adjusted by a gain adjustment circuit.

10. The remote control system according to claim 1,
wherein the amplitude correlation is an amplitude ratio.

11. The remote control system according to claim 10,
wherein the amplitude ratio, a swing angle of the remote control transmitter, and position information specifying the position of the cursor correspond to one another.

12. The remote control system according to claim 1,
wherein the amplitude correlation is a logarithm of an amplitude ratio.

13. The remote control system according to claim 12,
wherein the logarithm of the amplitude ratio, a swing angle of the remote control transmitter, and position information specifying the position of the cursor correspond to one another.

14. The remote control system according to claim 1,
wherein the amplitude correlation is a linear approximation of a logarithm of an amplitude ratio.

15. The remote control system according to claim 14,
wherein the logarithm of the amplitude ratio, a swing angle of the remote control transmitter, and position information specifying the position of the cursor correspond to one another based on an approximating straight line obtained by the linear approximation.

16. The remote control system according to claim 11,
wherein the position information is set corresponding to a variation in the swing angle.

17. The remote control system according to claim 11,
wherein at least two types of position information, namely coarse adjustment position information for moving the cursor in a large amount and fine adjustment position information for moving the cursor in a small amount, are set as the position information of the cursor.

18. The remote control system according to claim 17,
wherein the fine adjustment position information is used after using the coarse adjustment position information.

19. The remote control system according to claim 18,
wherein switching between the coarse adjustment position information and the fine adjustment position information is carried out by changing an emission pattern of light signals constituted by the position detection light signals and the detection start light signal that are emitted from the position detection light-emission unit.

20. A remote control system comprising:
a remote control transmitter including a position detection light-emission unit that emits position detection light signals;
a remote control receiver including a light-reception signal processing unit that detects position detection reception signals from the position detection light signals that are received, and a displacement detection unit that detects a displacement of the remote control transmitter based on the position detection reception signals; and
a cursor control unit that controls a cursor displayed on a display screen by coarse adjustment and fine adjustment,
wherein the coarse adjustment is carried out based on the displacement of the remote control transmitter, and,
after a fine adjustment optical code signal as position information for finely adjusting a position of the cursor is transmitted from a fine adjustment alternative signal generating means included in the remote control transmitter to the remote control receiver, the fine adjustment is carried out based on the fine adjustment optical code signal received by the remote control receiver.

21. The remote control system according to claim 20,
wherein the fine adjustment alternative signal generating means is operated with a cross-shaped key.

22. The remote control system according to claim 20,
wherein the fine adjustment alternative signal generating means is operated with a capacitance touch pad.

23. The remote control system according to claim 20,
wherein a function of the coarse adjustment is disabled when the fine adjustment alternative signal generating means is operated.

24. The remote control system according to claim 1, comprising:
a light-emission control button that controls an on/off operation of the light-emitting element control unit,
wherein the position detection light signals are emitted when the light-emission control button is pressed, emission of the position detection light signals is suspended when pressure is released from the light-emission control button, and the position of the cursor is determined when a non-detection state of the position detection output signals has continued for a predetermined time period.

25. The remote control system according to claim 1, comprising:
a light-emission control button that controls an on/off operation of the light-emitting element control unit,
wherein the position detection light signals are switched between emission and non-emission states each time the light-emission control button is pressed, and the position of the cursor is determined when a non-detection state of the position detection output signals has continued for a predetermined time period.

26. The remote control system according to claim 20, comprising:
a light-emission control button that controls an on/off operation of the light-emitting element control unit,
wherein the position detection light signals are emitted when the light-emission control button is pressed, emission of the position detection light signals is suspended when pressure is released from the light-emission control button, and the fine adjustment alternative signal generating means is enabled when a non-detection state of the position detection output signals has continued for a predetermined time period.

27. The remote control system according to claim 20, comprising:
a light-emission control button that controls an on/off operation of the light-emitting element control unit,
wherein the position detection light signals are switched between emission and non-emission states each time the light-emission control button is pressed, and the fine adjustment alternative signal generating means is enabled when a non-detection state of the position detection output signals has continued for a predetermined time period.

28. The remote control system according to claim 24,
wherein the light-emission control button is constituted by a spring-loaded slide switch.

29. The remote control system according to claim 24,
wherein the light-emission control button is constituted by a touch activated switch.

30. The remote control system according to claim 24,
wherein the light-emission control button is constituted by a pressure sensor.

31. The remote control system according to claim 24,
wherein the light-emission control button is constituted by a wired switch that is connected to the remote control transmitter by wire.

32. The remote control system according to claim 24,
wherein the light-emission control button is constituted by a trigger of a remote control transmitter having a pistol shape.

33. The remote control system according to claim 1,
wherein the remote control system is placed on a support table that rotatably supports the remote control transmitter.

34. The remote control system according to claim 2,
wherein the transmitter comprises a command button for controlling emission of a command optical code signal, and the command optical code signal is emitted from at least one of the first light-emitting element, the second light-emitting element, the third light-emitting element, the fourth light-emitting element, and the start signal light-emitting element.

35. The remote control system according to claim 1, comprising:
a distance measuring means that measures a communication distance between the transmitter and the receiver,
wherein the position of the cursor is controlled using a measured communication distance.

36. A display device in which a cursor displayed on a display screen is controlled by a remote control system,
wherein the remote control system is the remote control system according to claim 1.

37. An electronic device comprising a drag and drop function of dragging and dropping an icon displayed on a monitor screen while the icon is selected by a pointer, using a remote operation device (using the remote control system according to claim 1), thereby executing an application corresponding to the dropped icon in a predetermined mode,
wherein one or a plurality of content icons and device icons are displayed on the monitor screen, and an arbitrary content icon is dragged and dropped onto an arbitrary device icon, thereby executing an application corresponding to the device icon in a predetermined mode.

38. An electronic device comprising a drag and drop function of dragging and dropping an icon displayed on a monitor screen while the icon is selected by a pointer, using a remote operation device, thereby executing an application corresponding to the dropped icon in a predetermined mode,
wherein one or a plurality of content icons, device icons and operation icons, and setting fields for the icons are displayed on the monitor screen, and an arbitrary content icon is dragged and dropped onto the corresponding setting field, an arbitrary device icon is dragged and dropped into the corresponding setting field, and an arbitrary operation icon is dragged and dropped onto the corresponding setting field, thereby executing an application corresponding to the icons that are set.

39. An electronic device comprising a drag and drop function of dragging and dropping an icon displayed on a monitor screen while the icon is selected by a pointer, using a remote operation device, thereby executing an application corresponding to the dropped icon in a predetermined mode,
wherein one or a plurality of content icons and household appliance icons are displayed on the monitor screen, and, when a household appliance icon is selected, locations in which a household appliance corresponding to said household appliance icon is installed are displayed on a floor plan on the monitor screen, and a desired location of the household appliance is selected from said locations.

40. The electronic device according to claim 37,
wherein the remote operation device comprises a light-emission unit that emits as output a position detection light signal, a light-receiving unit that receives as input the position detection light signal and obtains a position signal from a detected light-reception signal is provided at the body of the electronic device, and the drag and drop operation is performed by moving the pointer on the monitor screen vertically and laterally by moving the remote operation device itself vertically and laterally.

41. The electronic device according to claim 40,
wherein a movement direction of the remote operation device is detected based on a reception amount of the position detection light signal.

42. The electronic device according to claim 40,
wherein the pointer is moved by a minimum movement amount by swinging the remote operation device back and forth once.

43. The electronic device according to claim 41,
wherein by holding the remote operation device inclined in a swung direction for a fixed time period, the pointer is continuously moved in the inclined direction.

44. The electronic device according to claim 40,
wherein a lever that can be tilted forward or backward and can be pressed down at a right angle is provided in the remote operation device, a center of enlargement is specified by pressing the lever down at a right angle, and then a screen display is enlarged or reduced by tilting the lever forward or backward.

45. The electronic device according to claim 44,
wherein a device to be operated is switched using the lever.

46. The electronic device according to claim 44,
wherein an operation menu screen for a device to be operated is switched using the lever.

47. The electronic device according to claim 40,
wherein a cross-shaped key for inputting a vertical command and a lateral command is provided in the remote operation device, and a screen display is enlarged or reduced by pressing an up key or a down key of the cross-shaped key.

48. An electronic device comprising a remote operation device that emits as output various light signals from a light-emission unit,
wherein a light-reception detection unit that receives the light signals and detects a change in a light reception amount, and, in a state in which a television broadcasting signal is received and displayed on a monitor screen, a received channel is switched up/down based on a change in a reception light amount detected by the light-reception detection unit by swinging the remote operation device in either a lateral direction or a vertical direction, and volume is turned up/down based on a change in a light reception amount detected by the light-reception detection unit by swinging the remote operation device in the other direction different from said direction.

49. An electronic device comprising a remote operation device that emits as output various light signals from a light-emission unit,
wherein a light-reception detection unit that receives the light signals and detects a change in a light reception amount, and a method for operating a screen is switched based on a change in a light reception amount detected by the light-reception detection unit by swinging the remote operation device forward and backward.

50. An electronic device that can control a camera device and comprises a remote operation device that emits as output various light signals from a light-emission unit,
wherein a light-reception detection unit that receives the light signals and detects a change in a light reception amount, and an orientation of the camera device is moved in a lateral direction or a vertical direction based on a change in a light reception amount detected by the light-reception detection unit by swinging the remote operation device in the lateral or the vertical direction.

51. The electronic device according to any of claim 37,
wherein the remote operation device is the remote control system.
